(19) United States
(12) Patent Application Publication
(10) Pub. No.: US 2017/0256123 A1
(43) Pub. Date: Sep. 7, 2017

(54) SYSTEM FOR MAPPING AND CONVERTING ONE OR MORE MATRICES

(71) Applicant: LMS PATENTS (ISLE OF MAN) LIMITED, Douglas (IM)

(72) Inventors: John Anthony REID, Auckland (NZ); Glen David SMITH, Auckland (NZ)

(21) Appl. No.: 15/511,688

(22) PCT Filed: Sep. 16, 2015
(86) PCT No.: PCT/IB2015/057106

§ 371 Date: Mar. 16, 2017

(30) Foreign Application Priority Data
Sep. 17, 2014 (NZ) 700135
Dec. 24, 2014 (NZ) 703466
Feb. 17, 2015 (NZ) 705114
Mar. 12, 2015 (NZ) 705936
Apr. 17, 2015 (NZ) 707121

(51) Int. Cl. G07F 17/32

(52) U.S. Cl. CPC G07F 17/329; G07F 17/3209; G07F 17/3237; G07F 17/3276

(57) ABSTRACT

Apparatus for mapping a matrix has a microcontroller with RAM and an EEPROM. The microcontroller has inputs/outputs to a touch sensitive display. A low resolution camera is provided to allow a machine readable code to be scanned for optional input. The EEPROM includes a random, pseudo-random or logical number/symbol generator, and instructions controlling the size of the cell matrix and ranking of the cell contents. To start a game in response to a barcode captured by camera the microcontroller decodes the captured image to produce a random sequence of symbols to populate the matrix displayed on the display and to rank and display the ranking of the symbols. The microcontroller applies the instructions to (a) determine the existence of any valid links between symbols in adjacent cells, (b) to calculate a result and (c) to display at least the result on the display.

### FIELD OF THE INVENTION

The present invention relates to a system for mapping and converting one or more matrices. The invention is directed particularly, but not solely towards a system for mapping and converting one or more matrices in a game that is played on the one or more matrices.

### BACKGROUND OF INVENTION

Most people are familiar with a game played on a matrix card or board, for example bingo games. Bingo games initially began as a type of lottery played in Renaissance Italy and then France in the late 18th century where it became known as “Le Lotto.” All main types of bingo have many variations. Accordingly the rules are not always exactly the same.

### Major Versions of Existing Bingo Games

The main types of bingo are:

90-Ball Bingo—90-ball bingo is the traditional format of the game played in Europe and Australia. It is the most popular form of the game played in the United Kingdom. Each bingo card has three rows and nine columns, with five numbers on each row for a total of 15 numbers. Each number is between 1 and 90.

Tickets are commonly sold in strips of six, which means that the purchasing player of a strip of 6 will have all 90 numbers across all six cards, and will have a hit for every number called.

As the bingo balls are called, players cross off the numbers, seeking to win by being first to mark five numbers in a line on a single ticket. Subsequent to a winner being announced, players attempt to mark two full lines on one ticket and then a “full house” covering all 15 numbers.

90-ball bingo, (and other bingo games of this similar type/size) can be divided into multiple rounds. For example, a three round game can comprise:
The first round goes to the first player to mark off one complete horizontal line of numbers. This player wins a small portion of the prize fund.
The second round, with a slightly larger prize, goes to the first player to mark off two complete horizontal lines.
The third round goes to the first player to mark off all numbers on their card. This player will win the main prize of the game.

75-Ball Bingo—The U.S. card features a 25-box grid. It has five rows of boxes arranged in five lettered columns containing 24 numbers and a “free” space in the very middle. Played with just 75 balls, the numbers 1-15 appear in the B column, 16-30 fall in the I column, 31-45 go in the N column (where the free space is located), 46-60 are in the G column, and 61-75 occupy the 0 column. To win, a player must be first to mark five numbers in a row, a column, or a diagonal. Sometimes the requirement to mark 5 in a row is reduced to 4 in a row.

80-ball Bingo—This is a relatively new U.K. version of the game. Unlike 75 ball and 90-ball bingo, which originated in the live format of the game, 80-ball bingo is specifically an online variation of the game. It uses a ticket with a 4×4 matrix of numbers consisting of 16 numbers. These cards are usually arranged so that only certain numbers appear in each column:
Column 1: 1-20
Column 2: 21-40
Column 3: 41-60
Column 4: 61-80

The winner of a game is the first player to mark off a specified pattern. The required pattern might be a vertical line or horizontal line, as in 75-ball bingo, but with only 4 numbers required these games are completed more quickly. There are many variations of patterns that might be required to be matched. For example some other required patterns include all 4 corners, 2 complete lines or a full house (every number marked off).

Mini Bingo—This is 30-ball bingo played on a ticket with nine cells in a 3×3 matrix. It is becoming popular online because it is fast, with each round lasting no more than several minutes, which means more winners per hour.

Pattern Bingo—Played usually on the U.S. card, winning combinations must form a certain shape or pattern, such as four corners, the letter L or T.

Progressive Bingo—The player only has a certain number of goes to obtain the required winning pattern. Once the number of tries has been exceeded, the game is over, and the prize is carried into the next round. This has the similar effect to a jackpotting Lotto game.

Coverall—In the U.K., this is the same as a full house. It may also be referred to as “blackout” in the U.S. The object is to be first to cover all of the numbers appearing on a ticket. In some games, progressive jackpots can be used, awarding a huge prize pool to the player who can cover every box within a certain numbers of balls called.

Quickie—A game in which numbers are called as quickly as possible. The winner is the first to fill the entire card. A variation of this is “Speed Bingo,” sometimes played with a pattern.

Bonanza Bingo—In the U.S., a progressive coverall Jackpot that is typically played as the 13th game of a day's sessions. It involves the pre-selection of forty-five numbers, which players mark on separate cards. Assuming no winners to share the prize money initially, numbers are called till a coverall is achieved.

Money Ball—Prior to the start of a game, one number is designated that will double the player's winnings if a Bingo is hit on that exact number. A variation of this is “Lucky Ball,” where the very first number called during the first session becomes “lucky” for the rest of the day, and any players who Bingo with it receive a bonus.

Texas Blackout—Whatever number is called first must be odd (1, 3, 5 . . . ) or even (2, 4, 6 . . . ). If it is even, for example, all of the even numbers on every card become “Wild” and are immediately covered—vice versa for odd. The game then continues until someone wins with a blackout.

Horse Race Bingo—Up to 15 players can play this variant of bingo. These players will have their own numbers from 1-15, which will correspond to the top row of their cards. Once a player gets five matching numbers in his column, he will be the winner of horse race bingo.

Death Bingo—This game inverts the traditional bingo game. When one player gets bingo, he will be eliminated. Therefore, the last one standing will be declared the winner. Alternatively, in another variation when a player gets bingo, all the other players will find out if they have the least number of filled spaces in their cards. The winner will be the one with the most spaces left.

### Jackpot Games

Jackpot games are games where there is a particularly big prize at stake, which can only be won if certain conditions are met. There are generally two types of jackpot games:
fixed jackpots, where the prize is a set amount of money, and
progressive jackpots, which increase over time until they are won.

### Bingo Prizes and Jackpots

Usually, the size of the typical jackpot is based on how much money is coming in. A progressive jackpot is a prize that keeps growing from game to game until somebody wins it. To win the progressive, a player must have an extraordinary win, such as a blackout (covering every space on a bingo card) in only 49 balls. If no one wins, the house chips in extra money to sweeten the pot even more.

The popularity of big prizes has allowed bingo to expand into more lucrative games. This has resulted in the spread of high-stakes games.

Some of the super-jackpots are set up to be “step games,” where the game pays different amounts depending on how quickly the winner gets a blackout. For example, a blackout in 49 numbers might pay $50,000, while a blackout in only 45 numbers could earn $100,000. This step in prize amount is because the odds change. It's very hard to get a blackout in so few calls.

In some bingo game variations, in order to win this or other super-jackpots, players may have to get a special pattern within a certain number of calls, and in addition, may have to play another game of chance, such as spinning a wheel.

### Bingo Odds

The odds in a traditional non progressing bingo game, where there is one winner that will emerge, is 1 in the total number of cards in play.

These odds don't apply to progressive jackpot games or step games, as a winner is not guaranteed. In this case the odds depend on the difficulty of covering the pattern in the predetermined number of calls. These odds will vary depending on the game.

### Various Bingo Patterns

The two main types of bingo are 75-ball and 90-ball bingo. But regardless of the main bingo type, there are different patterns used in both. The following patterns are among the most popular seen in both 75-ball and 90-ball bingo.

Horizontal—With horizontal bingo, a player must have one or more horizontal re(s) of the required number (usually 5 numbers in any order in a row) in order to win the game.

Vertical—The only difference between horizontal and vertical bingo is the direction of the line.

Diagonal—requires the player to make a line from one top corner to the opposite bottom corner (usually 5 numbers in any order in a row).

Coverall—Coverall (or blackout) bingo is the most difficult pattern to achieve. Usually, progressive jackpots use the coverall pattern and require players to get a “bingo” in 40 calls or less in order to win the jackpot.

Pattern—Pattern bingo can cover a wide array of interesting patterns. The pattern will be shown to all players and in order to win, the pattern must be replicated on the card. Diamonds, castles and hearts are three popular patterns used in pattern bingo.

### Multiple Winners

It is not uncommon in existing bingo games for multiple winners to be declared in a single bingo game. In the case of two or more winners, the prize is split evenly. In 75-ball games, it is less likely that two or more winners will be called but in 90-ball games, multiple winners are more frequent because the odds of correctly getting the right balls and the right matching patterns for the overall winner are harder.

### Bingo Technology Progress

The biggest technological innovation in the past twenty years has been the introduction of electronic daubing to the game. Electronic daubing is made possible through the computerised drawing of numbers.

It started with GameTech's invention called the T.E.D. or “Ted,” a handheld terminal capable of displaying four bingo cards at a time and automatically playing up to 600 cards in a single game. Even newer versions of this electronic daubing technology have been introduced in the past few years, such as the lightweight “Traveler,” which can show up to 21 cards at a time and play up to 1,200 cards in one game.

Technology has also allowed an entirely new form of bingo to grow worldwide via the Internet. Virtual bingo halls now offer players access to games 24/7 and by using devices such as a smart phone, tablets, PDA or PC, it is now also possible to download mobile bingo applications and play anywhere.

### Limitations of Existing Bingo Systems

Existing forms of bingo games often have relatively small prizes, which are won by the bingo player that first gets the required pattern. Prizes, if any, for the other players are often limited.

Some bingo games have a guaranteed winning outcome even if there is no clear winner, but they have the disadvantage that they can have multiple ‘first’ or top placed winners that share the top prize, which is often considered by players to be less desirable than having a game outcome where the first prize is undiluted and is substantially always won by a single bingo card or entry.

Where bingo is played with progressive jackpots, then the odds are stacked against a winner. This means that the games usually have no winner and accordingly the first place prize on offer in a progressive game is often not won and also any other prizes on offer are often limited.

Further, to increase the level of the first place prize (or progressive jackpot) available in a bingo game, the odds against winning the first place prize have to be increased. This is usually done by increasing the number of balls in a bingo game (such as using the 90-ball game), or by increasing the odds by increasing the number of balls that form the pattern to be matched by the players within the game. It can be a combination of both. Alternatively, the bingo gaming operator may require another game of chance to be played by the winning bingo player, such as spinning a wheel, or picking a number from 1 to 10, before that player can claim the first prize.

Further, some or all of these factors increase the length of the bingo game, which can be a disadvantage for some parties, including players who desire a quicker game.

The ability to have numerous prize points on offer, or the flexibility to structure prizes around numerous outcomes within a game, is also desirable.

The ability to have a wide range of odds in respect of numerous outcomes within a game is also desirable.

The ability to allow a player of a game to have instant play access, and to play a game as a sole player of the game where the prizes are set prizes based around the odds of numerous outcomes within the game, including large insured lottery style prizes, is also desirable.

In respect of a game that is played by a pool of players, the ability to substantially always guarantee a sole winner for the first prize on offer, or in the alternative, in a relatively few occasions, a small group of winners for the first prize on offer, in any game, irrespective of the participants' choices on entry, is also desirable.

The ability to reduce the number of balls in a bingo game in a way that decreases the time that a game takes, and when doing so does not result in any adverse reduction in game odds that would adversely affect prize amounts, is also desirable.

The ability to have a winner of the first prize on offer and for that winner to almost always be a single bingo or matrix card entry, but to also allow the game to run its full course so as to create numerous minor winners, is also desirable.

Many other gaming operators, such as a LOTTO operator, are faced with the practical problem that when increasing the odds against there being tied winners of the first prize, they increase the odds against there being a first prize winner at all. For example, in a game of LOTTO if the odds are set at 30 times the expected number of participants (entries), practically that LOTTO Operator's player base won't have a winner of the first prize, the odds are stacked against there being any first prize winner from that LOTTO game, and their players will come to the belief that they can't win, and some will eventually become disillusioned with that LOTTO game and ‘leave’. But on the other hand, if the odds against winning are set too low for the number of participants in that LOTTO game, then too many tied winners will result and the benefits of having a single winner being the sole winner of the first prize in the first division of such a LOTTO game are lost, as the first prize will need to be shared amongst two or more winners of first division.

It would also be desirable for the bingo game to be able to have multiple winners of the top pattern prize, say matching 5 in a row, yet at the same time the game has the ability to rank those multiple winners of the 5 in a row individually (and to rank any smaller sub set or lower ranked prize category) and to determine almost always or with substantial certainty one top winner from the relevant prize group.

It would be further desirable to achieve the ranking of the top winning group in a way that is transparent for players.

It would also be desirable for the bingo gaming event to be capable of a number of different methods of presenting the results of the bingo game to participants, particularly in a simplified manner that is transparent and easily understood.

It would also be desirable for the game to be capable of awarding prizes to those participants that fail in the game in a way that is profitable for the gaming operator.

It would also be desirable for the game results to be independently audited by an independent third party.

It would also be desirable for the game to be capable of use in many different gaming sectors or categories, such as use in the LOTTO and Lottery sectors, the Casino sector, the Slot sector, as well as in the Bingo sector of the gaming market.

Overall, it would be desirable to have a system for mapping and converting a matrix or matrices, wherein the system can facilitate a game that overcomes or at least goes someway towards overcoming some or all of the disadvantages of the existing games described above.

In this specification unless the contrary is expressly stated, where a document, act or item of knowledge is referred to or discussed, this reference or discussion is not an admission that the document, act or item of knowledge or any combination thereof was at the priority date, publicly available, known to the public, part of common general knowledge; or known to be relevant to an attempt to solve any problem with which this specification is concerned.

### PRIOR REFERENCES

All references, including any patents or patent applications cited in this specification are hereby incorporated by reference. No admission is made that any reference constitutes prior art. The discussion of the references states what their authors assert, and the applicants reserve the right to challenge the accuracy and pertinency of the cited documents. It will be clearly understood that, although a number of prior art publications may be referred to herein; this reference does not constitute an admission that any of these documents form part of the common general knowledge in the art, in New Zealand/or in any other country.

### Definitions

For the purpose of this specification:

Comprise: It is acknowledged that the term ‘comprise’ may, under varying jurisdictions, be attributed with either an exclusive or an inclusive meaning. For the purpose of this specification, and unless otherwise noted, the term ‘comprise’ shall have an inclusive meaning—i.e. that it will be taken to mean an inclusion of not only the listed components it directly references, but also other non-specified components or elements. This rationale will also be used when the term ‘comprised’ or ‘comprising’ is used in relation to one or more steps in a method or process.

Gaming Operator/s: means any party that is legally able to undertake gaming and/or betting activities with or without prizes, and where the context requires shall include any State Lottery Operator. “Gaming operator/s” and/or “gaming operator/s” shall have a corresponding meaning.

Joker/s: Any drawn symbol that is rejected by a player under the rules of any relevant Link2Win™ game, with the rejected symbol becoming a “joker” symbol which can be used as required and in compliance with the rules of any relevant Link2Win™ game in order to complete links, with those links being in respect of 3 Links or greater. An example of a relevant Link2Win™ game is set out in Example 8. Joker symbol/s and/or Joker symbol/s shall have a corresponding meaning.

Link or link: For the purpose of this specification, and unless otherwise noted, the term Link or link shall include one or more links or relationships between any two or more Symbols at the Game Play Area, that occur in accordance with the rules of the relevant game. “Links” and/or “links” shall have a corresponding meaning.

Lottery: Unless otherwise specifically noted, the “lottery” in the context of the present invention refers to any game of chance that is operated with prizes (including virtual prizes) or without prizes.

Prize or prize: Unless otherwise specifically noted, the word prize may include either a real prize with monetary value. However, it may also include a virtual prize with no monetary value in real world. Example of virtual prizes can be scores, visual representations indicating virtual money, or any form of recognition that does not provide any form of physical or financial gain to the player(s)/participant(s) of the game. “Prize” and/or “prizes” shall have a corresponding meaning.

Machine Readable Code: For the purpose of this specification, and unless otherwise noted, the term ‘Machine Readable Code’ or ‘Machine Readable Codes’ shall include any form of code(s) readable by a machine as long as a person skilled in the art may consider such code(s) to be suitable for delivering the functionality as intended with this invention. Examples of machine readable code(s) include/s Quick Response (QR) code(s), bar code(s) etc. Where suitable, the machine readable code(s) may also be interpreted to include Near Field Communication code(s) (“NFC” or “NFC code(s)”). “Quick Response code” and “QR code” have a corresponding meaning.

State Lottery Operator: Any authorised body or legal entity, including any company or person, authorised by a country or a state of a country, to run the lottery.

Game Play Area: For the purpose of this specification, and unless otherwise noted, the term “Game Play Area” is defined to mean any virtual two-dimensional or multi-dimensional area, including any representation thereof of whatever kind, that is used when placing two or more Symbols from a defined available range of Symbols from one to n at (in, and/or on and/or close to) the Game Play Area, with the Symbols being placed at (in, and/or on and/or close to) the Game Play Area in a regular or irregular spatial arrangement, so that some Symbols are bordered by or are close to other Symbols and in accordance with the rules of the relevant game one or more links or relationships between any two or more of the Symbols at (in, and/or on and/or close to) the Game Play Area, can occur. The word “Game Play Areas” has a similar meaning, but means more than one Game Play Area. Without limitation, the Game Play Area may include a virtual representation of one or more matrices or one or more grids comprised of any grouping (including any multi dimensional grouping) of “squares”, “circles”, “rectangles” hexagons”, or “diamond” shapes, or of any combination of objects, including but not limited to a grouping comprised of z×z shapes or objects (e.g. 5×5; 6×6), or z×y shapes or objects (e.g. 4×5; 4×6), or any ordered or disordered configuration of shapes or objects including two or more combinations of different shapes or objects.

Card: Unless otherwise noted, the word “card” is a form of a Game Play Area and shall encompass a virtual representation of a card comprising one or more matrices or grids. The word “cards” has a similar meaning, but means more than one card. However, unless otherwise specifically noted, the word “card” or “cards” do not mean a “scratch card” or “scratch cards”.

Symbol or symbol: Unless otherwise noted, the word “Symbol” or “symbol” may be appropriately interpreted to include any representation of a symbol, icon or object. Unless otherwise specifically noted, the word “Symbol” or “symbol” also includes a number or letter. Unless otherwise noted, the word “Symbols” or “symbols” has a similar meaning, but means more than one symbol.

Ticket or ticket: Unless otherwise noted, the word “Ticket” or “ticket” may be appropriately interpreted to include any ‘virtual representation’ of a ticket; any document or electronic record or confirmation performing a similar function to a ticket, that is issued or provided to a participant as evidence of entry in a relevant game. Unless otherwise noted, the word “Tickets” or “tickets” has a similar meaning, but means more than one ticket.

Matrix: Unless otherwise noted, the word “matrix” shall mean a form of a Game Play Area comprised of any grouping (including any multi-dimensional grouping) in a grid like array or a game play area typically but not limited to a rectangular array of a×b cells. Cells at least in the central region of a matrix will have neighbouring cells. Various matrix configurations are illustrated in the drawings. In our most preferred examples, we refer to a 5×5 matrix. Unless otherwise noted, the word “Matrices” or “matrices” has a similar meaning, but means more than one matrix.

Pseudo-random: Unless otherwise noted, a term “pseudo-random” relates to a process that appears to be random but is not. Pseudorandom sequences typically exhibit statistical randomness while being generated by an entirely deterministic causal process that is unknown to the participants of the game.

Pseudo-random: Unless otherwise noted, a term “pseudo-random” relates to a process that appears to be random but is not. Pseudorandom sequences typically exhibit statistical randomness while being generated by an entirely deterministic causal process that is unknown to the participants of the game.

### OBJECT OF THE INVENTION

It is an object of this invention to provide a novel system for mapping and converting a matrix or a matrices, for use in playing a game, the game being one which will obviate or minimise the foregoing disadvantages or go at least some distance towards meeting the foregoing desirable attributes or at least some of them in a simple yet effective manner or one which will at least provide the public with a useful choice.

### SUMMARY OF THE INVENTION

In a first broad aspect, the invention resides in a system for mapping and converting one or more matrices used in a game that is played on the one or more matrices, the system comprising:
a display means;
a memory storing at least particular rules, the rules being related to one or more matrices, each consisting of multiple cells, the rules at least specifying valid links between the cells of the one or more matrices; and
one or more modules stored in the memory and configured for execution by one or more processors, the one or more modules including instructions:
to initialize one or more matrices consisting of multiple cells, by identifying at least some of the cells of the one or more matrices using a number of unique identifiers, the number of unique identifiers being equal to a number of cells of the one or more matrices that are to be identified;
to cause each of the uniquely identified cells of the one or more matrices to display a symbol identified by the respective identifier of that cell, on the display means;
to read the rules stored in the memory and to store in the memory the scoring factors associated with at least particular cells of the one or more matrices identified by particular rules;
to create an ordinal ranking of at least those cells of one or more matrices that display the symbols to cause at least some of the cells of the one or more matrices displaying the symbols to display their ordinal ranking, on the display means;
to calculate a series of sequences identified by particular rules in relation to relative positions of the ordinal rankings of the cells of the one or more matrices;
to determine any valid links between the calculated series of sequences, the valid links being determined according to the rules;
to calculate a game result from the scoring factors stored in memory and associated with at least the particular cells of the one or more matrices; and
to display at least the result of the game on the display means.

Preferably, the one or more modules further includes instructions to display any valid links between the calculated series of the sequences, on the display means.

Preferably, the symbol displayed by any one cell on the display means is unique to at least the matrix containing that cell.

Preferably, the display means is an OLED or a touch screen display.

Preferably, the system further comprises an input device operatively connected to the processor to input data to the processor.

Preferably, the input device is adapted to input a symbol data to the processor, the symbol displayed by the at least some of the cells of the one or more matrices on the display means being dependent on the symbol data inputted by the input device.

Preferably, the input device is a machine readable code scanner adapted to read and input symbol data from a machine readable code.

Preferably, the input device is a bar code scanner adapted to read and input symbol data from a bar code

Preferably, the input device is a QR code scanner adapted to read and input symbol data from a QR code.

Preferably, the input device is a camera.

Preferably, the system comprises a symbol generator operatively connected to the processor, the symbol generator being adapted to generate at least some of the symbols that are displayed by the cells of the one or more matrices on the display means, the ordinal ranking of the cells being values that represent the order in which the at least some of the symbols are generated from the symbol generator.

Preferably, the input device is operatively connected to a symbol generator and to the processor, wherein the input device receives the ordinal ranking data from the symbol generator and inputs the received ordinal ranking data to the processor, the ordinal ranking displayed by at least some of the cells of the one or more matrices on the display means being dependent on the ordinal ranking data inputted by the input device.

Preferably, the symbol generator generates the symbol in a random order, pseudo-random order, or a logical order unknown to any participant(s) of the game.

Preferably, the memory and the processors are located in a remote location in a server and the display means is operatively connected to the server.

Preferably, the ordinal ranking being independent from and unrelated to the symbols identified by the identifiers of the cells of the one or more matrices.

In a second broad aspect, the invention resides in an apparatus for mapping and converting one or more matrices that is used in a game that is played on the one or more matrices, the apparatus comprising:
a matrix store storing at least one matrix having a specified number of cells, a unique symbol identifier for identifying symbols, each symbol being identified by a symbol identifier;
a matrix store storing at least one matrix having a specified number of cells, a plurality of unique symbol identifiers for identifying symbols, each symbol being identified by a unique symbol identifier;
a placement allocator receiving each unique symbol identifier from the matrix store and placing each unique symbol identifier in the at least one matrix so that each symbol identifier represents each cell;
a sequence implementer adapted to receive a specified number of ordinal ranking values each of which represent an order in which a specified number of symbols are drawn, and to replace at least some of the symbol identifiers representing the respective matrix cells with one ordinal ranking value corresponding to the order in which that particular symbol is drawn, the ordinal ranking value being in a sequence between 1 and the specified number;
a rule store for storing a set of rules, the rules being dependent on the ordinal ranking values, sequence(s) of the ordinal ranking values and a location of the ordinal ranking values on the cells;
a cell location determiner adapted to determine the location of the ordinal ranking values on the cells;
a sequence determiner adapted to determine if the ordinal ranking values located at two or more cells are in sequence(s) according to the rules of the game;
a sequence detector adapted to determine if the ordinal ranking values located at two or more cells are determined to be in sequence(s) by the sequence determiner according to the rules;
a sequence sorter adapted to compare the sequence(s) detected by the sequence detector and sort the sequence(s) that are valid sequence(s) and invalid sequences according to the rules;
a sequence comparator adapted to compare at least the valid sequence(s) thereby obtaining a result providing information about at least the number and/or type of the valid sequence(s) according to the rules;
a result publisher adapted to receive at least the result from the sequence comparator and transmit at least the result externally for publication.

Preferably, the apparatus further comprises a score calculator for calculating a score using any scoring factors in the rules of the game and associated with particular cells and/or valid links and wherein the result publisher is adapted to receive and transmit the calculated score from the score calculator for publication.

Preferably, the apparatus further comprises an identifier generator that generates the unique symbol identifiers to be received by the placement allocator.

Preferably, the apparatus comprises a transaction module adapted to receive and/or process payments or at least store any payment details.

Preferably, the apparatus further comprises an information module for storing information of the participant(s) of the game.

Preferably, the apparatus is operatively connected to one or more display means adapted to receive and display any data transmitted by the result publisher.

Preferably, the display means is adapted to display several stages of the game either in real time (synchronously) or in non real time (non-synchronously).

The apparatus as claimed in claim 18 or 19, wherein the display means is adapted to display a symbol together with the respective placement value of that symbol on each cell of the one or more matrices.

In a third broad aspect, the invention resides in an apparatus for mapping and converting at least one matrix, the apparatus comprising:
a display means;
a memory storing a definition of valid links between the cells of the at least one matrix
one or more modules stored in the memory and configured for execution by one or more processors, the one or modules including instructions:
to initialize at least one matrix consisting of multiple cells, by identifying at least some of the cells of the at least one matrix using a number of unique identifiers, the number of unique identifiers being equal to a number of cells of the at least one matrix that are to be identified;
to cause each of the uniquely identified cells of the at least one matrix to display a symbol identified by the respective identifier of that cell, on the display means;
to read the definitions of valid links stored in the memory and to store in the memory the valid links associated with at least particular cells of the one or more matrices identified by particular definitions;
to create an ordinal ranking of at least those cells of the one or more matrices that display the symbols;
to cause at least some of the cells of the one or more matrices displaying the symbols to display their ordinal ranking, on the display means;
to calculate a series of sequences identified by particular definitions of valid links in relation to relative positions of the ordinal rankings of the cells of the one or more matrices;
to determine any valid links between the calculated series of sequences, the valid links being determined according to the rules;
to calculate a result from the scoring factors stored in memory and associated with at least the particular cells of the one or more matrices; and
to display at least the result on the display means.

All appropriate preferable options of the first and second broad aspects as defined above may equally apply to the third broad aspect.

In a fourth broad aspect, the invention resides in an apparatus for mapping and converting one or more matrices that is used in a game that is played on the one or more matrices, the apparatus comprising:
a matrix store storing at least one matrix having a specified number of cells and plurality of unique symbols;
a placement allocator receiving each unique symbols from the matrix store and placing each unique symbols in the at least one matrix so that each symbol represents each cell;
a sequence implementer adapted to receive a specified number of ordinal ranking values each of which represent an order in which a specified number of symbols are drawn, and to replace at least some of the symbols representing the respective matrix cells with one ordinal ranking value corresponding to the order in which that particular symbol is drawn, or also place (on each of the some or all matrix cells containing the symbols) one ordinal ranking value corresponding to the order in which the particular symbol on that cell is drawn, the ordinal ranking value being in a sequence between 1 and the specified number;
a rule store for storing a set of rules, the rules being dependent on the ordinal ranking values, sequence(s) of the ordinal ranking values and a location of the ordinal ranking values on the cells;
a cell location determiner adapted to determine the location of the ordinal ranking values on the cells;
a sequence determiner adapted to determine if the ordinal ranking values located at two or more cells are in sequence(s) according to the rules of the game;
a sequence detector adapted to determine if the ordinal ranking values located at two or more cells are determined to be in sequence(s) by the sequence determiner according to the rules;
a sequence sorter adapted to compare the sequence(s) detected by the sequence detector and sort the sequence(s) that are valid sequence(s) and invalid sequences according to the rules;
a sequence comparator adapted to compare at least the valid sequence(s) thereby obtaining a result providing information about at least the number and/or type of the valid sequence(s) according to the rules;
a result publisher adapted to receive at least the result from the sequence comparator and transmit at least the result externally for publication.

All appropriate preferable options of the first and second broad aspects as defined above may equally apply to the fourth broad aspect.

In a fifth broad aspect, the invention resides in an apparatus for mapping and converting at least one matrix, the apparatus comprising:
a display means;
a memory storing a definition of valid links between the cells of the at least one matrix; and
one or more modules stored in the memory and configured for execution by one or more processors, the one or modules including instructions:
to initialize at least one matrix consisting of multiple cells, by randomly populating (i.e. populating in a random order) each cell of the at least one matrix with a symbol that is selected from a set of symbols, the set of symbols containing the plurality of symbols that are in sequence between 1 and a specified number;
to cause each cell of the at least one matrix to display a symbol that is populated on the display means,
to read the definitions of valid links stored in the memory and to store in the memory the valid links associated with at least particular cells of the one or more matrices identified by particular definitions;
to calculate a series of sequences identified by particular definitions of valid links in relation to relative positions of the symbols on the cells of the one or more matrices;
to determine any valid links between the calculated series of sequences, the valid links being determined according to the rules;
to calculate a result from the scoring factors stored in memory and associated with at least the particular cells of the one or more matrices; and
to display at least the result on the display means.

All appropriate preferable options of the first and second broad aspects as defined above may equally apply to the fifth broad aspect.

### Inventive Step

The invention as defined above provides a system and apparatus for mapping and converting one or more matrices used in playing a game played on the one or more matrices, the game being one that allows a gaming event to operate with prizes, without prizes, or to operate using a totalizer or pari-mutuel system (where the total prize pool depends upon the number of entries and is not a fixed amount) or to operate using a pari-mutuel system in combination with one or more ‘additional fixed prizes’, or to operate using fixed prize amounts. In respect of the game that is played by a pool of players, the gaming event closes at a defined time or upon reaching of defined parameters such as reaching of a predetermined number of ticket sales or prize pool. The game played using the system and apparatus as defined above provides for participants to select all or substantially all of the symbols such as numbers (including for the avoidance of doubt, number equivalents) from a defined available range of symbols from one to n and randomly place those symbols at a Game Play Area/matrix, as the participant decides, or as may be randomly undertaken by a computer or by any other person or thing on their behalf.

The system and apparatus as defined above then provides for the ranking of the symbols in the defined available symbol range one to n based on the ordinal ranking (or ranking or placement value, or ranking or placement order) of some or all of the n symbol which is in turn based on a random draw or pseudo-random draw or a logical draw of some or all of the n symbols. The logic used in the logical draw is unknown to the participant(s) of the game.

The participant or participants then use the ordinal ranking to identify links between their symbols or numbers at the Game Play Area, the links being determined in accordance with the rules of the game. The participant or participants may do this directly, or the gaming operator or system may do it automatically.

In particular, the invention allows a game to operate where the game (including by its aim) involves as one of its objectives, the linking of two or more symbols or numbers that are located at a Game Play Area with the linking occurring with reference to a separate but associated random, pseudo-random or logical draw of at least some of the symbols that are located at the Game Play Area, and in accordance with the rules of the game. The gaming system then uses the results and outcomes and determines the prize or prizes for one or more winners.

In preferred uses of the invention the random draw, pseudo-random or logical draw comprises a draw of all the symbols, but in some uses of the invention, the rules of the relevant game can provide for a draw of at least some of the n symbols comprising a sufficient number of drawn symbols so that links between symbols at the Game Play Area, in accordance with the rules of the relevant game, can occur.

Optionally the player may be allowed to reject in a game, one or more symbols as they are drawn and to convert the rejected symbols into “Joker/s” as explained in Example 8 below.

Optionally there may be two or more Game Play Areas per player with different symbol/number sequences. For example 3 cards per player with numbers chosen from the number range of 1-25 on the first card, from the number range of 26-50 on the second card, and from the number range of 51 to 75 on the third card.

Alternatively the player may be allowed to exchange symbol or number positions at a Game Play Area up to a defined point in the game—typically as the symbol/number draw is being carried out.

Further, the invention allows a gaming event to operate, where it is commercially viable and profitable for the gaming operator to offer as one of its prizes, a prize in excess of at least twice the entry fee paid by a participant, with it being paid to participants that fail to achieve any links.

And the invention allows a game to operate where a prize can be on offer and paid to all participants that totally fail to achieve any links in the game, and where the prize during the delivery of the game can be seen by the participant to be reduced to a zero monetary/value amount on one or more occasions as a result of some Links being achieved, and the position will stay at zero for the participant until and if the Links at the participant's Game Play Area, such as a matrix card or board, reach a set number of Links as determined by the game rules. When that occurs, prizes can start again, and prizes can thereafter rise to greater levels as further Links are achieved beyond the relevant set number.

In respect of a game that is played by a pool of players, the gaming system can also determine one or more winners based on a ranking of the tickets or entries in the game.

The invention also allows the participant or participants to play the game remotely e.g. by using their PC, tablets, PDA or smart phones.

The invention is capable of use in many different gaming sectors or categories, such as use in the LOTTO and Lottery sectors (which includes, for the avoidance of doubt, Keno), the Casino sector, the Slots sector, as well as in the Bingo sector of the gaming market.

The invention also allows the participant or participants to purchase entry into the game and to be paid any winnings other than by any online transaction, but allows the participant or the participants to view the draw and the play out of the game results in a visual form using their PC, tablets, PDA or smart phones. The invention achieves this by using a State Lottery Operator's POS lottery retailers, in conjunction with the use of computer technology that facilitates the visual form.

### BRIEF DESCRIPTION OF THE DRAWINGS

These and other aspects of the inventions, which will be considered in all their novel aspects, will become apparent from the following descriptions, which are given by way of examples only, with reference to the accompanying drawings in which:

FIG. 1 is shows a game of the present invention being displayed as the game displayed as a matrix consisting of multiple cells.

FIG. 2 shows a differing matrix arrangement in which a 5×4 (or 20 cell) matrix has unique symbols in each matrix cell and the cells are disarrayed across a decorative background.

FIG. 3 is a flowchart showing steps involved to play a game using the system/apparatus according to mapping and converting one or more matrix according to a first preferred embodiment of the invention.

FIG. 4 shows a schematic diagram of an apparatus/system for mapping and converting one or more matrix according to the first preferred embodiment of the invention.

FIG. 5 is a flowchart showing a process of one way of creating a ranking of the displayed sequence of symbols equal to the number of matrix cells with the rank numbers ordered randomly.

FIG. 6 is a flowchart showing a process for one way of detecting the adjacency of the cells of the matrix.

FIG. 7 shows the examples links that are valid scoring links according to the rules of the game.

FIG. 8 is a flowchart showing a process of one way of finding which of the links required by the games' rules can be found from the results of the procedure in FIG. 6.

FIG. 9 relates to the process which resolves the cell links found and the “significant” cells found into a game score.

FIG. 10 shows first 10 numbers of the matrix being converted to their corresponding ordinal ranking as determined by the order of the 10 drawn numbers.

FIG. 11 shows process of displaying any valid links found (i.e. any links that are valid as per the game rules) in order to calculate a game result from the scoring factors associated with the particular cells and any valid links.

FIG. 12 shows a schematic diagram of an apparatus/system for mapping and converting one or more matrix according to a second preferred embodiment of the invention.

FIG. 13 shows one embodiment of a Game Play Area in a form of a blank matrix card for use in a game of the present invention—in this case a 25 cell card in a 5×5 configuration.

FIG. 14 shows an example of a completed matrix card of FIG. 13, for use in a game according to the present invention, and the matrix card is ready to play (ready for the game draw).

FIG. 15-18 shows a process of the n symbols (in this case 25 numbers from 1-25) being randomly drawn and the corresponding number at the Game Play Area (in a form of a matrix card) being converted to its ordinal ranking according to one aspect of the present invention.

FIG. 15 shows the first 10 numbers drawn,

FIG. 16 shows the first 10 numbers at the Game Play Area (in a form of a matrix card) being converted to their corresponding ordinal ranking as determined by the order of the first 10 drawn numbers,

FIG. 17 shows the random draw of 25 numbers, and

FIG. 18 shows all 25 numbers at the Game Play Area (in a form of a matrix card) being converted to their corresponding ordinal ranking as determined by the order of the separate but associated random draw of 25 numbers as shown in FIG. 17, with this exampled game resulting in 5 links: 4×2 Links; and 1×5 Links.

FIGS. 19-22 show one preferred embodiment of the invention where virtual imagery of tokens are used. These tokens represent ordinal rankings determined from the numbers drawn in the random draw.

FIG. 19 shows the tokens being stacked in an ordinal placing order prior to draw, stacked from 1^{st} to 25^{th}.

FIG. 20 shows the 4^{th} token, representing the 4^{th} drawn number (number 25) where the number 25 at the Game Play Area in a form of a 5×5 matrix card is about to be converted to 4^{th} by placing the 4^{th} token onto the cell containing the number 25.

FIGS. 21A and 21B together show a situation, where a player/participant recognises two instances of 2 Links being achieved and flips Tokens 8^{th}, 9th & 10th over to reveal an alternate colour (showing 10th Token before and after the player flips to the alternate side).

FIG. 22 shows a draw that is complete with 5 Links: 4×2 Links, and 1×5 Link.

FIG. 23 shows the coordinates in a 5×5 matrix.

FIG. 24 shows a view of part of a Game Play Area (in the form of a card) during the draw, with the option for the player to shuffle the position of two or more symbols (in this example, numbers) in the hope of gaining an advantage.

FIGS. 25A, B, C and D show a three card game, with each Game Play Area in a form of a card and each card has 25 numbers from a unique range of numbers: card 1 has numbers from the range of 1-25; card 2 has numbers from the range of 26-50; and card 3 has numbers from the range of 51-75. A random draw of 75 numbers, numbered from 1-75, then operates in this example to be used to govern the outcome of this exampled game, according to the rules set.

FIG. 26 shows a Machine Readable Code in a form of a Quick Response (QR) code containing, or which can contain: (a) the 25 ticket or card numbers (there are 25 of them on a 5×5 matrix). These numbers are ordered in a 25 number sequence based on the position of each number on the 5×5 matrix; (b) a unique game ID; (c) the draw information and the winning link information and (d) the date and time of the draw in a common time reference to allow for a draw to take place simultaneously in several different time zones.

FIGS. 27 A-Z and AA show some examples of the Game Play Areas that can be used to play the present game

FIGS. 28 A-D show variation to the ranking of entries by reference to the links achieved, the variation being different to that set out in Example 1.4-1.7, and specifically referenced in Example 1.7.

### DESCRIPTION OF THE PREFERRED EMBODIMENT(S)

The following will describe the invention in relation to preferred embodiments of the invention, namely a system/apparatus for mapping and converting one or more matrices. Several examples of playing the game that can be played using the system/apparatus are also described. The invention is in no way limited to these preferred embodiments and examples as they are purely to exemplify the invention only and that possible variations and modifications would be readily apparent without departing from the scope of the invention.

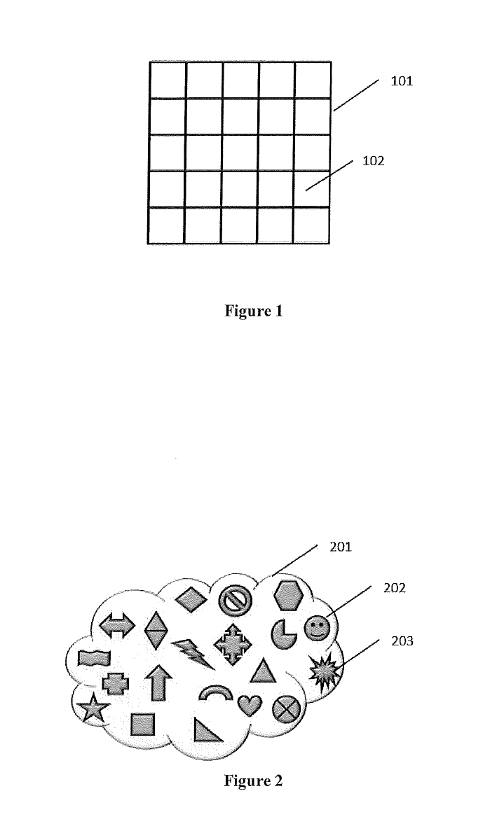

Examples of preferred embodiments of the hardware and process for mapping and converting one or more matrix when used in a game that is played on at least one matrix will now be described with reference to FIGS. 1-12.

FIG. 1 shows the game displayed as a matrix 101 consisting of multiple cells 102. The matrix shown consists of 25 cells in a 5×5 grid but the game may consist of any number of cells arranged in a two dimensional or three dimensional matrix. At least some or each cell may show a symbol identifying the cell in which it appears. Preferably each symbol is unique and typically the symbols may be those of the numbers from 1 to 25 for a 5×5 grid.

FIG. 2 shows a differing matrix arrangement in which a 5×4 (or 20 cell) matrix has unique symbols in each matrix cell and the cells are disarrayed across a decorative background. While the appearance is very different the same game rules can apply and the same system can be used.

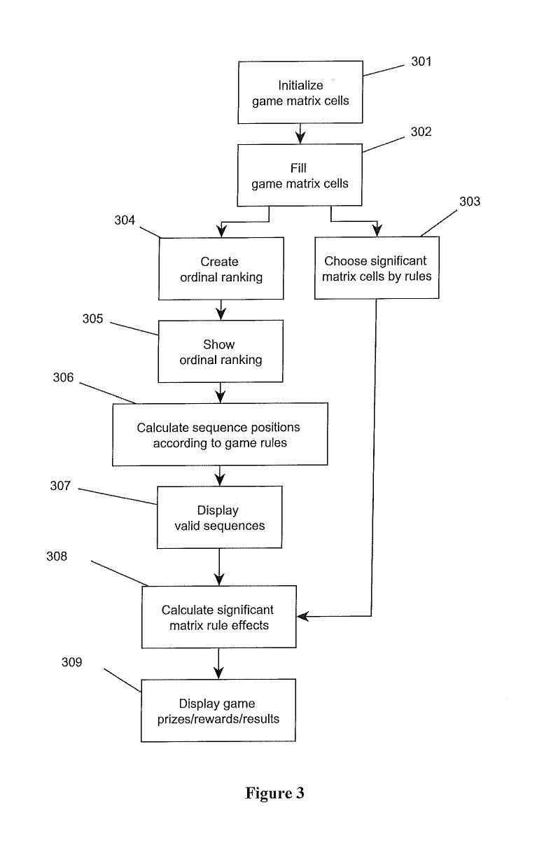

FIG. 3 shows the steps involved to play a game using a system or an apparatus according to a first preferred embodiment of the invention to play the game. At step 301 a display matrix such as that of FIG. 1 will be initialized by calculating or otherwise providing a random number using a number of unique identifiers equal to the number of matrix cells. Typically these unique identifiers will be the numbers 1 to 25 in random order. These numbers act as identifiers for symbols to be displayed in the matrix. Preferably the matrix cells are numbered in sequence firstly across and then down, but this order or numbering is not essential. The gaming apparatus then at 302 causes each cell or at least some of the cells to display a symbol identified by the identifier for that cell.

Typically the symbols are the numbers 1 to 25 but symbols such as those of FIG. 2 or any others may be used instead.

User input may be allowed to locate or relocate these symbols rather than relying solely on a random number generation. Equally the user may present a machine input to the game, such as a machine readable number sequence, a bar code or QR code or any form of a suitable user input interface which may be used to create a random sequence, a pseudo random sequence or a logical sequence.

The system then at 303 reads the stored rules of the game relating to scoring factors to be eventually applied to particular “significant” cells in the matrix and stores the factors associated with these. These rules may specify various special case gaming scenarios, such as the doubling of a score or the complete negation of a game when a particular symbol occurs on a particular cell. The rules may also specify valid links, invalid links and any scoring factors associated with the types of links.

The system then at 304 creates an ordinal ranking of the cells of the game. This ranking is unrelated to or independent from the symbols identified by the identifiers of the cells/appearing on the screen and may be the result of a random number/symbol generation, or a pseudo random number/symbol generation or a particular logical number/symbol generation that is known to the gaming operator but is unknown to the participants of the game.

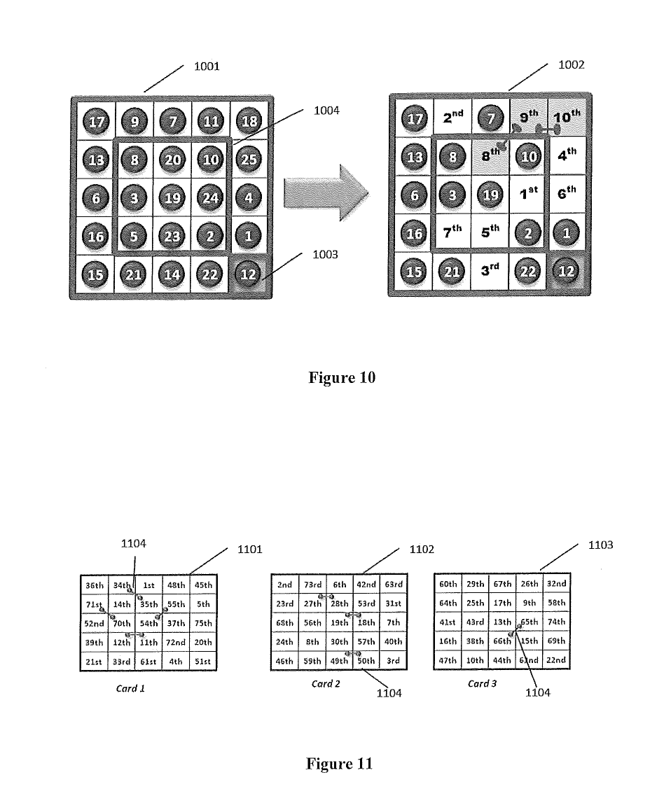

At 305 the ordinal ranking of at least some or all of those cells that were displaying the symbols is now displayed to the user, as shown for example in FIG. 10 where the original grid at 1001 is resolved into the ranked version shown partially complete at 1002. The ranking may replace or supplement the symbol otherwise shown in a cell and may be carried out as an immediate change or gradually to heighten the sense of play.

In FIG. 10 the right bottom square 1003 is shown as a “significant” cell in terms of the game rules for this game. Also in FIG. 10 an inner boundary indicates a separation between cells significant in the game rules for this particular game.

In FIG. 3 at 306 a series of sequences may be calculated in relation to the relative positions of the rankings/ordinal rankings of the cells. Typically this may be the occurrence of sequential rankings next to each other, but other occurrences of rankings may be considered of importance in the game rules.

Once the series of sequences have been calculated at 306, any valid links found (i.e. any links that are valid as per the game rules) may be displayed at 307 (see FIG. 11) in order to calculate a game result from the scoring factors associated with the particular cells and any valid links. Preferably, at 308 the game value of the links is calculated and the factors introduced by any “significant” cells are factored in to provide the game result which may be displayed at 309. Preferably, the game result is displayed together with any entitlement to prizes, any rewards, any scores or merely the results.

The system may be implemented using a programmable microcontroller, a dedicated gaming computer or a general purpose computer.

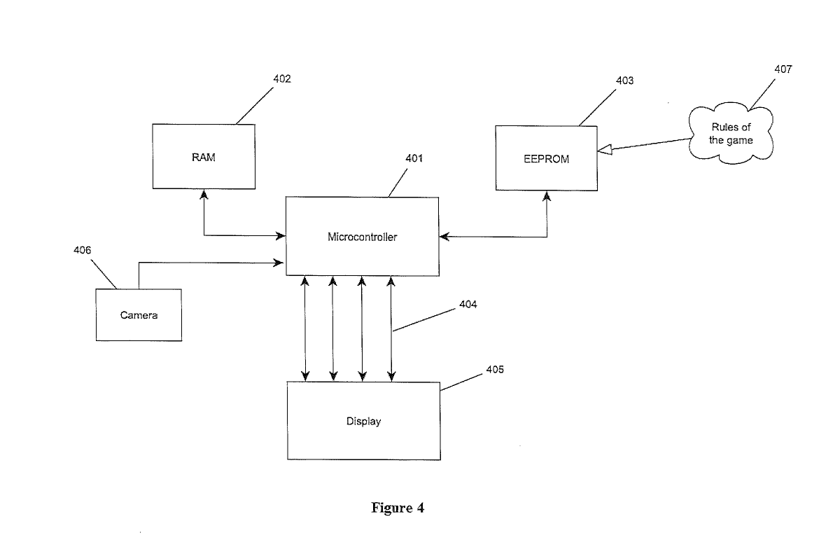

FIG. 4 shows a processor in the form of a microcontroller 401 with random access memory (RAM) 402 and programmable read only memory (EEPROM) 403. The microcontroller 401 has inputs/outputs (I/O) 404 to a display means 405 which is preferably a touch sensitive OLED display. A low resolution camera 406 is provided to allow a barcode to be scanned for optional input. A power supply (not shown) may be inbuilt or externally supplied.

The EEPROM is programmed with the desired game, including a random, pseudo-random or logical number/symbol generator, the rules of the game controlling the size of the cell matrix to be displayed on the display means 405, the rules of the game specifying which matrix cells are significant in providing special positive or negative score factors in the game, the rules of the game specifying the matrix cell positions which will score when containing a specified sequence of displayed symbols, and the controls which are to be displayed on the touch display 405 to allow user input. The logical number/symbol generator generates the number/symbol in a logical order that is known to the gaming operator but unknown to the participants of the game.

In use, the microcontroller 401 is powered up and may receive user input to start a game. This input may be a barcode displayed to the camera 406 or a screen touch on display 405. In response to a barcode the microcontroller 401 receives the barcode image stream from the camera 406 and decodes it to produce either a random sequence of symbols for initially filling the matrix displayed on the display 405 or a trigger to modify an initially created random display of symbols by ranking the symbols in a sequence related to the barcode.

Alternatively the user input may cause an already produced random sequence of symbols to be modified by ranking them in a differing random sequence or to exchange the position of two or more of the symbols. When the user has provided any required input the game apparatus may be triggered to rank the displayed symbols, for instance by tapping the touch display 405 or by the lapsing of a time.

The display means may display several stages of the game in real time (synchronously) and/or non real time (non synchronously).

A person skilled in the art will appreciate that the system comprises one or more modules stored in the memory 402, 403 that are configured for execution by the processor such as microcontroller 401. The one or more modules contain the instructions to carry out the steps as described above with reference to FIG. 3.

The system of this first embodiment may comprise more than one processor.

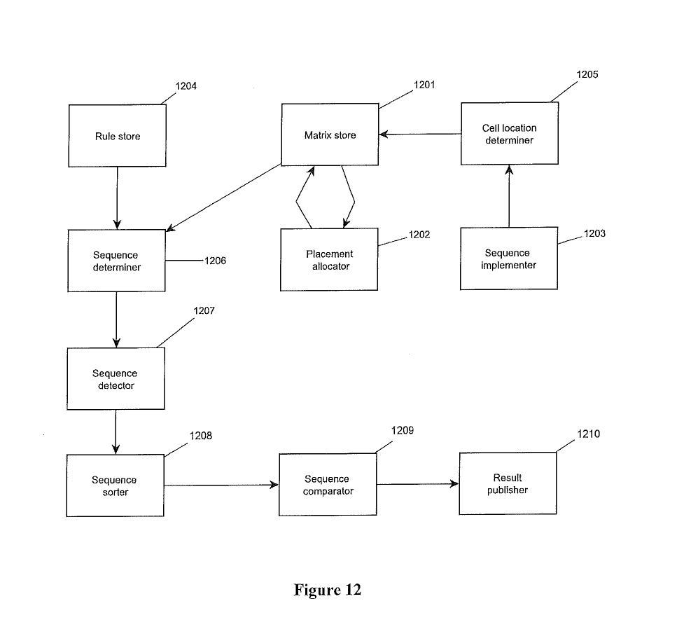

A second embodiment of a system, more particularly an apparatus, for mapping and converting one or more matrix to be used in a game will now be described with reference to FIG. 12.

The apparatus comprises several modules, namely a matrix store 1201, a placement allocator 1202, a sequence implementer 1203, a rule store 1204, a cell location determiner 1205, a sequence determiner 1206, a sequence detector 1207, a sequence sorter 1208, a sequence comparator 1209 and a result publisher 1210 which operatively communicates together.

The matrix store 1201 stores at least one matrix such as the one described above with reference to FIGS. 1 and 2. The matrix store 1201 also stores a plurality of unique symbol identifiers and each symbol identified by each of the plurality of the unique symbol identifiers.

The placement allocator 1202 receives a data of the symbols identified by the unique symbol identifiers from the matrix store 1201. The placement allocator 1202 then populates some or all of the cells of the matrix by placing one unique symbol identifier in each cell of the matrix so that each symbol identifier represents that particular cell on which it is placed.

There is a sequence implementer 1203 that receives a specified number of ordinal ranking values. Each of the ordinal ranking values received by the sequence implementer represents an order in which a specified number of symbols identified by the symbol identifiers are drawn. The sequence implementer 1203 then replaces at least some or all of the symbol identifiers in the matrix cells with the ordinal ranking values. Each ordinal ranking value that replaces a symbol identifier in the matrix cells correspond to the order in which a symbol identified by that particular symbol identifier is drawn in a sequence between 1 and the specified number. Consequently, the ordinal ranking values will now be placed in the some or all of the cells of the one or more matrix. When displayed on display means, it may be that the original symbol identified by the respective symbol identifier and the ordinal ranking value are shown together in each cell.

There is a rule or definition store 1204 that is adapted to store a set of rules of the game or a definition of what constitutes a valid scoring location. The set of rules is dependent on the ordinal ranking values, sequence(s) of the ordinal ranking values and a location of the ordinal ranking values on the cells. Preferably, the set of rules is predetermined.

The cell location determiner 1205 determines the location of the ordinal ranking values that are placed on the cells by the sequence implementer 1203.

Once the cell location determiner 1205 determines the location of the ordinal ranking values on the cells, the sequence determiner 1206 reads the set of rules stored in the rule store and thereafter determines if the ordinal ranking values located at two or more cells are in sequence according to the rules of the game.

When a sequence is determined, that determined sequence needs to be detected before any sorting and comparison can be done. That is done by a sequence detector 1207.

Once detected by the sequence detector 1207, the data of detected sequence is passed on to a sequence sorter 1208 that compares the sequence detected by the sequence detector 1207 and sort that sequence that are valid sequence(s) and invalid sequence(s) according to the rules of the game.

A data regarding valid and invalid sequence(s) from the sequence sorter(s) is then passed on to a sequence comparator 1209. The sequence comparator 1209 compares at least the valid sequence and obtains a result data which is then received by a result publisher 1210 that is adapted to transmit the data to an external device(s) such as display means for publication.

In some cases, rules of the game stored in the rule store (1204) may specify any scoring factor(s)/prize(s)/reward(s) associated with the particular sequence(s). The apparatus may comprises a score calculator that is adapted to receive result data from the sequence comparator, read the data from the result store and then calculate the score(s) and/or any prize(s) and/or reward(s) associated with the particular sequence(s). That calculated data may then be received by the result publisher 1210. The result publisher may also transmit such data to an external device(s) such as display means for publication.

In some cases, rules of the game stored in the rule store 1204 may specify particular “significant” cell or cells in the matrix and any scoring factors/prizes/rewards associated with these. These rules may specify various special case gaming scenarios, such as the doubling of a score or the complete negation of a game when a particular symbol and/or ordinal ranking value occurs on a particular cell. In such case, the cell location determiner 1205 determines the location of the symbol and/or ordinal ranking values on the cell and reads from the rule store 1204 if scoring factors/prizes/rewards/special case gaming scenarios associated with the location of any symbol and/or ordinal ranking values on any particular cell. The cell location determiner may then transfer that data to a score calculator that calculates the score(s) and/or any prize(s) and/or reward(s) associated with the particular sequence(s). That calculated data may then be received by the result publisher 1210.

The result publisher may also transmit such data to an external device(s) such as display means for publication.

The display means may display several stages of the game in real time (synchronously) and/or non real time (non synchronously).

For example, when the placement allocator populates some or all of the cells with the unique symbol identifiers, the display means may display, in real time or in non real time, the one or more matrix whose cells are populated or is being populated with the symbols that are identified by the respective symbol identifiers.

Similarly, the symbols in the matrix cells replaced or being replaced with original ranking values, the determination of valid and invalid sequences or links, any scores, any prizes or rewards etc may also be displayed by the display means in real time or not in real time. It may be that the original symbol identified by the respective symbol identifier and the ordinal ranking value are displayed together in each cell by the display means.

The display means may be in the form of a touch screen display and the user may be able to manually input data using touch screen that is responsible for populating at least some or all of the cells of the matrix with the symbols that are identified by the respective symbol identifiers. Alternatively, such data may be inputted by any other suitable external devices operatively connected to the apparatus such as but not limited to QR code reader, keyboard, camera, bar code reader etc.

The system/apparatus as described above in the first and/or second embodiment may optionally comprise an information module for storing information of the participants for example, name, address, telephone number, ticket numbers etc.

Preferably, at least some or all of the modules of the apparatus are stored in a server in a remote location. The external devices are connected with the server via internet using network devices.

The system/apparatus as described above in the first and/or second embodiment may optionally comprise a transaction module that is capable of receiving and processing and/or storing payment details. For example, if the game is to be operated with prize(s) in the form of money, then the payment of the prize(s) may be processed via this transaction module. Similarly, if there is an entry fee for participating in a game, the transaction module may be capable of receiving the payment made by credit card, debit card or any other means. In some case, the payment of an entry fee may be made by the participants via external source such as point of sale equipment located remotely at various retail stores. In such case, the transaction module may either communicate with those externally located point of sale equipment to process payment or may not process the financial transaction but simply receive and store any payment related data from the external source.

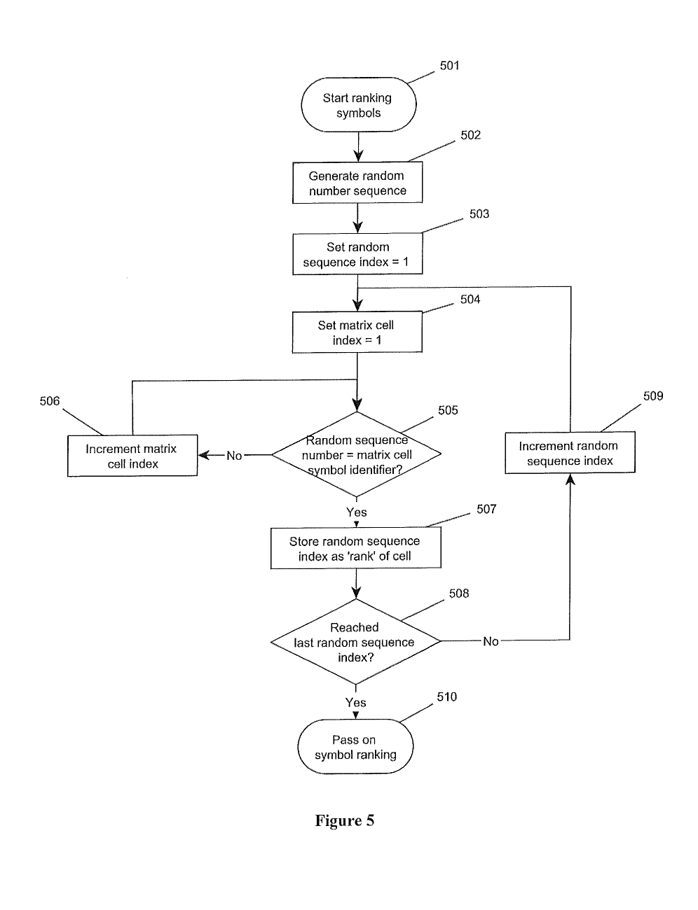

From the above description of the two preferred embodiments of the apparatus/system, it is clear that the important aspects of the game played using the apparatus/system is to place ordinal ranking value on the cells of the one or more matrix and identify if there is any valid/invalid sequence/links between the ordinal ranking value. An example of the process explaining how that is done will now be described with reference to FIGS. 5-11.

FIG. 5 shows the process of creating a ranking of the displayed sequence of symbols equal to the number of matrix cells with the rank numbers ordered randomly.

The symbols are enumerated at 501, and a random sequence, pseudo random sequence or logical sequence (that is unknown to the participants of the game) of these with length equal to the number of matrix cells is generated at 502 before the sequence index number is set to 1 at 503. The matrix cell index is also set to 1 and at 505 the number at the random sequence index number is compared to the symbol identifier of matrix cell number 1 at 505. If the two are not equal the matrix cell index is incremented at 506 and the next cell identifier queried.

Where the two are equal the random sequence index is stored at 507 as the “rank” of the matrix cell. Following this at 508 a check is made as to whether this is the last random sequence index and if not the random sequence index is incremented at 509, the matrix cell index reset at 504 and the comparison loop begun again.

When the system has incremented through all the random sequence indexes at 508 the stored symbol ranking for all matrix cells is passed on at 510.

The generation of the ranking need not be carried out in precisely the manner just described. It is sufficient that a ranking in random order of the sequence of matrix cells or pseudo-random order of the sequence of matrix cells or any logical order of matrix cells that is unknown to the participants of the game is passed for further processing.

Either before or after the ranking has been displayed to the user the sequence positions of the ranking numbers as adjacent numbers within the matrix must be calculated, since one of the aims of the game is to achieve links. This requires the detection according to the game rules of what is normally adjacent cells with adjacent ranking, thus for instance the detection of whether the 6^{th} rank position has the 7^{th} rank position somewhere on its perimeter must be verified or rebutted. Additionally the direction of the adjacency must be detected so that the existence of straight line links between a continuing adjacency of numbers can be found.

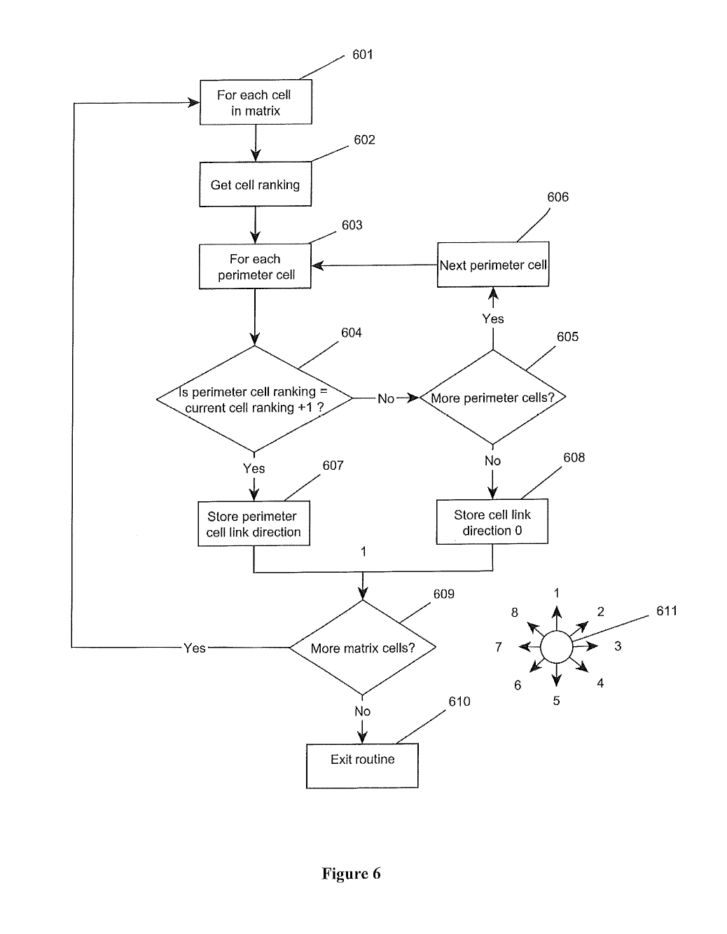

FIG. 6 provides for this by starting at 601 to loop through the data for all cells in the matrix. At 602 the cell ranking is read and then at 603 a loop through each adjacent perimeter cell is carried out. Clearly if the initial cell is on the perimeter of the matrix then it will have no outer perimeter cells, so only the perimeter cells actually existing within the matrix will be read. At 604 the rank of the adjacent cell is read and compared to the rank of the original cell plus one. If the rank of the cell is not one greater then a check is made at 605 to determine whether there are more perimeter cells. If there are then the next perimeter cell is read at 606 and the contents passed via 603 to the comparison at 604.

When the perimeter cell meets the ranking requirements of being one greater than the current cell rank the perimeter link direction is stored against the current cell at 607. This direction may be expressed, for a square cell in a two dimensional matrix, as the numbers between 1 and 8 as shown at 611. Note 611 is in respect of a 4 sided cell where it can link to 8 other cells.

Where no perimeter cells are found with the next ranking the direction will be set to 0 or null at 608. After this the remaining matrix cells are processed in the same way by looping at 609 until exiting at 610. The result is that a result is stored in which every cell which is adjacent to the cell with the next ranking number carries the direction to that cell. In any particular game draw there may be some or none of these adjacent rankings.

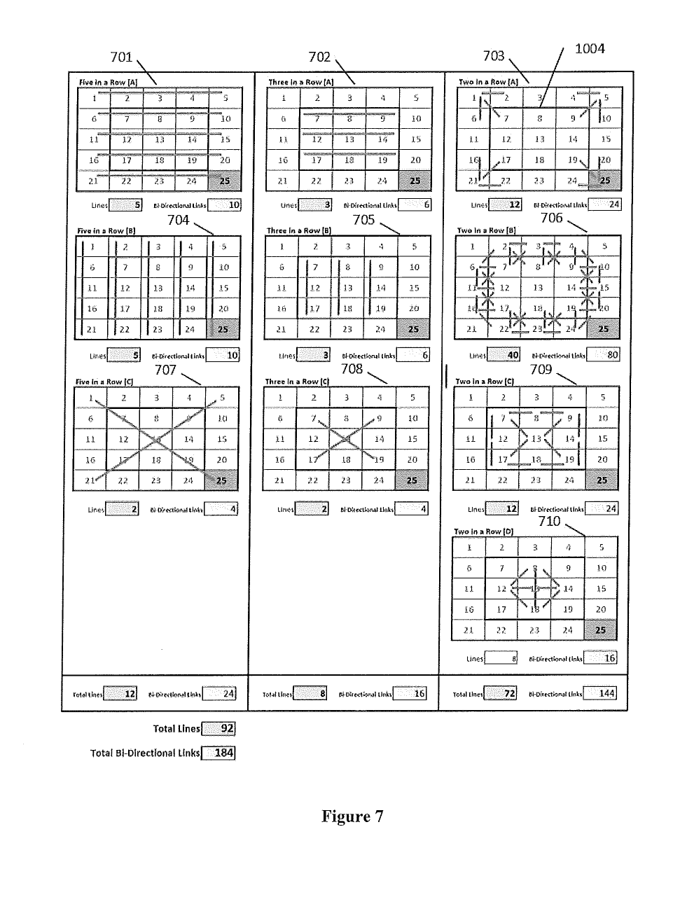

To determine which of these rankings may be a valid scoring link in terms of the rules of the game FIG. 7 shows examples of links in a 5×5 two dimensional matrix divided into two theoretical parts by an inner boundary line 1004. Within the inner boundary there may be a variety of two or three cell linking lines. Thus matrix 701 depicts 5 horizontal links each 5 cells long, matrix 702 depicts three three cell horizontal lines within the inner boundary, matrix 703 depicts three two cell links at each of the outer corners, matrix 704 depicts five five cell vertical links, matrix 705 depicts three three cell vertical links within the inner boundary, matrix 706 depicts all the two cell links crossing the inner boundary, plus the outer two cell links not in matrix 703, matrix 703 depicts the diagonal five cell links, matrix 708 shows diagonals within the inner boundary, matrix 709 shows perimeter and diagonal combinations of two cells within the inner boundary while matrix 710 shows horizontal and vertical links of the centre cell plus the diagonal links between the adjacent vertical and horizontal cells.

Any combination of these may be deemed to be required by the rules of any particular game in order to form scoring links of the ranking numbers.

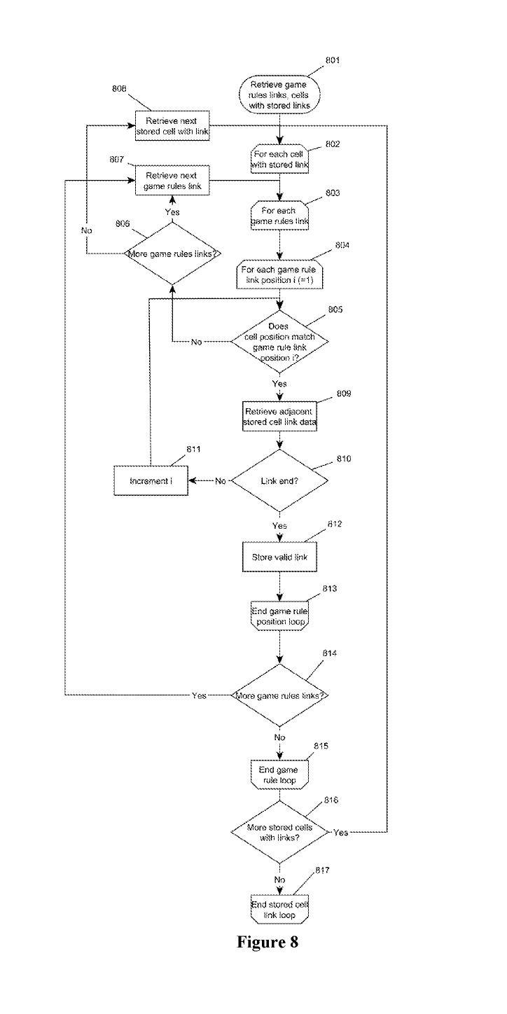

FIG. 8 shows one way of finding which of the links required by the games' rules can be found from the results of the procedure in FIG. 6 which found valid links between the rank of a cell and an adjacent cell of the next higher rank and stored them. At step 801 these stored links are retrieved together with the rules of the game as they relate to link positions. At 802 the process begins a loop which retrieves each stored link. These links may be at the beginning, the end, or between beginning and end of a valid game link. At 803 the process begins a loop through each link defined in the game rules. At 804 a loop is initialized with the position of the cell at the beginning of the game link. At 805 this is compared with the position of the cell in the stored link.

If there is no match a check is made at 806 for the existence of more game rules links and if any exist the next game link is passed to the start of the loop at 807. If there are no more game links then the next matrix cell stored link is retrieved at 808 and the process repeats.

If there is a match the stored link is followed to retrieve at 809 the location of the next cell (and the direction from it to any stored link if it has one). At 810 a check is made that the end of the link according to the rules has been reached. If it has not then the counter is incremented at 811 to point to the next position in the game rules link and the check at 805 as to rank and cell position is made. In this way the process iterates along a set of adjacent ranked cells matching them against a game link or failing to match them. For every full match of game rule link to the end of a game rule link the test at 810 succeeds and the existence of a valid link is stored at 812 before passing through the end of the loop at 813 to check at 814 for the existence of any more game links to test the same cell as the origin of a different game rule link (as may happen if the game scores both a three cell link and the two cell link at the start of the three cell link). Once the game rules are all resolved for that matrix cell the process moves through the end of the loop at 815 and determines at 816 whether any more stored links exist. If so the loop repeats at 816 otherwise the process exits at 817.

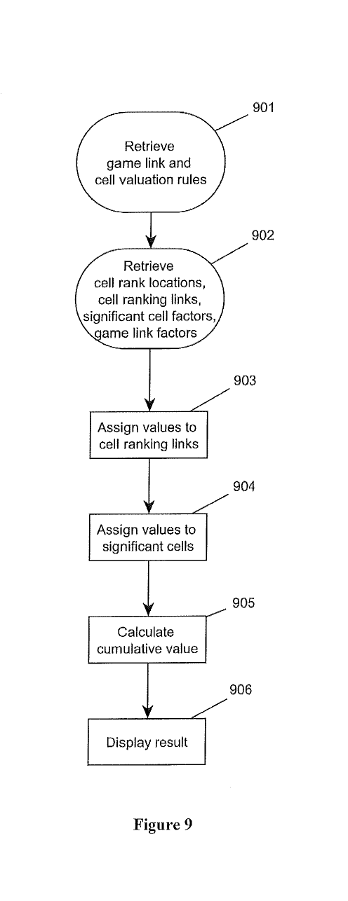

FIG. 9 relates to the process which resolves the cell links found and the “significant” cells found into a game score. At 901 the game link and cell validation rules are retrieved and at 902 the cell rank locations are retrieved as are the links found within the cell ranking, the “significant” cells and the factors that these apply to the final score, together with the game link factors and what they contribute to the final score.

From the values found the appropriate ones are assigned to the links found at 903, to the “significant” cells at 904—bearing in mind that the game rules for a particular rank in a particular cell may multiply the score or totally negate it. The values found are cumulated according to the game rules at 905 and the end result displayed to the user at 906. Typically the calculation may be involved since various game rules may provide somewhat arbitrary changes to the results.

In some variations of the game prizes or rewards may be produced by the gaming machine on which the game is played.

In some variations, there is no is no requirement in the rules of the game to have a random draw of 25 symbols in order to obtain the ordinal rankings. Rather the numbers are randomly populated in a blank matrix or matrices. In other words, the numbers from 1 to 25 are displayed in the cells of the matrix or matrices in a random order, i.e. an order that is not predictable. These randomly populated numbers provide their own sequence or ranking as they are made up of the numbers from 1 to 25, hence it is easy to identify adjacent sequential numbers. The system/apparatus in such case may use same or at least similar process as described above in order to identify the adjacent sequential numbers in the matrix or matrices.

### EXAMPLES

Examples of game(s) played using the system/apparatus of the present invention will now be described in more detail.

In this Examples section, the game of the present invention will hereinafter be referred to as Link2Win™ game and the Game Play Area(s) in a form of a virtual matrix card will hereinafter be referred to as Link2Win™ card(s) or Link2Win™ card(s) or simply as “card” or “cards”.

In this section, any prize amounts may include a real prize amount with monetary value. However, it may also include a virtual prize amount with no monetary/financial value in real world. Example of virtual prize amount can be scores, visual representations indicating virtual money, or any form of recognition that does not provide any form of financial gain to the player(s)/participant(s) of the game.

Similarly, an entry fee may include an actual fee the payment of which is made using real money. However, it may also include a virtual entry fee which is an entry fee that provides no real monetary/financial gain to the gaming operator and/or any party. Non-monetary payment of the virtual entry fee can be made using “virtual money” or any form of non monetary recognition that may be earned/collected by the player(s)/participant(s) of the game using several ways such as but not limited to the player's experience, length of membership, scores from previous games, clicking on the advertisements, sharing the game or its advertisement on social media etc.

| | |
|---|---|
| Example 1 | 5 × 5 Matrix Game - 5 × 2 Links with £Nil prizes |
| Example 2 | 5 × 5 Matrix Game - 1 × 2 Link with £Nil prizes |
| Example 3 | Link2Win ™ for State Lotteries - Pooled Games |
| Example 4 | Link2Win ™ for State Lotteries - Single Play Games |
| Example 5 | Link2Win ™ for State Lotteries - Instant Link2Win ™ |
| | Scratch Card Application |
| Example 6 | Multiple Concurrent Games |
| Example 7 | Token Design Concepts |
| Example 8 | Player Interaction - Rejecting Drawn Numbers |
| Example 9 | Player Interaction - Relocating or Shuffling Numbers |
| Example 10 | Player Interaction - Competition involving a Pool of Players |
| Example 11 | Player Interaction - Competition involving a Player |
| | competing against a computer |
| Example 12 | Variations - 2 Link Prize Profile |
| Example 13 | “2 Links” only with “Killer” cells |
| Example 14 | Side Bets |
| Example 15 | 5 × 5 Matrix Game - No random draw to obtain ordinal |
| | rankings |

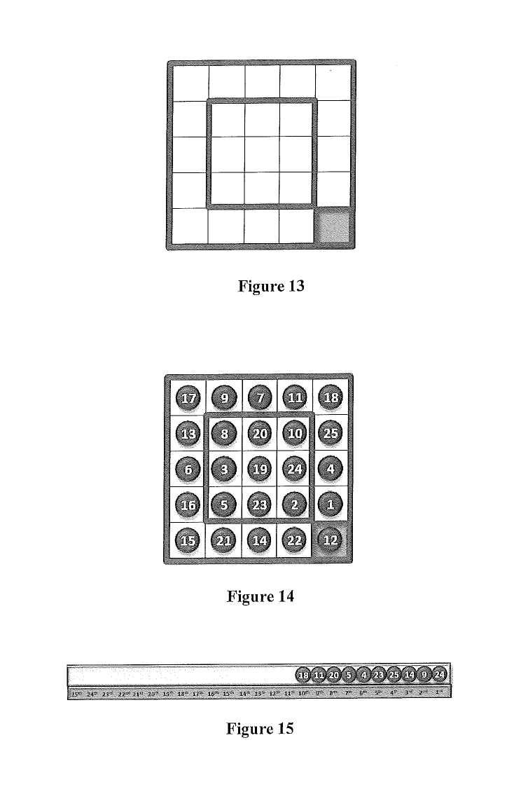

FIG. 13 shows a blank Link2Win™ card, and it is a 5×5 card, containing 25 cells.

The players have 25 numbers (1-25). These numbers are placed by the player on the Link2Win™ card, one number per cell (or randomly placed by the gaming Operator). An example of a completed Link2Win™ card ready to play (ready for the game draw) is shown in FIG. 14. A Link2Win™ card is a virtual imagery that is displayed on the screen of the display means of the device such as PC, tablets or smart phones.

The objective in this example of the game is to match patterns of straight lines, being horizontal, vertical and/or diagonal, as set out in FIG. 7 above. This is achieved by creating Links.

Links are formed by a number on the Link2Win™ card being linked to an adjacent number on the card, with this linking being determined by rules set around an associated random draw of 25 numbers, in this case the rule is that numbers are linked by the immediate following drawn number, in a random draw of 25 numbers, and so on. This is set out in FIGS. 15 and 16, and FIGS. 17 and 18.

### Example 1.0-5×5 Matrix Game—5×2 Links with £Nil Prizes

### Example 1.1—Exampled Game Profile

£5 entry per card
SUPERLINK is played by those players that correctly get the 25th drawn number (as the bottom right number in the Link2Win™ card—see example in FIG. 2), and
SUPERLINK is played by approximately 1/25th of all players, as there is a 1 in 25 chance of correctly choosing the SUPERLINK number.
For clarification: In this example, a SUPERLINK game operates to increase the prizes for 2 Links and 3 Links only.

### Example 1.2—The Random Game Draw

The 25 numbers are randomly, pseudo-randomly drawn by the gaming operator. The 25 numbers can also be drawn in a logical order that is unknown to the participant(s) of the game. As each number is drawn, the corresponding number on the Link2Win™ card is converted to its ordinal ranking. For example, the first drawn number is number 24, and number 24 on the Link2Win™ card is converted to 1st. This process is overviewed in FIGS. 15-18. Ordinal numbers make it easier for the players to see linkages. Alternatively, players may be given the option to identify the Links themselves, with prize levels dependent on each player's identification process.

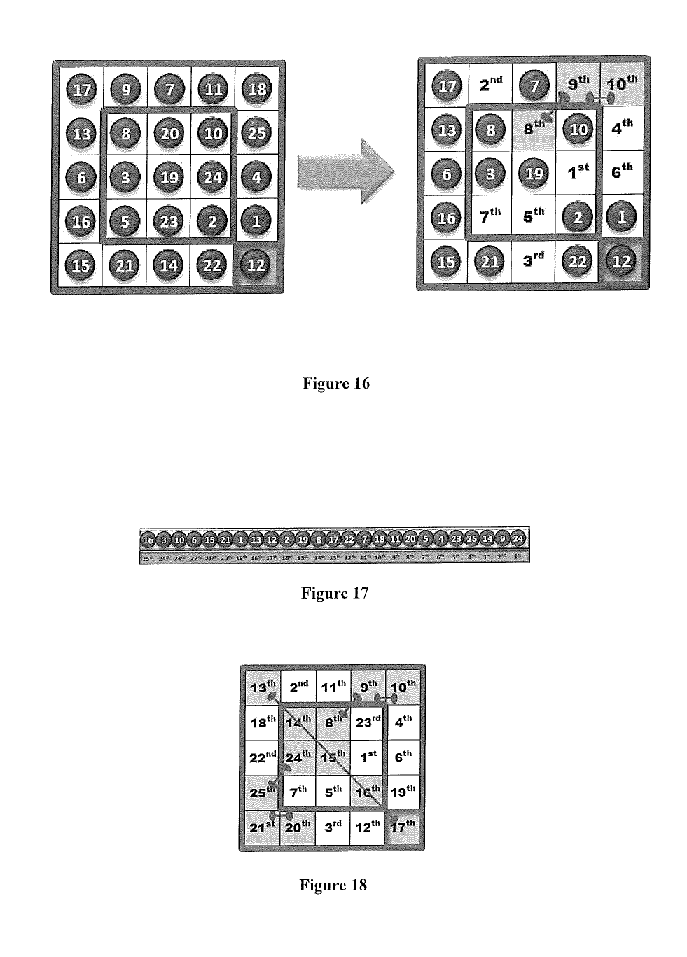

FIGS. 16 and 18 demonstrate the winning process. The Link2Win™ card in FIG. 18 has 5 links: two links of 2; and one link of 5.

FIG. 7 shows the examples of the patterns that need to be linked. In this example of the game there are 92 possible links per Link2Win™ card. These are for 5, 3 and 2 in a row as identified in FIG. 7.

### Example 1.3—Example Game Play

The game frequency can be set as desired by the gaming operator, for example, every 5-10 minutes, if the game is played by a pool of players, or instantly if it is to be played as an instant play by a single player of the relevant game.
Players place their 25 numbers (1-25) onto the 25 cells, placing one number per cells. Usually, a player will chose his or her SUPERLINK number, and most if not all of the remaining numbers will be randomly/pseudo-randomly/logically placed on the Link2Win™ card by a computer process using a random/pseudo-random/logical number generator.

### Example 1.4—Scoring the Link2Win™ Card

In this example of the game, it can be played by a pool of players, or as an instant play by a single player. Each card will be scored as follows:
2 Links: If two numbers drawn consecutively are located in adjacent cells (horizontal, vertical or diagonal) on the player's card, they score a 2 Link.
Three numbers drawn consecutively (if they do not qualify as a 3 Link) form 2×2 Links that are joined with a common number.
3 Links: If three numbers drawn consecutively are located on the player's card in adjacent cells in a straight line (horizontal, vertical or diagonal) within the inner 9 cells as shown in FIG. 13 (and FIG. 7, central columns) they score a 3 Link.
   Note: a 3 Link will always start as a pair and this pair will be removed from the score sheet when it qualifies and becomes a 3 Link.
   Further, five (5) drawn numbers drawn consecutively all inside the middle cell can form 2×3 Links that are joined with a common number, e.g. in a “L” shape.
   Seven (7) drawn numbers drawn consecutively all inside the middle cell can form 3×3 Links that are joined with two common numbers, in a “Z” shape, or in a “U” shape.
5 Links: If five numbers drawn consecutively are located on the player's card in adjacent cells in a straight line (horizontal, vertical or diagonal) they score a 5 Link.
   Note in this example, a 5 will always start as a 2-link, followed by a second 2-link. This is because a 3 Link can only occur within the inner 9 cells and the 5 Link must start from one of the outside cells. Whichever scored items lead to the 5 Link, they will all be removed from the scorecard from the straight line as the 5 Link is completed.
   Nine (9) drawn numbers drawn consecutively can form 2×5 Links that are joined with a common corner number, e.g. in an “L” shape.
   Thirteen (13) drawn numbers drawn consecutively can form 3×5 Links that are joined with two common corner numbers, in a “Z” shape, or in a “U” shape.
      Note: In this example of the game, there are no 4 Links. 4 consecutive drawn numbers appearing in a straight line (horizontal, vertical or diagonal) will count as:
Three 2 Links, if all outside the inner 9 cells; or
One 2 Link and one 3 Link, if any part of the 4 consecutively drawn numbers are in the inner 9 cells (of which there will be the one 3 Link).

### Example 1.5—Ranking of Top Cards in Multi-Card Draws

An application to rank the top cards in a multi-play of the game is also part of this exampled game. This allows for a first place winning card to be identified, as well as other placements as deemed desirable (such as 2^{nd} and 3^{rd}), in order that a winning card for part or all of any pari-mutuel prize fund can be determined. The rules to rank the top card are summarized below:
That card that has the most 5 Links is the Link2Win™ winner.

### Example 1.6—Tie Breaking Rules

In the event that there are tied cards equal with the most 5 Links, then in this example the following rules apply to separate those tied cards;
The card that has the best 5 Link is then the winner, e.g. 1^{st}, 2^{nd}, 3^{rd}, 4^{th}, 5^{th} drawn numbers will beat 2^{nd}, 3^{rd}, 4^{th}, 5^{th}, 6^{th} drawn numbers and so on;
In the event that there are still tied cards equal with best 5 Links, then the next best 5 Link is considered until a winning card emerges;
In the event that there are still tied cards remaining that all have equally ranked 5 Links, then the following further rule applies to separate those remaining tied cards;
   Of the remaining tied cards, that card that has the most 3 Links is the winner;
In the event that there are still tied cards equal with the most 5 Links and 3 Links, then the following further rule applies to separate those remaining tied cards;
The card that then has the best 3 Link is the winner, e.g. 1^{st}, 2^{nd}, 3^{rd} drawn numbers will beat 2^{nd}, 3^{rd}, 4^{th} drawn numbers and so on;
   In the event that there are still tied cards equal with the best 3 Links, then the next best 3 Link is considered until the tie is broken and a winning card emerges;
   In the event that there are still tied cards remaining that all have equally ranked 5 Links and 3 Links, then the process is repeated using 2 Links;
   In the event that there are still tied cards remaining that all have equally ranked 5 Links, 3 Links and 2 Links, then the following and final elimination process is used to separate the final remaining tied cards;
      The card that has the SUPERLINK number is declared the winner. If there are two or more cards tied with the SUPERLINK number, then the prize is shared;
      If none of the remaining tied cards have the SUPERLINK number (the 25^{th} drawn as their 25^{th} number), then the winning card is that card that has as its selected SUPERLINK number, the number that was drawn closest to the 25^{th} drawn SUPERLINK number—24^{th} drawn will beat 23^{rd} drawn and so on.
   If after the completion of the above processes there remains cards that are still tied, then the prize/s are shared.

If there are no cards with 5 Links at all, then the process commences at the 3 Link level, or the 2 Link level if there are also no cards with any 3 Links. Detailed rankings of all 5 Links, 3 Links and 2 Links are set out below.

### Example 1.7—Number Combinations to Rank Cards

The Ranking Order Rules for 5, 3, and 2 Links are set out in Tables 1-3 below. This is one example of rules to rank cards. Another example of rules to achieve a ranking of the cards would be to assign each possible link outcome with a numerical and graded value—a different example to that set out below is contained in FIG. 29, and a person skilled in the art will appreciate that there are many other ways to achieve a ranking of the cards as referred to in this example.

The ranking in this example follows the order of draw, with 5s being first, 3s second then 2s.

Like Poker, in this example the rules are that a 5 Link always beats one or more 3 Links, and a 3 Link always beats one or more 2 Links.

In each case, the same ranking is given to numbers that are drawn in the exact reverse.

TABLE 1
Ranking Order - 5 Links

| | 5 in order | | 5 in reverse order |
|---|---|---|---|
| Ranking | of random draw | | of random draw |
| Order | in a Row | Joint = | in a Row |
| 1^{st} | 1^{st}-5^{th} | & | 5^{th}-1^{st} |
| 2^{nd} | 2^{nd}-6^{th} | & | 6^{th}-2^{nd} |
| 3^{rd} | 3^{rd}-7^{th} | & | 7^{th}-3^{rd} |
| 4^{th} | 4^{th}-8^{th} | & | 8^{th}-4^{th} |
| 5^{th} | 5^{th}-9^{th} | & | 9^{th}-5^{th} |
| 6^{th} | 6^{th}-10^{th} | & | 10^{th}-6^{th} |
| 7^{th} | 7^{th}-11^{th} | & | 11^{th}-7^{th} |
| 8^{th} | 8^{th}-12^{th} | & | 12^{th}-8^{th} |
| 9^{th} | 9^{th}-13^{th} | & | 13^{th}-9^{th} |
| 10^{th} | 10^{th}-14^{th} | & | 14^{th}-10^{th} |
| 11^{th} | 11^{th}-15^{th} | & | 15^{th}-11^{th} |
| 12^{th} | 12^{th}-16^{th} | & | 16^{th}-12^{th} |
| 13^{th} | 13^{th}-17^{th} | & | 17^{th}-13^{th} |
| 14^{th} | 14^{th}-18^{th} | & | 18^{th}-14^{th} |
| 15^{th} | 15^{th}-19^{th} | & | 19^{th}-15^{th} |
| 16^{th} | 16^{th}-20^{th} | & | 20^{th}-16^{th} |
| 17^{th} | 17^{th}-21^{st} | & | 21^{st}-17^{th} |
| 18^{th} | 18^{th}-22^{nd} | & | 22^{nd}-18^{th} |
| 19^{th} | 19^{th}-23^{rd} | & | 23^{rd}-19^{th} |
| 20^{th} | 20^{th}-24^{th} | & | 24^{th}-20^{th} |
| 21^{st} | 21^{st}-25^{th} | & | 25^{th}-21^{st} |

TABLE 2
Ranking Order - 3 Links

| | 3 in order | | 3 in reverse order |
|---|---|---|---|
| Ranking | of random draw | | of random draw |
| Order | in a Row | Joint = | in a Row |
| 1^{st} | 1^{st}-3^{rd} | & | 3^{rd}-1^{st} |
| 2^{nd} | 2^{nd}-4^{th} | & | 4^{th}-2^{nd} |
| 3^{rd} | 3^{rd}-5^{th} | & | 5^{th}-3^{rd} |
| 4^{th} | 4^{th}-6^{th} | & | 6^{th}-4^{th} |
| 5^{th} | 5^{th}-7^{th} | & | 7^{th}-5^{th} |
| 6^{th} | 6^{th}-8^{th} | & | 8^{th}-6^{th} |
| 7^{th} | 7^{th}-9^{th} | & | 9^{th}-7^{th} |
| 8^{th} | 8^{th}-10^{th} | & | 10^{th}-8^{th} |
| 9^{th} | 9^{th}-11^{th} | & | 11^{th}-9^{th} |
| 10^{th} | 10^{th}-12^{th} | & | 12^{th}-10^{th} |
| 11^{th} | 11^{th}-13^{th} | & | 13^{th}-11^{th} |
| 12^{th} | 12^{th}-14^{th} | & | 14^{th}-12^{th} |
| 13^{th} | 13^{th}-15^{th} | & | 15^{th}-13^{th} |
| 14^{th} | 14^{th}-16^{th} | & | 16^{th}-14^{th} |
| 15^{th} | 15^{th}-17^{th} | & | 17^{th}-15^{th} |
| 16^{th} | 16^{th}-18^{th} | & | 18^{th}-16^{th} |
| 17^{th} | 17^{th}-19^{th} | & | 19^{th}-17^{th} |
| 18^{th} | 18^{th}-20^{th} | & | 20^{th}-18^{th} |
| 19^{th} | 19^{th}-21^{st} | & | 21^{st}-19^{th} |
| 20^{th} | 20^{th}-22^{nd} | & | 22^{nd}-20^{th} |
| 21^{st} | 21^{st}-23^{rd} | & | 23^{rd}-21^{st} |
| 22^{nd} | 22^{nd}-24^{th} | & | 24^{th}-22^{nd} |
| 23^{rd} | 23^{rd}-25^{th} | & | 25^{th}-23^{rd} |

TABLE 3
Ranking Order - 2 Links

| | 2 in order | | 2 in reverse order |
|---|---|---|---|
| Ranking | of random draw | | of random draw |
| Order | in a Row | Joint = | in a Row |
| 1^{st} | 1^{st}-2^{nd} | & | 2^{nd}-1^{st} |
| 2^{nd} | 2^{nd}-3^{rd} | & | 3^{rd}-2^{nd} |
| 3^{rd} | 3^{rd}-4^{th} | & | 4^{th}-3^{rd} |
| 4^{th} | 4^{th}-5^{th} | & | 5^{th}-4^{th} |
| 5^{th} | 5^{th}-6^{th} | & | 6^{th}-5^{th} |
| 6^{th} | 6^{th}-7^{th} | & | 7^{th}-6^{th} |
| 7^{th} | 7^{th}-8^{th} | & | 8^{th}-7^{th} |
| 8^{th} | 8^{th}-9^{th} | & | 9^{th}-8^{th} |
| 9^{th} | 9^{th}-10^{th} | & | 10^{th}-9^{th} |
| 10^{th} | 10^{th}-11^{th} | & | 11^{th}-10^{th} |
| 11^{th} | 11^{th}-12^{th} | & | 12^{th}-11^{th} |
| 12^{th} | 12^{th}-13^{th} | & | 13^{th}-12^{th} |
| 13^{th} | 13^{th}-14^{th} | & | 14^{th}-13^{th} |
| 14^{th} | 14^{th}-15^{th} | & | 15^{th}-14^{th} |
| 15^{th} | 15^{th}-16^{th} | & | 16^{th}-15^{th} |
| 16^{th} | 16^{th}-17^{th} | & | 17^{th}-16^{th} |
| 17^{th} | 17^{th}-18^{th} | & | 18^{th}-17^{th} |
| 18^{th} | 18^{th}-19^{th} | & | 19^{th}-18^{th} |
| 19^{th} | 19^{th}-20^{th} | & | 20^{th}-19^{th} |
| 20^{th} | 20^{th}-21^{st} | & | 21^{st}-20^{th} |
| 21^{st} | 21^{st}-22^{nd} | & | 22^{nd}-21^{st} |
| 22^{nd} | 22^{nd}-23^{rd} | & | 23^{rd}-22^{nd} |
| 23^{rd} | 23^{rd}-24^{th} | & | 24^{th}-23^{rd} |
| 24^{th} | 24^{th}-25^{th} | & | 25^{th}-24^{th} |

### Example 1.8—Sole First Ranked Card is Substantially Certain

The odds that arise from the configuration and interplay of the linking features of the 2, 3 and 5 Links, together with the tie breaking rules set out above, mean that it is substantially certain that a sole first place or ranked Link2Win™ card will almost always occur. This avoids the first place game prize being subject to dilution, which would occur as a consequence of there being 2 or more first place joint winners.

### Example 1.9—Visual Representation of Draw, Links and Prizes

The results draw will appear on a screen of a computer device (including mobile smart phones) as numbers, or as an animated sequence of numbers timed such that the cards are scored as each number or cluster of numbers appears. A list of the prize entries for 2 Links, 3 Links and 5 Links should appear on the screen against each card. When the SUPERLINK number is correctly selected there will be strong visual effects and prize draw updates to heighten player awareness.

Important Feature of this Example:

A card can win in up to 3 prize categories: in 2 Links; in 3 Links; and/or in 5 Links. All cards in this example will start with a loaded prize credit being displayed prior to the first number being drawn in the results draw. This displayed prize credit is what the card will win in the 2 Link prize category if that card stays at zero 2 Links following the completion of the results draw. That displayed prize/recognition credit will then be won, irrespective of whether or not the card also has 3 Link and/or 5 Link prizes, which will be additional prizes/recognitions.

### Example 1.10—2 Link Prize Profile

In this example, that starting displayed prize (for zero 2 Links) is set at £15. This £15 starting prize will:
initially go down in monetary value during the draw as the card gets one to three 2 Links;
go to a zero monetary amount once the card gets to, four to eight 2 Links;
At nine 2 Links, the displayed prize for 2 Links will go positive again and rise increasingly further as the card gets ten or more 2 Links—see Tables 10 and 11. If the exact profile of this 2 Link prize decline, then increase, can be varied. Additional prizes will also appear as 3 Links and/or 5 Links are achieved on the card.

### Example 1.11—Periodic Draws Involving Previously Played Cards

All legally entered cards may be retained by the gaming system/operator. There may be feature draws around key holidays or other globally recognised occasions when all cards received since the last such event will be entered into a free-to-enter draw.

These Link2Win™ games will be significantly larger, with the draw capable of being scheduled over a number of days to facilitate the scoring of a much larger number of cards.

Note: the scoring animations for these draws will still need to execute on the player's computer device, together with a display of that cards ranking. In this example of the game, and for the purpose of player interaction and suspense, the ranking is to be twofold, and in two stages:
Firstly: to first appear after the draw of the 15^{th} number recording whether or not the card is in the top 25% of all cards, and to be continually updated as each following number is drawn; and
Secondly: for a placement ranking to appear after the draw of the 20^{th} number, e.g. 1^{st} place or 999,999^{th} place, and to be continually updated as each following number is drawn.

### Example 1.12—Technology

Each player's card is almost virtually certain to be different, as the placement of the 25 numbers on the 25 cells of the 5×5 card will almost certainly be different. The chances that the same 25 number sequence will appear more than once in any game is extremely remote.

To calculate the odds of this occurring, the calculation starts with the odds of 1 against the calculation of getting 25 numbers in correct order of a random draw of the 25 numbers.

That starting calculation is odds of 1 in: 25×24×23×22×21×20×19×18×17×16×15×14×13×12×11×10×9×8×7×6×5×4×3×2×1.

This equals odds of 1 in 1.551121×10²⁵.

Then, the above odds of 1 in 1.551121×10²⁵ needs to be adjusted (enhanced or made better) because there is more than one position on the card where 25 numbers can appear in order of draw on a 5×5 card matrix with every other drawn number also remaining in the same pattern relevant to all other numbers. The required adjustment is by making an allowance for the number of starting sequences that allow the same pattern of 25 numbers in order of draw to appear on the card—so that the same patterns of all linkages between numbers on the card when the card is rotated in ¼ turns, or viewed in reverse (i.e. a mirror image) are identical. On the basis that there are 4 corners, and allowing for the mirror image effect, or alternatively, the reverse order of draw, the required adjustment is believed to be by a division of the calculated number of 1.551121×10²⁵, by a division factor of 8.

This results in odds of 1 in 1.93890×10²⁴.

In full, the adjusted odds are 1 in 1,938,900,000,000,000,000,000,000.

The odds of there being two cards with the exact same 25 number sequence, in order of a random draw of 25 n numbers and capable of producing the same results for, in this example, a game played with 2, 3, and 5 Links, is therefore in excess of 1 in a trillion.

In order to process any game involving such a vast array of possibilities and outcomes, and where outcomes must be processed extremely quickly, the only practical way to do so is by using computer technology, equipment and programs designed to meet those needs, including software programs written to cover all outcomes as required by the rules of the game. Assuming an annual prize draw occurred, and that it involved 1 Billion Link2Win™ cards (being the number of cards played during a 1 year period), and assuming the computer processing from the results of the random draw, cards at a rate of 250,000 cards a second, then the computer processing would take at least 67 minutes.

Further, because each player's card is almost virtually certain to have the order of placement of its 25 numbers different to all other cards, the scoring functionality and visual representation relating to each card and its outcome or position in the game must, or should take place on the player's own computer device. The scoring on each player's computer device is for display purposes, as the main computer system operated by the Gaming Operator will have already scored the card.

Further the system should be capable of operating with a central Link2Win™ Game Operator. When this occurs, this operator will not know, or is unlikely to know, the player details. This operator will receive from a number of gaming operators' entries and the relevant player's unique identification code. The central operator will feed back the draw and the results to the gaming operators for them to feed to their respective players.

Various hardware configurations to implement the game are possible. For instance, the Link2Win™ game could be played online using a client-server model in which a server entity is used to process the game data and then transmit the output to one or more client machines. The client-server model could also be implemented using one or more game terminals as clients, such as terminals using touch screens.

The virtual imagery of the Link2Win™ card and the numbers are displayed on the display means of the device (such as PC, tablets, Smartphone, PDA etc) and the participants will be able to click onto their identified number and see the number convert to its ordinal placing. Alternatively, this process could be automatically done for the player by the gaming operator's system.

The draw of 25 numbers can be very fast, or it can be slower, like a traditional bingo game draw, one number at a time in a fairly slow sequence. In this later event, players could be given a time to identify their number on the card that corresponds to the drawn number, click on it and see the number covert to its ordinal placing. Ideally, there will be a set time for participants/players to match their number with the drawn number. A failure by a player to identify a match may result in lost winnings relevant to that failure. So this can be used to set a challenge to the player. However, such set time for participants to match their number with the drawn number is purely optional as there may be situations that might adversely affect some players and not others, such as lost connections, internet crashes etc.

The graphic interface of the game does not have to be the same in all devices, and the representation of the events, despite being formally equivalent, can be represented by distinct graphics. Part of the task of representation of the game sequence and the events of the game would either fall locally, or on each individual electronic device, on the game room servers or on the management servers, depending on the nature of the task involved in the event or game sequence.

### Example 1.13—Software Requirements and Processes

In order to provide a usable platform to run the Link2Win™ application in this example of the game, the software must be designed to ensure complete randomness of number generations, and should also be designed to run as efficiently as possible. There are a number of critical code areas to achieve this. We believe the following method provides an efficient running of the software.

Entry into the Game

The drawing of the 25 numbers for placement on a player's card will generally be by way of a random request. In many games of LOTTO, the majority of entries involve a random request for numbers, generally less than 8 in total. In this example of the game, there are 25 numbers. It is therefore believed that most entries into a game will be by random number request. Players can be given the choice to select their SUPERLINK number.

The request for the creation and supply of random game cards, especially when many players are playing the game, could see a large number of requests arrive in a very short period of time, such as a second. This will be more so as the game entry period comes to an end. Accordingly the software code needs to be as efficient as possible, and able to handle these surges.

### The Algorithm to Draw Card Numbers Ready for the Game

The numbers are stored in an array the size of the card. In this example of a 25 matrix (5×5) card, the array is of 25 numbers.

We believe that the following process is the most efficient way to handle and process this exampled game:

First, a 25 element array is created and loaded with the following numbers in order: |1|2|3|4|5|6|7|8|9|10|11|12|13|14|15|16|17|18|19|20|21|22|23|24|25|

Second, create a random number between 1 and 25. The number returned is used as an index to select the first item. The item selected is swapped with the 25^{th} element.

So if 10 was chosen you would have |1|2|3|4|5|6|7|8|9|25|11|12|13|14|15|16|17|18|19|20|21|22|23|24|10|

Third, then create a random number sourced from between index 1 to 24, and swap the selected index content with the 24^{th} element.

So if 4 is chosen you would get: |1|2|3|24|5|6|7|8|9|25|11|12|13|14|15|16|17|18|19|20|21|22|23|4|10|

Fourth, this is repeated in a loop until the final action where you create a number from the last two remaining indexes, 1 and 2, to decide the 2^{nd} element. The 1^{st} element is the remainder.

In Summary, The loop draws 24 random numbers and fills in the card with just 24 random swap operations (with the last number automatically filling the 25^{th} placement). This process allows for cards to be generated very quickly.

### Scoring a Card

It is important that after closure of the game and then during and/or following the random draw to determine the results for each card, that cards can be scored very quickly. Further, all game cards must be processed before the game result can be displayed. Further, as game cards can be stored to participate in an end of year draw (or some other periodic event), a very large number of cards may have to be processed (in this example, a full year of entries) and ordered as quickly as possible for the end of year draw.

### The Algorithm to Score Each Card as Quickly as Possible

Assume that the separate results draw of the 25 numbers is: |6|20|23|25|10|15|7|18|8|2|22|19|12|13|14|5|17|21|24β|16|4|9|11|1|

Assume that the game card is: |13|7|12|17|18|8|5|22|10|19|15|25|16|24|21|2|1|20|11|14|9|23|3|4|6|

First, the computer software checks to see if the last drawn number in the results draw matches the players number in the bottom right hand cell of the card, i.e. the 25^{th} position of the game card. If so the computer program will record the relevant card as a SUPERLINK card.

Second, the computer software then loops through each player's game card and creates a list of the relevant links on or in each game card, where a number drawn in the results draw links with the immediately prior drawn number, as those numbers are positioned on the player's card.

This is processed for all numbers giving the following list of coordinates (The “coordinate list”): |25|18|22|12|9|11|2|5|6|16|8|10|3|1|20|7|4|15|14|23|13|24|21|19|17|

Form the above list of coordinates:
First number drawn was 6; and it is in position 25 on the card
Second number drawn was 20, its at position 18 on the card
Third number drawn was 23, and it is at position 22 on the card
And so on.

The coordinates describe the path of the draw across the card and can be used by the computer program to calculate the direction of travel for each step.

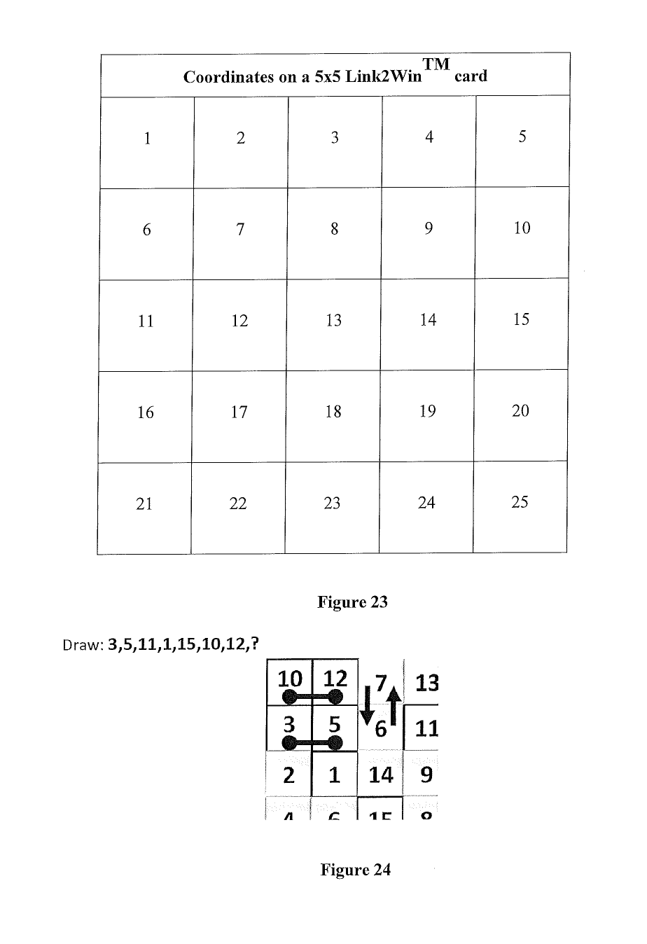

The table below shows the coordinates which we have assigned to each cell on the 5×5 Matrix. This is also set out in FIG. 23.

Coordinates on a 5 × 5 Link2Win ™ card

| | | | | |
|---|---|---|---|---|
| 1 | 2 | 3 | 4 | 5 |
| 6 | 7 | 8 | 9 | 10 |
| 11 | 12 | 13 | 14 | 15 |
| 16 | 17 | 18 | 19 | 20 |
| 21 | 22 | 23 | 24 | 25 |

Third, in this example of the game, mid-size links (3 long on a 25 matrix card) are only valid in the centre elements of the card. These are coordinates 7, 8, 9, 12, 13, 14, 17, 18, 19. Accordingly, alongside the processed list the computer program identifies and stores whether each mid-size link is in the centre region or not by reference to the coordinates.

This can be done by looping through each position in the processed list and creating a list which is set to ‘1’ if in the middle section, and ‘0’ if not.

For this example, this would create the centre list as follows: |0|1|0|1|1|0|0|0|0|0|1|0|0|0|0|1|0|0|1|0|1|0|0|1|1|

Fourth, following the completion of the coordinate list, the computer program tests if each step forms a link to an adjacent location (horizontally, vertically, and diagonally).

This can be done by stepping through the coordinate list in turn, testing each location, and its immediate next location, in all directions, to see if there are any relevant adjacent links. This can be done quickly by the computer program storing the adjacency rules in a two dimensional array. The first dimension is the current point, and the second dimension is the next point.

The array result provides the vector for each link found on the card. For the example card this would be: |0|0|0|0|0|0|0|0|0|0|0|0|0|0|7|0|0|6|0|0|0|0|0|0|0|

This exampled card has just 2 adjacent sets of links.

The values that have been used are:
0. The points are NOT adjacent.
1. Vertical up.
2. Diagonal up, left.
3. Horizontal left.
4. Diagonal down, left.
5. Vertical down.
6. Diagonal down, right.
7. Horizontal right.
8. Diagonal up right.

Fifth, the final stage is for the computer software to work through the vector list and to find and calculate how many of the links are:
Long Links (5 long)
Mid Links (3 long) and
Short Links (2 long).

This is achieved by the computer software looping through the vectors. From each position a check is first made for a valid Long Link (5 long), then a valid Mid Link in the centre area using the centre list (3 long), and then a valid Short Link (2 long).

A total of each type of link is stored, which provides the card score, with prize-winning opportunities in all 3 categories.

During the scoring a Link List is generated. This is similar to the vector list, but each link only has one entry. The link length is coded such that the first digit indicates the length of the link and the second link shows the link direction as follows:
01-08 Short Link (2 long)
11-18 Mid Link (3 long)
21-28 Long Link (5 long)

The example card only has Short Links and so the Link list is exactly the same as the Vector list.

If the vector list has a set of links forming a long link such as |2|2|2|2|2| this would become |22|0|0|0|0|

The Link List provides the number and type of links on each matrix card. The total for each link type is calculated by counting the links of each size and is stored.

### Delivery of Results

To allow the game draw to be animated on each player's computer device, the following information is stored by the gaming operator's computer software for each card:
The Card's 25 numbers and their positions of placement on each card.
The processed list. This is used to animate the numbers in order.
The Link List. This is used to draw the lines on the card during the draw and provide the score animation.

### Example 1.14—Above Methods Followed

The above described computer processing methods were used when processing a simulated 82.958 billion card run and its results, the results of which are set out in Tables 4-8 below.

A skilled person will appreciate from the simulation results set out in Tables 4-8 below that the computer is an integral part of the present invention.

### Example 1.15—Odds, Stats from the Process of a 82.958 Billion (5×5) Card Run

### 2 Links

TABLE 4
2 Links - Excluding SUPERLINK

| | | | Percentage From |
|---|---|---|---|
| | Number From | Simulated | 82.958 Billion |
| No. of | 82.958 Billion | Odds ¹ | Card Run % |
| 2 Links | Card Run | 1 in . . . | (to 5 decimal places) |
| 0 | 92,339,829 | 898.4 | 0.11131 |
| 1 | 754,593,803 | 109.9 | 0.90961 |
| 2 | 2,904,311,049 | 28.5 | 3.50094 |
| 3 | 7,010,631,386 | 11.8 | 8.45082 |
| 4 | 11,920,509,234 | 6.9 | 14.36933 |
| 5 | 15,199,948,853 | 5.4 | 18.32246 |
| 6 | 15,104,963,648 | 5.5 | 18.20796 |
| 7 | 12,000,571,487 | 6.9 | 14.46584 |
| 8 | 7,755,756,398 | 10.7 | 9.34902 |
| 9 | 4,127,286,456 | 20.1 | 4.97515 |
| 10 | 1,822,984,542 | 45.5 | 2.19748 |
| 11 | 671,719,387 | 123.5 | 0.80971 |
| 12 | 207,007,065 | 400.7 | 0.24953 |
| 13 | 53,340,465 | 1,555.2 | 0.06430 |
| 14 | 11,467,371 | 7,234.2 | 0.01382 |
| 15 | 2,047,975 | 40,507.3 | 0.00247 |
| 16 | 301,979 | 274,714.4 | 0.00036 |
| 17 | 36,032 | 2,302,342.2 | 0.00004 |
| 18 | 3,380 | 24,543,788.0 | 0.00000 |
| 19 | 266 | 311,872,192.0 | 0.00000 |
| 20 | 14 | 5,925,571,854.0 | 0.00000 |
| 21 | 1 | 82,958,000,000.0 | 0.00000 |
| 22 | | | 0.00000 |
| 23 | | | 0.00000 |
| 24 | | | 0.00000 |
| Totals | 79,639,820,620 | | |

¹ From 82,958,000,000 Card Run Simulation

TABLE 5
2 Links - with SUPERLINK

| | | | Percentage From |
|---|---|---|---|
| | Number From | Simulated | 82.958 Billion |
| No. of | 82.958 Billion | Odds ² | Card Run % |
| 2 Links | Card Run | 1 in . . . | (to 5 decimal places) |
| 0 | 3,267,260 | 25,390.7 | 0.00394 |
| 1 | 27,488,602 | 3,017.9 | 0.03314 |
| 2 | 108,889,762 | 761.8 | 0.13126 |
| 3 | 270,382,769 | 306.8 | 0.32593 |
| 4 | 472,896,860 | 175.4 | 0.57004 |
| 5 | 620,058,043 | 133.8 | 0.74744 |
| 6 | 633,606,355 | 130.9 | 0.76377 |
| 7 | 517,548,281 | 160.3 | 0.62387 |
| 8 | 343,972,242 | 241.1 | 0.41463 |
| 9 | 188,258,101 | 440.6 | 0.22693 |
| 10 | 85,567,880 | 969.5 | 0.10315 |
| 11 | 32,466,718 | 2,555.1 | 0.03914 |
| 12 | 10,298,080 | 8,055.6 | 0.01241 |
| 13 | 2,739,461 | 30,282.6 | 0.00330 |
| 14 | 607,334 | 136,593.7 | 0.00073 |
| 15 | 112,166 | 739,600.2 | 0.00014 |
| 16 | 17,191 | 4,825,664.5 | 0.00002 |
| 17 | 2,047 | 40,526,624.0 | 0.00000 |
| 18 | 206 | 402,708,736.0 | 0.00000 |
| 19 | 19 | 4,366,210,560.0 | 0.00000 |
| 20 | 2 | 41,479,000,064.0 | 0.00000 |
| 21 | 1 | 82,958,000,000.0 | 0.00000 |
| 22 | | | 0.00000 |
| 23 | | | 0.00000 |
| 24 | | | 0.00000 |
| Totals | 3,318,179,380 | | |

² From 82,958,000,000 Card Run Simulation

### 3 Links

TABLE 6
3 Links - Excluding SUPERLINK

| | | | Percentage From |
|---|---|---|---|
| | Number From | Simulated | 82.958 Billion |
| No. of | 82.958 Billion | Odds ³ | Card Run % |
| 3 Links | Card Run | 1 in . . . | (to 5 decimal places) |
| 0 | 77,540,364,059 | 1.07 | 93.46941 |
| 1 | 2,087,032,877 | 39.75 | 2.51577 |
| 2 | 12,404,278 | 6,687.85 | 0.01495 |
| 3 | 19,406 | 4,274,863.50 | 0.00002 |
| Totals | 79,639,820,620 | | |

³ From 82,958,000,000 Card Run Simulation

TABLE 7
3 Links - With SUPERLINK

| | | | Percentage From |
|---|---|---|---|
| | Number From | Simulated | 82.958 Billion |
| No. of | 82.958 Billion | Odds ⁴ | Card Run % |
| 3 Links | Card Run | 1 in . . . | (to 5 decimal places) |
| 0 | 3,222,810,622 | 25.74 | 3.88487 |
| 1 | 94,746,581 | 875.57 | 0.11421 |
| 2 | 621,080 | 133,570.56 | 0.00075 |
| 3 | 1,097 | 75,622,608.00 | 0.00000 |
| Totals | 3,318,179,380 | | |

⁴ From 82,958,000,000 Card Run Simulation

### 5 Links

TABLE 8
5 Links - All Cards

| | | | Percentage From |
|---|---|---|---|
| | Number From | Simulated | 82.958 Billion |
| No. of | 82.958 Billion | Odds ⁵ | Card Run % |
| 3 Links | Card Run | 1 in ... | (to 5 decimal places) |
| 0 | 82,951,439,471 | 1.00 | 99.99209 |
| 1 | 6,560,331 | 12,645.40 | 0.00791 |
| 2 | 198 | 418,979,808.00 | 0.00000 |
| 3 | | | |
| 4 | | | |
| 5 | | | |
| Totals | 82,958,000,000 | | |

⁵ From 82,958,000,000 Card Run Simulation

Important Note: SUPERLINK does not (in this example) apply to 5 Links. Accordingly, the above numbers from Table 8 comprise all of the Cards in the run of 82,958,000,000. The reasons that the rules in this example exclude SUPERLINK applying to 5 Links are that some 5 links will contain the SUPERLINK number, and accordingly there is no multiplying effect on the odds for those 5 Links. Further, the odds of 2×5 Links are already at 1 in 418,979,808. Finally, it makes for a simple rule for players to understand that SUPERLINK only applies to the 2 and 3 Link prizes in this Example 1.

### Example 1.16—Prize Winning Chances

Each Link2Win™ card in this Example 1 has overall winning chances for any prize of:
24.01%, or
odds of 1 in 4.15

### Example 1.17—Use of Entry Fee

TABLE 9
Game Entry Fee Allocations - Overview

| | Allocation of | Percent- | |
|---|---|---|---|
| For | £5 Entry Fee | age | Comment |
| Standard game | £2.230759 | 44.61% | Inclusive of Insured |
| | | | Prize Costs |
| SUPERLINK | £0.613381 | 12.27% | Inclusive of Insured |
| game | | | Prize Costs |
| Contingency + | £0.655860 | 13.12% | A Base contingency of at |
| Yearly Draw | | | least 10% is proposed. |
| | | | Each Link2Win ™ card |
| | | | is also entered into a |
| | | | yearly or other periodic |
| | | | draw, |
| | | | Prizes in this example are |
| | | | pari-mutuel prizes, paid to |
| | | | Top 3 Ranked Link2Win ™ |
| | | | cards: determined by |
| | | | Most/best 5s, or if none or there |
| | | | are ties, then by reference to |
| | | | Most/best 3s, and so on. |
| Sub Total | £3.500000 | 70% | |
| Operator/ | £1.500000 | 30% | |
| Link2Win ™ | | | |
| | £5.000000 | 100% | |

### Example 1.18—Prizes and Odds, and Prize Costing

TABLE 10
Standard Game (excluding SUPERLINK)
Link2Win ™, excluding SUPERLINK

| | | | | | | |
|---|---|---|---|---|---|---|
| Match | | | | | | |
| Prizes | | | | | | |
| in order | | | | | | |
| or | Base Prize | | | | | |
| reverse | * Insured | | | | Total % | Insurance % |
| Diagonal | Prize | | | Number of | Cost | Cost |
| Horizontal, | “BC” = | | Odds | expected | Per each | @2.5x Risk |
| or | £5 Bonus | Odds: | From | entries from | Original | Per each |
| Vertical | Card | 1 in . . . | Simulation | 1 Entry⁶ | £5 entry | £5 entry |

5 Link Prizes

| | | | | | | |
|---|---|---|---|---|---|---|
| 2+ | £25,000,000* | 418,979,808 | Sim | 0.000000002 | £0.149172 | £0.149172 |
| 1 | £1,000 | 12,645 | Sim | 0.000079083 | £0.079083 | |
| | | | | | £0.228255 | |

3 Link Prizes

| | | | | | |
|---|---|---|---|---|---|
| 3 | £10,000 | 4,274,863 | Sim | 0.000000234 | £0.002340 |
| 2 | £100 | 6,687 | Sim | 0.000149544 | £0.014955 |
| 1 | £10 (incl. | 39.7 | Sim | 0.025188917 | £0.251890 |
| | BC) | | | | |
| | | | | | £0.269185 |

2 Link Prizes

| | | | | | | |
|---|---|---|---|---|---|---|
| 18+ | £500,000* | 22,659,928⁷ | Sim | 0.000000044 | £0.055164 | £0.055164 |
| 17 | £50,000* | 2,302,342 | Sim | 0.000000434 | £0.054293 | £0.054293 |
| 16 | £10,000 | 274,714 | Sim | 0.000003640 | £0.036402 | |
| 15 | £1,000 | 40,507 | Sim | 0.000024687 | £0.024687 | |
| 14 | £100 | 7,234 | Sim | 0.000138236 | £0.013824 | |
| 13 | £50 | 1,555 | Sim | 0.000643087 | £0.032154 | |
| 12 | £25 | 401 | Sim | 0.002493766 | £0.062344 | |
| 11 | £10 (incl. | 123 | Sim | 0.008130081 | £0.081301 | |
| | BC) | | | | | |
| 10 | £8 (incl. BC) | 45 | Sim | 0.022222222 | £0.177778 | |
| 9 | £6 (incl. BC) | 20.1 | Sim | 0.049751244 | £0.298507 | |
| 8 | £0 | 10.7 | Sim | 0.093457944 | £0.000000 | |
| 7 | £0 | 6.9 | Sim | 0.144927536 | £0.000000 | |
| 6 | £0 | 5.5 | Sim | 0.181818182 | £0.000000 | |
| 5 | £0 | 5.4 | Sim | 0.185185185 | £0.000000 | |
| 4 | £0 | 6.9 | Sim | 0.144927536 | £0.000000 | |
| 3 | £6 (incl. BC) | 11.8 | Sim | 0.084745763 | £0.508475 | |
| 2 | £8 (incl. BC) | 28.5 | Sim | 0.035087719 | £0.280702 | |
| 1 | £10 (incl. BC) | 109.9 | Sim | 0.009099181 | £0.090992 | |
| 0 | £15 | 898.4 | Sim | 0.001113090 | £0.016696 | |
| | | | | | £1.733319 | |

| | |
|---|---|
| Total Scenario A | £2.230759 |
| The Overall Target is £3.00 (60%) (based on SUPERLINK costs in Table | £2.386619 |
| 11 of £0.613381), so this Table 10's Target is: | |
| Difference is: which goes to extra prizes or added to the 10% contingency | £0.155860 |

⁶Calc: 1 Entry (1) divided by the odds
⁷See Table 1: Add the number of cards for 18 × 2 Links and above; 3,380 + 266 + 14 + 1 = 3,661. Then divide the total cards of 82.958 Billion by 3,661 = 22,659,928.98

TABLE 11
SUPERLINK
SUPERLINK

| Match | | | | | | |
|---|---|---|---|---|---|---|
| Prizes | | | | | | |
| in order | Base Prize | | | | | |
| or | * Insured | | | | | Insurance |
| reverse | Prize | | | Number of | Total % Cost | % Cost |
| Diagonal | “BC” = | | Odds | expected | Per each | @2.5x Risk |
| Horizontal, | £5 Bonus | Odds: | From | entries from | Original | Per each |
| or Vertical | Card | 1 in . . . | Simulation | 1 Entry⁸ | £5 entry | £5 entry |
| 3 Link | | | | | | |
| Prizes | | | | | | |
| 3 | £1,000,000* | 75,622,608 | Sim | 0.000000013 | £0.033059 | £0.033059 |
| 2 | £1,000 | 133,570 | Sim | 0.000007487 | £0.007487 | |
| 1 | £100 | 875 | Sim | 0.001142857 | £0.114286 | |
| | | | | | £0.154832 | |
| 2 Link | | | | | | |
| Prizes | | | | | | |
| 18+ | £10,000,000* | 363,850,877⁹ | Sim | 0.000000003 | £0.068710 | £0.068710 |
| 17 | £500,000* | 40,526,624 | Sim | 0.000000025 | £0.030844 | £0.030844 |
| 16 | £25,000 | 4,825,644 | Sim | 0.000000207 | £0.005181 | |
| 15 | £5,000 | 739,600 | Sim | 0.000001352 | £0.006760 | |
| 14 | £500 | 136,593 | Sim | 0.000007321 | £0.003661 | |
| 13 | £125 | 30,282 | Sim | 0.000033023 | £0.004128 | |
| 12 | £100 | 8,055 | Sim | 0.000124146 | £0.012415 | |
| 11 | £50 | 2,555 | Sim | 0.000391389 | £0.019569 | |
| 10 | £40 | 969 | Sim | 0.001031992 | £0.041280 | |
| 9 | £35 | 440 | Sim | 0.002272727 | £0.079545 | |
| 8 | £0 | 241 | Sim | 0.004149378 | £0.000000 | |
| 7 | £0 | 163 | Sim | 0.006134969 | £0.000000 | |
| 6 | £0 | 131 | Sim | 0.007633588 | £0.000000 | |
| 5 | £0 | 133 | Sim | 0.007518797 | £0.000000 | |
| 4 | £0 | 175 | Sim | 0.005714286 | £0.000000 | |
| 3 | £25 | 306 | Sim | 0.003267974 | £0.081699 | |
| 2 | £50 | 761 | Sim | 0.001314060 | £0.065703 | |
| 1 | £100 | 3,017 | Sim | 0.000331455 | £0.033146 | |
| 0 | £150 | 25,390 | Sim | 0.000039386 | £0.005908 | |
| | | | | | £0.458549 | |

| | |
|---|---|
| Total Scenario A | £0.613381 |

⁸Calc: 1 Entry (1) divided by the odds
⁹See Table 2: Add the number of SUPERLINK cards for 18 × 2 Links and above; 206 + 19 + 2 + 1 = 228. Then divide the total cards of 82.958 Billion by 228 = 363,850,877.2

### Variations to Prizes:

There are many variations that are possible. For example, the following variation could be achieved: Table 10: The top prize of 5 Link×2+ could be increased to £100 million. The extra cost would be £0.447576. This could be fully funded by eliminating the “2 Link×3” prize of £6 for example, and still leaving from that one prize elimination an extra surplus savings. The odds to win a prize would increase, from 1 in 4.15, to c. 1 in 6.5.

### Example 1.19—Overall Probability of Winning

In this Example 1, there are 36 Prize Tiers in each Link2Win™ Game, with each card having the chance to win in 3 separate prize categories, one in each of the 2, 3 and 5 Link categories. This Table 12 is organized based on the odds in Column 3.

TABLE 12
Odds

| Prize Categories | | | | | |
|---|---|---|---|---|---|
| Need to Match . . . | | Column 3 | Average | | |
| Standard | SUPERLINK | Odds | Prize | Entry | Return on |
| Game | Game | 1 in . . . | (set) | Cost | Entry Cost |
| 5 Links x 2+ | | 418,979,808 | £25,000,000 | £5 | x 5,000,000 |
| | 2 Links x 18+ | 363,850,877 | £10,000,000 | £5 | x 2,000,000 |
| | 3 Links x 3 | 75,622,608 | £1,000,000 | £5 | x 200,000 |
| | 2 Links x 17 | 40,526,624 | £500,000 | £5 | x 100,000 |
| 2 Links x 18+ | | 22,659,928 | £500,000 | £5 | x 100,000 |
| | 2 Links x 16 | 4,825,644 | £25,000 | £5 | x 5,000 |
| 3 Links x 3 | | 4,274,863 | £10,000 | £5 | x 2,000 |
| 2 Links x 17 | | 2,302,342 | £50,000 | £5 | x 10,000 |
| | 2 Links x 15 | 739,600 | £5,000 | £5 | x 1,000 |
| 2 Links x 16 | | 274,714 | £10,000 | £5 | x 2,000 |
| | 2 Links x 14 | 136,593 | £500 | £5 | x 100 |
| | 3 Links x 2 | 133,570 | £1,000 | £5 | x 200 |
| 2 Links x 15 | | 40,507 | £1,000 | £5 | x 200 |
| | 2 Links x 13 | 30,282 | £125 | £5 | x 25 |
| | No 2 Links | 25,390 | £150 | £5 | x 30 |
| 5 Links x 1 | | 12,645 | £1,000 | £5 | x 200 |
| | 2 Links x 12 | 8,055 | £100 | £5 | x 20 |
| 2 Links x 14 | | 7,234 | £100 | £5 | x 20 |
| 3 Links x 2 | | 6,687 | £100 | £5 | x 20 |
| | 2 Links x 1 | 3,017 | £100 | £5 | x 20 |
| | 2 Links x 11 | 2,555 | £50 | £5 | x 10 |
| 2 Links x 13 | | 1,555 | £50 | £5 | x 10 |
| | 2 Links x 10 | 969 | £40 | £5 | x 8 |
| No 2 Links | | 898 | £15 | £5 | x 3 |
| | 3 Links x 1 | 875 | £100 | £5 | x 20 |
| | 2 Links x 2 | 761 | £50 | £5 | x 10 |
| | 2 Links x 9 | 440 | £35 | £5 | x 7 |
| 2 Links x 12 | | 401 | £25 | £5 | x 5 |
| | 2 Links x 3 | 306 | £25 | £5 | x 5 |
| 2 Links x 11 | | 123 | £10 | £5 | x 2 |
| 2 Links x 1 | | 109.9 | £10 | £5 | x 2 |
| 2 Links x 10 | | 45 | £8 | £5 | x 1.6 |
| 3 Links x 1 | | 39.7 | £10 | £5 | x 2 |
| 2 Links x 2 | | 28.5 | £8 | £5 | x 1.6 |
| 2 Links x 9 | | 20.1 | £6 | £5 | x 1.2 |
| 2 Links x 3 | | 11.8 | £6 | £5 | x 1.2 |

Overall Odds of winning a prize in Link2Win ™ are 1 in 4.15
Plus every Card is also in the annual Draw
Top 3 Cards win the prize pool established from the 10% Contingency

### Example 1.14—Looking at the ODDS

We set out below the EuroMillions and PowerBall odds and prizes, so that a comparison can be made with the example of the Link2Win™ game set out in this Example 1, at Table 12.

### EuroMillions

There are 13 prize tiers in each EuroMillions draw and the estimated jackpot is published prior to the draw. The exact prize value of each tier, including the jackpot*, is calculated according to how many tickets are sold in a particular draw and how many winning tickets there are in any given prize tier.

EuroMillions involves picking numbers from 2 set of numbers:
Pick 5 from 50 (always the first reference), and then 2 from 11.

TABLE 13a
Average prize amounts calculated using results
drawn between 10 May 2011 and 31 Oct. 2014

| | | |
|---|---|---|
| Match 5 + 2 Lucky Stars | 1 in 116,531,800 | [symbol] 51,771,309.34 |
| Match 5 + 1 Lucky Star | 1 in 6,473,989 | [symbol] 420,132.31 |
| Match 5 | 1 in 3,236,995 | [symbol] 71,399.02 |
| Match 4 + 2 Lucky Stars | 1 in 517,920 | [symbol] 4,736.86 |
| Match 4 + 1 Lucky Star | 1 in 28,774 | [symbol] 211.80 |
| Match 4 | 1 in 14,487 | [symbol] 104.96 |
| Match 3 + 2 Lucky Stars | 1 in 11,771 | [symbol] 63.89 |
| Match 2 + 2 Lucky Stars | 1 in 882 | [symbol] 20.77 |
| Match 3 + 1 Lucky Star | 1 in 654 | [symbol] 15.06 |
| Match 3 | 1 in 327 | [symbol] 12.24 |
| Match 1 + 2 Lucky Stars | 1 in 157 | [symbol] 10.79 |
| Match 2 + 1 Lucky Star | 1 in 46 | [symbol] 8.06 |
| Match 2 | 1 in 23 | [symbol] 4.08 |

The overall odds of winning a prize in Euromillions are 1 in 13

TABLE 13b
EuroMillions

| Prize Categories | Odds | Average | Entry | Return on |
|---|---|---|---|---|
| Need to Match | 1 in . . . | Prize | Cost | Entry Cost |
| 5 + 2 | 116,531,800 | [symbol] 52,000,000 | [symbol] 2 | x 26,000,000 |
| 5 + 1 | 6,473,989 | [symbol] 420,000 | [symbol] 2 | x 210,000 |
| 5 | 3,236,995 | [symbol] 70,000 | [symbol] 2 | x 35,000 |
| 4 + 2 | 517,920 | [symbol] 4,700 | [symbol] 2 | x 2,350 |
| 4 + 1 | 28,774 | [symbol] 212 | [symbol] 2 | x 106 |
| 4 | 14,487 | [symbol] 105 | [symbol] 2 | x 53 |
| 3 + 2 | 11,771 | [symbol] 64 | [symbol] 2 | x 32 |
| 2 + 2 | 882 | [symbol] 21 | [symbol] 2 | x 11 |
| 3 + 1 | 654 | [symbol] 15 | [symbol] 2 | x 7 |
| 3 | 327 | [symbol] 12 | [symbol] 2 | x 6 |
| 1 + 2 | 157 | [symbol] 11 | [symbol] 2 | x 5 |
| 2 + 1 | 46 | [symbol] 8 | [symbol] 2 | x 4 |
| 2 | 23 | [symbol] 4 | [symbol] 2 | x 2 |

### American PowerBall

The Basic game involves:
The minimum Powerball bet is $2.
In each game, players select five numbers from a set of 59 white balls and one number from 35 red Powerballs.
The number chosen from the red Powerballs may be the same as one of the numbers chosen from the white balls.

TABLE 14
American PowerBall
Payouts after Jan. 9, 2014 are:

| | | Power | Power | Power | Power | |
|---|---|---|---|---|---|---|
| | | Play 2x (1 | Play 3x (1 | Play 4x (1 | Play 5x (1 | Odds of |
| Matches | Prize | in 2) | in 3⅓) | in 10) | in 10) | winning[19] |
| Only | $4 | $8 | $12 | $16 | $20 | 1 in 55.41 |
| Powerbal 1 | | | | | | |
| 1 number | $4 | $8 | $12 | $16 | $20 | 1 in 110.81 |
| plus PB | | | | | | |
| 2 | $7 | $14 | $21 | $28 | $35 | 1 in 706.43 |
| numbers | | | | | | |
| plus PB | | | | | | |
| 3 | $7 | $14 | $21 | $28 | $35 | 1 in 360.14 |
| numbers; | | | | | | |
| no PB | | | | | | |
| 3 | $100 | $200 | $300 | $400 | $500 | 1 in 12,244.83 |
| numbers | | | | | | |
| plus PB | | | | | | |
| 4 | $100 | $200 | $300 | $400 | $500 | 1 in 19,087.53 |
| numbers; | | | | | | |
| no PB | | | | | | |
| 4 | $10,000 | $20,000 | $30,000 | $40,000 | $50,000 | 1 in |
| numbers | | | | | | 648,975.96 |
| plus PB | | | | | | |
| 5 | $1,000,000 | $2,000,000† | $2,000,000† | $2,000,000† | $2,000,000† | 1 in |
| numbers; | | | | | | 5,153,632.65 |
| no PB | | | | | | |
| 5 | Jackpot | Jackpot†† | Jackpot†† | Jackpot†† | Jackpot†† | 1 in |
| numbers | | | | | | 175,223,510.00 |
| plus PB | | | | | | |

*California's prize amounts are variable as state law requires prizes to be pari-mutuel. Powerplay is not offered in California.
†The Power Play Match 5 stays fixed at $2,000,000 since Jan. 15, 2012.

### Example 2.0-5×5 Matrix Game—1×2 Link with £Nil Prizes

This Example 2 of the game is a similar 5×5 game to that set out in Example 1. This Example 2 has the same entry fee structure (£5) and linking rules. The key difference is the profile of the 2 Link prizes.

In addition, some adjustments have been made to the top prizes, increasing them, and to the retained percentage of the Gross Gaming Revenue retained by the Gaming Operator/Link2Win™- to demonstrate the flexibility of this invention.

### Number of Link2Win™ Card Simulations

In this Example 2 of the game, we ran a Link2Win™ Card simulation that comprised 139.828 Billion card run. The simulated odds correlate with those simulated odds set out in Example 1. For example, compare Example 1.18, Table 10 with Example 2.4, Table 16.

### Example 2.1-2 Link Prize Profile

In this Example 2, only one (1) set of a 2 Link has a £nil prize.

(Note: Example 1 had 5 sets of a 2 Link with a £nil prize, see Example 1.18 and Tables 10 and 11.)

In this Example 2, the initial starting prize credit for the 2 Link prizes will:
Initially go down in monetary value during the draw as the card gets one to four 2 Links;
Go to a zero monetary amount once the card gets to five 2 Links;
At six 2 Links, the displayed prize for 2 Links will go positive again, and rise increasingly further as the card gets seven or more 2 Links—see Tables 16 and 17.

### Example 2.2—Prize Winning Chances

In this Example 2 of the Link2Win™ game, each Link2Win™ card has overall winning chances for any prize of:
81.5%, or
odds of 1 in 1.27.

Note: In Example 1, the chances of winning any prize was 24.01%, or odds of 1 in 4.15—see Example 1.16. The reason why the overall winning chances have increased in this Example 2 is primarily because of the changes made to the 2 Link prize profile, as set out in Example 2.1 above.

### Example 2.3—Use of Entry Fee

TABLE 15
Entry Fee Allocations

| | Allocation of | | |
|---|---|---|---|
| For | £5 Entry Fee | Percentage | Comment |
| Standard game | £2.741106 | 54.82% | Inclusive of Insured |
| | | | Prize Costs |
| SUPERLink game | £1.167933 | 23.36% | Inclusive of Insured |
| | | | Prize Costs |
| Contingency | £0.090961 | 1.82% | |
| Sub Total | £4.00 | 80% | |
| Operator/Link2Win ™ | £1.00 | 20% | |
| | £5.00 | 100% | |

### Example 2.4—Prizes and Odds, and Prize Costing

TABLE 16
Standard Game (excluding SUPERLink)
Link2Win ™, excluding SUPERLink

| | | | | | | |
|---|---|---|---|---|---|---|
| | | | Odds | Number of | Total % Cost | Insurance % |
| | Base Prize | | Estimate | expected | Per each | Cost |
| Match | * Insured | Odds: | Or From | entries from | Original | @2.5x |
| Prizes | Prize | 1 in . . . | Simulation | 1 Entry¹⁰ | £5 entry | Risk |

5 Link Prizes

| | | | | | | |
|---|---|---|---|---|---|---|
| 2+ | £25,000,000* | 452,517,799.4 | Sim | 0.000000002 | £0.138116 | £0.138116 |
| 1 | £1,000 | 13,197.0 | Sim | 0.000075775 | £0.075775 | |
| | | | | | £0.213891 | |

3 Link Prizes

| | | | | | | |
|---|---|---|---|---|---|---|
| 3 | £100,000 | 4,253,582.0 | Sim | 0.000000235 | £0.058774 | £0.058774 |
| 2 | £100 | 6,687.7 | Sim | 0.000149529 | £0.014953 | |
| 1 | £10 | 39.7 | Sim | 0.025157724 | £0.251577 | |
| | | | | | £0.325304 | |

2 Link Prizes

| | | | | | | |
|---|---|---|---|---|---|---|
| 18+ | £1,000,000* | 22,531,098.9 | Sim | 0.000000044 | £0.110958 | £0.110958 |
| 17 | £50,000* | 2,299,651.3 | Sim | 0.000000435 | £0.054356 | £0.054356 |
| 16 | £10,000 | 275,111.2 | Sim | 0.000003635 | £0.036349 | |
| 15 | £1,000 | 40,538.4 | Sim | 0.000024668 | £0.024668 | |
| 14 | £100 | 7,233.7 | Sim | 0.000138241 | £0.013824 | |
| 13 | £50 | 1,555.0 | Sim | 0.000643090 | £0.032154 | |
| 12 | £25 | 400.8 | Sim | 0.002495181 | £0.062379 | |
| 11 | £15 | 123.5 | Sim | 0.008097439 | £0.121462 | |
| 10 | £10 | 45.5 | Sim | 0.021974646 | £0.219746 | |
| 9 | £5 | 20.1 | Sim | 0.049750955 | £0.248755 | |
| 8 | £3 | 10.7 | Sim | 0.093490599 | £0.280472 | |
| 7 | £2 | 6.9 | Sim | 0.144657184 | £0.289314 | |
| 6 | £1 | 5.5 | Sim | 0.182079687 | £0.182080 | |
| 5 | £0 | 5.4 | Sim | 0.183223966 | £0.000000 | |
| 4 | £1 | 7.0 | Sim | 0.143694104 | £0.143694 | |
| 3 | £2 | 11.8 | Sim | 0.084508301 | £0.169017 | |
| 2 | £3 | 28.6 | Sim | 0.035009732 | £0.105029 | |
| 1 | £10 | 109.9 | Sim | 0.009095818 | £0.090958 | |
| 0 | £15 | 898.4 | Sim | 0.001113038 | £0.016696 | |
| | | | | | £2.201911 | |

| | | |
|---|---|---|
| Total Standard Game | £2.741106 | £0.362204 |

¹⁰Calc: 1 Entry (1) divided by the odds

TABLE 17
SUPERLink
SUPERLink

| | | | | | | |
|---|---|---|---|---|---|---|
| | | | | | Total % | |
| | | | Odds | Number of | Cost | Insurance |
| | Base Prize | | Estimate | expected | Per each | % Cost |
| Match | * Insured | Odds: | Or From | entries from | Original | @2.5x |
| Prizes | Prize | 1 in . . . | Simulation | 1 Entry | £5 entry | Risk |

5 Link Prizes

| | | | | | | |
|---|---|---|---|---|---|---|
| 2+ | £25,000,000* | See note¹¹ | Sim | 0.0000000001 | £0.006258 | £0.006258 |
| 1 | £10,000 | 303,925.7 | Sim | 0.000003290 | £0.032903 | |
| | | | | | £0.039161 | |

3 Link Prizes

| | | | | | | |
|---|---|---|---|---|---|---|
| 3 | £5,000,000* | 76,534,209.1 | Sim | 0.000000013 | £0.163326 | £0.163326 |
| 2 | £1,000 | 133,566.9 | Sim | 0.000007487 | £0.007487 | |
| 1 | £100 | 875.6 | Sim | 0.001142022 | £0.114202 | |
| | | | | | £0.285015 | |

2 Link Prizes

| | | | | | | |
|---|---|---|---|---|---|---|
| 18+ | £10,000,000* | 350,446,115.3 | Sim | 0.000000003 | £0.071338 | £0.071338 |
| 17 | £500,000* | 39,905,251.1 | Sim | 0.000000025 | £0.031324 | £0.031324 |
| 16 | £25,000 | 4,838,339.1 | Sim | 0.000000207 | £0.005167 | |
| 15 | £5,000 | 740,500.7 | Sim | 0.000001350 | £0.006752 | |
| 14 | £500 | 136,649.9 | Sim | 0.000007318 | £0.003659 | |
| 13 | £125 | 30,284.9 | Sim | 0.000033020 | £0.004127 | |
| 12 | £100 | 8,050.7 | Sim | 0.000124214 | £0.012421 | |
| 11 | £50 | 2,555.2 | Sim | 0.000391355 | £0.019578 | |
| 10 | £40 | 969.4 | Sim | 0.001031556 | £0.041262 | |
| 9 | £35 | 440.7 | Sim | 0.002269360 | £0.079428 | |
| 8 | £30 | 241.2 | Sim | 0.004146380 | £0.124391 | |
| 7 | £20 | 160.3 | Sim | 0.006238781 | £0.124776 | |
| 6 | £10 | 130.9 | Sim | 0.007637771 | £0.076378 | |
| 5 | £0 | 133.8 | Sim | 0.007474627 | £0.000000 | |
| 4 | £10 | 175.4 | Sim | 0.005700396 | £0.057004 | |
| 3 | £25 | 306.8 | Sim | 0.003259459 | £0.081486 | |
| 2 | £50 | 761.8 | Sim | 0.001312685 | £0.065634 | |
| 1 | £100 | 3,017.9 | Sim | 0.000331354 | £0.033135 | |
| 0 | £150 | 25,394.5 | Sim | 0.000039379 | £0.005907 | |
| | | | | | £0.843758 | |

| | | |
|---|---|---|
| Total SUPERLink | £1.167933 | £0.272245 |

¹¹SUPERLink does not apply to increase the prizes for 2 × 5 Links, so the odds are left the same as the standard game for these occurrences - but the costs relevant to providing for this occurrence has not been provided for in Table 16. This cost is contained in this SUPERLink Table 17.

### Example 2.5—Overall Probability of Winning

In this Example 2, there are 45 Prize Tiers in each Link2Win™ Game, with each card having the chance to win in 3 separate prize categories, one in each of the 2, 3 and 5 Link categories. This Table 18 is organized based on the odds in Column 3

TABLE 18
Overview of Combined Prizes for Standard and SUPERLink Games

| Prize Categories | | Column 3 | |
|---|---|---|---|
| Standard | SUPERLink | Odds | Prize |
| Game | Game | 1 in . . . | (set) |
| 5 Links × 2+ | | 432,930,831¹² | £25,000,000 |
| | 2 Links × 18+ | 350,446,115 | £10,000,000 |
| | 3 Links × 3 | 76,534,209 | £5,000,000 |
| | 2 Links × 17 | 39,905,251 | £500,000 |
| 2 Links × 18+ | | 22,531,098 | £1,000,000 |
| | 2 Links × 16 | 4,838,339 | £25,000 |
| 3 Links × 3 | | 4,253,582 | £100,000 |
| 2 Links × 17 | | 2,299,651 | £50,000 |
| | 2 Links × 15 | 740,500 | £5,000 |
| 2 Links × 16 | | 275,111 | £10,000 |
| | 2 Links × 14 | 136,650 | £500 |
| | 3 Links × 2 | 133,567 | £1,000 |
| 2 Links × 15 | | 40,538 | £1,000 |
| | 2 Links × 13 | 30,285 | £125 |
| | No 2 Links | 25,395 | £150 |
| 5 Links × 1 | | 13,197 | £1,000 |
| | 2 Links × 12 | 8,051 | £100 |
| 2 Links × 14 | | 7,234 | £100 |
| 3 Links × 2 | | 6,688 | £100 |
| | 2 Links × 1 | 3,018 | £100 |
| | 2 Links × 11 | 2,555 | £50 |
| 2 Links × 13 | | 1,555 | £50 |
| | 2 Links × 10 | 969 | £40 |
| No 2 Links | | 898 | £15 |
| | 3 Links × 1 | 875 | £100 |
| | 2 Links × 2 | 762 | £50 |
| | 2 Links × 9 | 441 | £35 |
| 2 Links × 12 | | 401 | £25 |
| | 2 Links × 3 | 307 | £25 |
| | 2 Links × 8 | 241 | £30 |
| | 2 Links × 4 | 175 | £10 |
| | 2 Links × 7 | 160 | £20 |
| | 2 Links × 6 | 131 | £10 |
| 2 Links × 11 | | 123 | £15 |
| 2 Links × 1 | | 110 | £10 |
| 2 Links × 10 | | 45 | £10 |
| 3 Links × 1 | | 40 | £10 |
| 2 Links × 2 | | 29 | £3 |
| 2 Links × 9 | | 20 | £5 |
| 2 Links × 3 | | 12 | £2 |
| 2 Links × 8 | | 11 | £3 |
| 2 Links × 4 | | 7 | £1 |
| 2 Links × 7 | | 7 | £2 |
| 2 Links × 6 | | 5.5 | £1 |

¹²The recorded odds from our simulation of 139.828 Billion card run in the SUPERLink Game for a 2 × 5 Link is 9,987,714,285. Take this figure and divide by the recorded odds in the standard game. This = 22.07. Add in the one occurrence in the SUPERLink, then this = 23.07. Then divide 9,987,714,285 by 23.07 = 432,930,831.
Overall Odds of winning a prize in Link2Win ™ are 1 in 1.27

### Example 3.0—Link2Win™ for State Lotteries—Pooled Games

### Example 3.1—Background

For some State Lotteries around the world, online gambling is either not adopted, or it is illegal and therefore not offered. In particular, it is illegal for many of the US State Lotteries. Alternatively, if offered, it is likely to be in its infancy, with small online sales. Further, almost all State Lotteries around the world have a significant investment in their existing sales infrastructure, which includes their important relationships with their POS retail outlets. Further still, many of these POS retail outlets have built and supported their State Lottery over many years, and they provide an important personalized service with front line assistance for the customers of the lottery.

In some cases, POS lottery retailers have become very reliant on their State Lottery Operator for their viability. For example in the US, some retailers have lottery sales that comprise 25% or more of their total turnover.

There has developed over the years an important partnership/relationship between State Lotteries and their POS retail outlets. While online gaming is an increasing way for players to play, and this will continue, it poses both an opportunity and a threat or problem for many State Lotteries.
The opportunity is to bring new and exciting games to their customers, which many customers want.
The threat or problem is that the significant investment by State Lotteries in their existing POS retailer network may be adversely affected by moving to online gaming. For example, a move to online gaming may adversely affect the level of lottery sales made by the relevant State Lottery's POS retail outlets, and therefore adversely affect their earnings.

Link2Win™ is an invention of a new gaming system. This invention is suited to an online gaming environment, or at least an environment that provides for computer graphics—as the results are best animated, displayed or played out on a mobile, tablet or personal computer device. So in respect of an online gaming operator offering Link2Win™, a player enters the game and purchases an entry from the online gaming operator by undertaking an online payment transaction, the player later obtains access to the draw and results online, and collects his winnings, again via an online payment transaction.

As mentioned above, for some State Lotteries around the world, online gambling is still in its infancy, or it is illegal. And most or all State Lotteries will harbour concerns relating to the potential adverse impact that moving to online gaming may have on their POS lottery retailers.

These disadvantages can be overcome when a State Lottery Operator uses certain aspects of this invention described herein.

### Example 3.2—No Online Transaction

In a further aspect of this invention, Link2Win™ can be offered for play by most or all of the world's State Lottery Operators using their existing POS retail infrastructure without players undertaking any online payment transaction to enter the Link2Win™ game.

Entries into a Link2Win™ game could be transacted by players purchasing tickets from the relevant State Lottery Operator's POS retailers in the same way as they would purchase a typical LOTTO ticket. In respect of a pooled game (described below), after tickets sales close, the State Lottery Operator would then undertake the random draw. Winning Link2Win™ players would go back to a POS retailer with their original entry ticket to confirm and collect their winnings using the original Link2Win™ ticket that was purchased as the ‘proof of entry’, in the same way as they would go to the POS retailer to confirm and collect winnings in a typical LOTTO game. We set this out more fully below.

### Example 3.3—For State Lotteries—Pooled Game

We now describe a method involving a pooled Link2Win™ game. This involves a number of players that each undertake a conventional transaction with a State Lottery organisation through its existing POS lottery retailers, but without losing the excitement and anticipation that the players can experience of the Link2Win™ game when the results are to be animated, displayed or played out on a mobile, tablet or personal computer device.

### Example 3.4—Key Elements for the Pooled Game

In this example, the key elements are:
1. The players and the State Lottery Operator must not make any transaction online (i.e. purchase remotely over the internet).
2. The players can only enter into a pooled Link2Win™ game by purchasing an entry ticket from a POS lottery retailer. Note: when referring to an entry ticket, this includes any entry card that is issued.
3. The only valid ‘evidence’ of entry is the original ticket that is issued by the POS lottery retailer to the player at the time of purchase.
4. Winning tickets are presented by players to a POS lottery retailer, who process the tickets in the same way as they would process a traditional winning LOTTO ticket—e.g. confirm the ticket as valid and as a winning ticket; pay-out small prizes directly, refer big prize winners to the relevant State Lottery for processing by them.
5. Any ticket can be presented to any relevant POS lottery retailer in order to confirm whether it is a winning or losing ticket.

### Example 3.5—Further Explanation of the Methods

By way of further explanation of the method described in this example:
A player buys/obtains a Link2Win™ ticket/card at a POS lottery retail outlet, in exactly the same way as if the player was purchasing/obtaining an entry into a typical LOTTO draw from the POS lottery retailer.
The ticket purchased/obtained contains a visual representation of a 5×5 matrix, with the ticket showing the placement of the 25 numbers in or on the 25 cells.
The ticket purchased/obtained has printed on it a machine readable code such as a Quick Response (QR) Code.
The machine readable code contains: (a) the 25 ticket or card numbers (there are 25 of them on the 5×5 matrix). These numbers are ordered in a 25 number sequence based on the position of each number on the 5×5 matrix; (b) a unique game ID; and (c) the date and time of the draw in a common time reference to allow for a draw to take place simultaneously in several different time zones.
The ticket purchased/obtained may also have a separate bar code on it that is used by the retailer, scanning it to: (a) at the time of sale, verify to the State Lottery Operator that the ticket has been sold and the entry fee received, and/or (b) after the draw, whether or not it is a winning ticket, including the amount of any winnings.

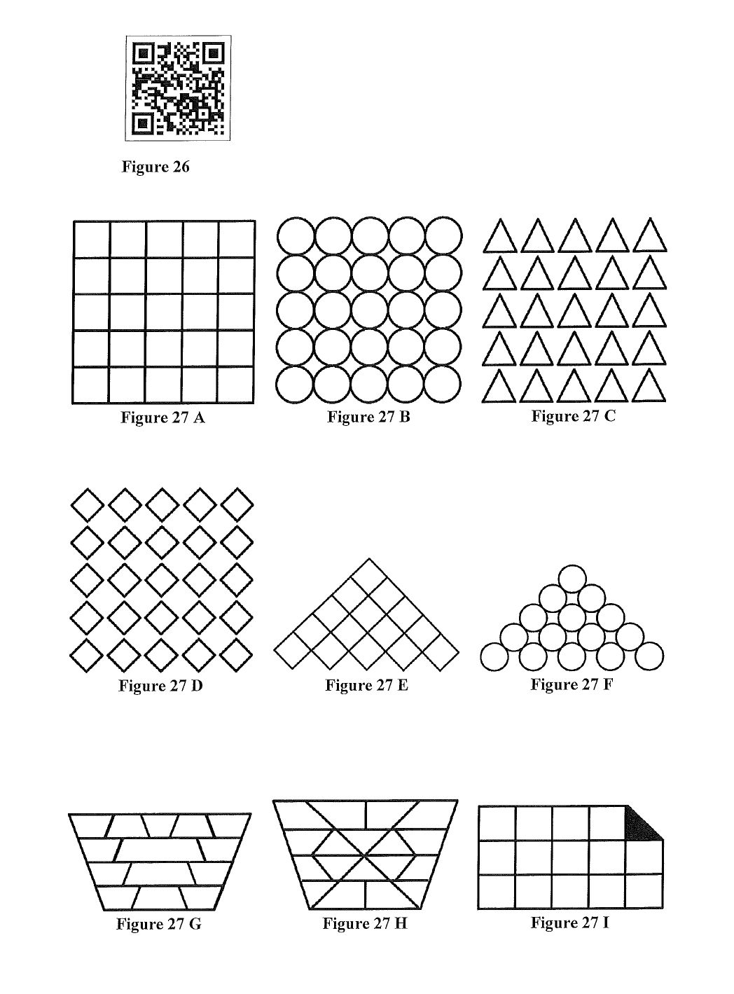

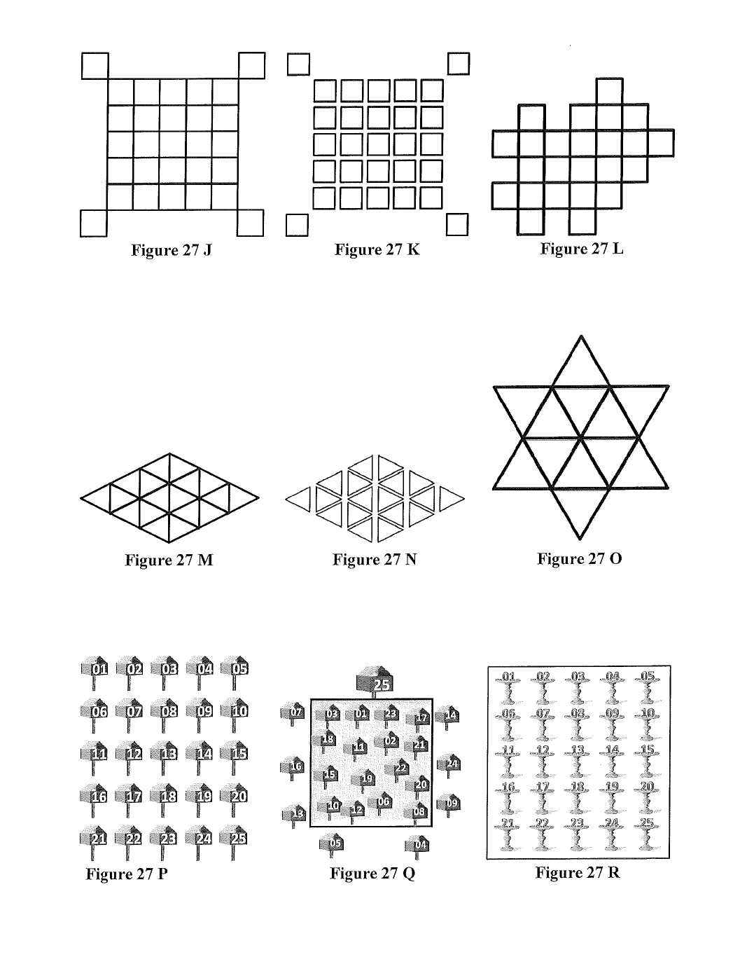

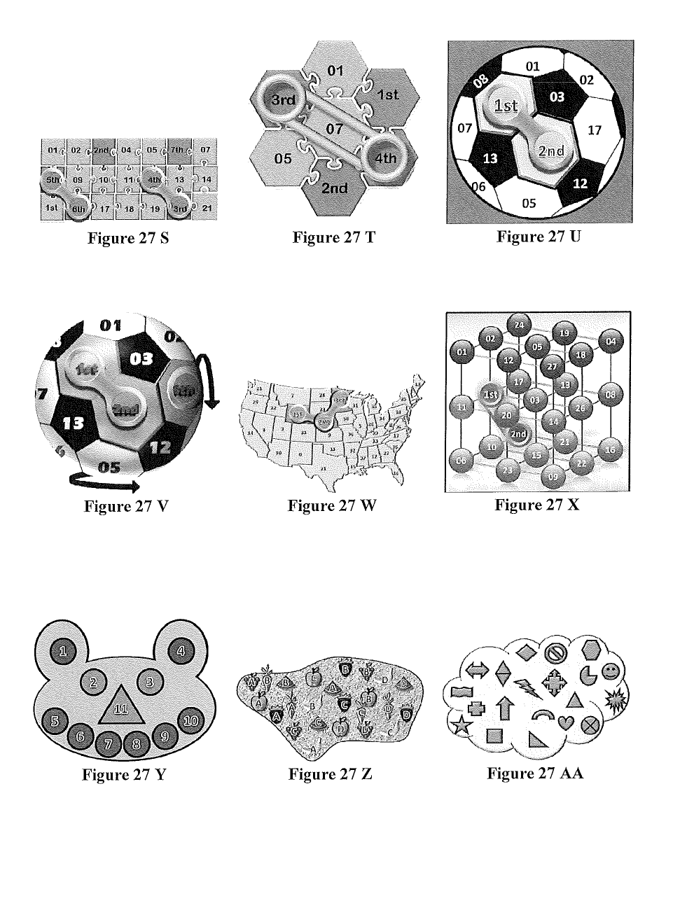

An example of a machine readable code such as a QR code is shown in FIG. 26.

The machine readable code contains: (a) the 25 ticket or card numbers (there are 25 of them on the 5×5 matrix). These numbers are ordered in a 25 number sequence based on the position of each number on the 5×5 matrix; (b) a unique game ID; and (c) the date and time of the draw in a common time reference to allow for a draw to take place simultaneously in several different time zones.

QR Data (split with ‘,’ to show fields)

Numbers all stored as double digits thus first 50 characters, ID=7 characters, Date=remaining 20 characters

Numbers:

06,10,15,04,11,19,14,03,25,01,17,12,09,22,08,18,02,23,16,13,07,21,24,05,20

Unique game ID:

001234567

Date/Time/Zone:

2015,03,05, 20,00,00,GMT+04
In this Example 3, a free Link2Win™ mobile app is provided for all platforms—mobile, tablet or personal computer devices. For those players who wish to play Link2Win™ and who wish to experience and see the animated draw, they would download the free app onto their relevant device as a one-time download event.
Players then use the Link2Win™ app to scan the machine readable code such as a QR Code that is contained on their ticket. This loads the Link2Win™ ticket onto their mobile, tablet or personal computer device, along with the draw identifier (i.e. which draw), and the draw timing.
Similar to LOTTO, entries close at a set time prior to the State Lottery Operator undertaking the draw.
The State Lottery Operator undertakes the draw for the relevant Link2Win™ game in the same way as the operator would do a typical LOTTO draw. The State Lottery Operator would undertake the random draw of all 25 numbers involved in this example of the Link2Win™ game.
During or after the Link2Win™ draw, the draw can be announced in the same way as a typical LOTTO draw. It can be live or delayed. It can be via broadcast media, showing and/or broadcasting the random draw of the 25 numbers. However, it is also important to be able to animate the Link2Win™ draw on a player's mobile, tablet or personal computer device so that the excitement and anticipation of the Link2Win™ game can be experienced by each player—should they wish to view the draw this way instead of watching it as a draw of 25 numbers on a broadcast medium, such as through a TV broadcast.
Animating the Link2Win™ draw on a player's mobile, tablet or personal computer device in this example is achieved by the downloaded app automatically downloading to the player's device, the results of the 25 number draw from the State Lottery Operator. This may be done in real time as the draw is happening, or it may be done shortly after the draw has been concluded. The app would be programmed to notify the player of this event.
The App would then, on command by the player, animate the draw on the player's personal computer device, and it would score their Link2Win™ ticket and identify prizes. Note: This play-out on the player's personal computer device is not a confirmation of any winnings or entry. It is the original ticket that was purchased that is the ONLY valid confirmation.
The player takes his or her original ticket to a relevant POS lottery retailer to confirm whether or not it is a winning ticket, and as relevant, to be paid/recognized his or her winnings

### Example 3.6—Comparison of a Typical Transaction: LOTTO Vs Link2Win™

Table 19 below sets out a comparison of the ‘operational mechanics’ between:
a State Lottery Operator selling/offering a typical LOTTO entry through a POS Lottery retailer and then undertaking the draw and paying winners; and
that same operator selling a typical Link2Win™ entry through the same POS Lottery retailer and then undertaking the draw and paying winners.

TABLE 19
Comparison Table of ‘Operational Mechanics’

| Event | Typical LOTTO Entry | Link2Win ™ Entry |
|---|---|---|
| Purchase of | At POS retailer | At POS retailer |
| Tickets | | |
| Valid Tickets | Original Ticket | Original Ticket |
| Closure of | Say 1 hour before draw | Say 1 hour before draw |
| Entries | | |
| Draw | By State Lottery | By State Lottery |
| | Operator | Operator |
| | Live, by TV | Live, by TV |
| | Live, by Internet | Live, by Internet and/or |
| | | By live or delayed |
| | | streaming to personal |
| | | computer devices |
| Publishing | Various Media Channels | Various Media Channels |
| Results | Newspapers | Newspapers |
| | Radio | Radio |
| | Website/Internet | Website |
| | | By streaming to personal |
| | | computer devices |
| Paying/ | By POS retailer | By POS retailer |
| recognizing | Big winnings | Big winnings |
| Valid Winnings | paid/recognized by | paid/recognized by |
| | State Lottery | State Lottery |
| | Operator | Operator |

### Example 3.7—Many Variations

As will be obvious to a person skilled in the art, there will be many ways to achieve the intended outcomes as we have described above.

### Example 3.8—Variations to Receive the Draw Information

Further there are also alternate ways to retrieve the results of the 25 number draw in order that a personal computer device can play out in animated form the results of a Link2Win™ game. For example, the results of the 25 number draw can be obtained:
From a State Lottery Operator's website, which displays a machine readable code such as a QR Code containing the draw information;
From a TV screen or similar display monitor, which displays a machine readable code such as a QR Code containing the draw information;
Manually, by typing into the player's personal computer device that has the free Link2Win™ app downloaded, the order of the 25 number draw obtained via a media release, although this is least preferred as among other things, it is cumbersome and very error prone.

### Example 3.9—Advantages

This Example 3 provides a number of advantages, including:

### For the Player:

It provides the excitement of an on-line gaming experience with all its visual effects.
It avoids potential exposure to online risks. For example it avoids potential risks associated with giving third parties over the internet access to banking information, such as credit card details.
It gives the player direct access to personal assistance and explanations, available via the POS lottery retailer outlet.

### For State Lottery Operators:

It uses and relies upon each operator's existing POS retailer network and logistics capabilities.
It maintains and enhances the important relationships that State Lottery Operators have with their POS retail outlets.
The transactions by which a player purchases a Link2Win™ entry ticket and cashes any winnings are the same as the current methods used by State Lottery Operators in respect of their existing transactions involving their typical LOTTO sales.
It should retain some players that might otherwise have migrated to other gaming operators in search of more visually exciting games to play.
Importantly, it ensures a greater control over preventing underage gambling, as the POS lottery retailers can use existing identification and verification methods to better guard against tickets being sold/offered to underage players when compared to normal online gaming

### Example 3.10—Link2Win™ Free App No Bearing on Game Results

It will be appreciated by a person skilled in the art that the animations and information enabled by the free download app are not essential to the relevant Link2Win™ game play and have no affect on the game's results. Its only purpose is to provide a useful means to display the results of a draw in an exciting and convenient way.

### Example 3.11—Variation Using ‘Other’ Lottery Games

It will further be appreciated by a person skilled in the relevant art that the use of certain aspects of this invention can be used by State Lottery Operators to provide a useful means to animate other lottery games in the same or similar way as described in this example, in which the results are to be animated, displayed or played out on a mobile, tablet or personal computer device, but where the other lottery games are offered for play by State Lottery Operators using their existing POS retail infrastructure and without players undertaking any online payment transaction to enter the other lottery games, or in the collection of their winnings.

Examples of other lottery games that would or could be suitable include:
Virtual racing games e.g. virtual horse racing; virtual dog racing; virtual car racing.
Virtual competition or team games e.g. virtual soccer; virtual tennis; virtual NFL.
Casino type games.
Slot machine type games.
LOTTO and Keno games.
Scratch Card Games.

### Example 4.0—Link2Win™ for State Lotteries—Single Play Games

### Example 4.1—Background

The above Example 3 focuses on a Link2Win™ game that is sold over a set period of time by a State Lottery Operator to numerous players in what we refer to as a pooled game.

This following Example 4 sets out the above previously described Example 3, but adapted for an instant game application, played by one player in a single play of the Link2Win™ game. We refer to this as the Single Play Game.

### Example 4.2—Key Elements of the Single Play Game

In this Example 4, the key elements are:
1. The single player and the State Lottery Operator must not make any transaction online (i.e. purchase remotely over the internet).
2. The single player can only enter into the Link2Win™ game by purchasing/obtaining a ticket from a POS lottery retailer.
3. The only valid ‘evidence’ of entry is the original ticket that is issued or given by the POS lottery retailer to the player at the time of purchase/obtaining of the ticket.
4. A winning ticket is presented by the player to the relevant POS lottery retailer, who then processes the ticket—e.g. confirm the ticket is valid and is a winning ticket; pay-out small prizes or give small recognitions directly, refer big prize/recognition winners to the relevant State Lottery for processing by them.

### Example 4.3—Further Explanation of the Methods

By way of further explanation:
A player buys/obtains a Link2Win™ single play ticket at a POS lottery retailer outlet, in exactly the same or similar way as if the player was purchasing/obtaining a typical LOTTO ticket from the POS lottery retailer.
The POS lottery retailer issues the ticket following an online request to the State Lottery

Operator, or following the relevant request to the computer equipment installed at the retailer's premises.
The issued ticket contains visible on its face a visual representation of a 5×5 matrix, with the ticket showing the placement of 25 numbers in the 25 cells. These placements of the 25 numbers may be all randomly placed on the 5×5 matrix by the gaming operator, or the player may select one or more numbers for placement in selected cells, with all other numbers randomly placed.
The issued ticket also contains visible on its face:
   1. A random draw of 25 numbers, this being a unique and individual random draw for the Link2Win™ Single Play ticket. This random draw is printed on the ticket at the time of purchase/obtaining, in a manner where the player only becomes aware of the order of the random draw after purchase/obtaining of the ticket.
   2. A machine readable code such as a Quick Response (QR) Code.
The Random Draw: This allows a player to review the order of the random draw and/or to review the order of draw and based on that order, to manually search for links on the Link2Win™ Single Play ticket—if the player wishes to undertake this manual method to locate links and to identify winnings.
The machine readable code such as a QR Code: This machine readable code contains:
   the positional placement on the 5×5 matrix of the 25 numbers on the issued ticket, being those 25 numbers that are displayed on the 5×5 matrix, all of which is displayed on the face of the issued ticket.
   The ticket's unique ID.
   The unique random draw of 25 numbers, and it is the order of this unique draw that will provide the outcome of the Link2Win™ single play game.
The issued ticket may also have a separate bar code that is used by the POS retailer, scanning it when it is presented by a player who wants to check it, or who claims it to be a winning ticket. The scan will confirm whether or not it is a winning ticket, including the amount of any winnings, and scanning it will provide the required advice to, and/or to receive the required confirmations from, the State Lottery Operator.

An example of a machine readable code in a form of a QR code is shown in FIG. 16.
In this Example 4, a free Link2Win™ mobile app is provided for all platforms—mobile, tablet or personal computer devices. For those players who wish to play the Link2Win™ Single Play Games and who also wish to experience and see the animated draw, they would download the free app onto their relevant device as a one-time download event.
Players would then use the Link2Win™ app to scan the machine readable code. This loads the Link2Win™ Single Play ticket onto their mobile, tablet or personal computer device.
It also loads at the same time the random draw of all 25 numbers that is to be used to play-out the results of the game.
The App would then animate the draw on the player's personal computer device, and it would identify links on the Link2Win™ 5×5 matrix card and identify prizes. Note: This play-out on the player's personal computer device is not a confirmation of winnings or entry. It is the ticket that was originally purchased that is the ONLY valid confirmation.
The player takes his or her original ticket to the relevant POS lottery retailer to confirm whether or not it is a winning ticket, and as relevant, to be paid/recognized his or her winnings

### Example 4.4—Many Variations

As will be obvious to a person skilled in the art, there will be many ways to achieve the intended outcomes as we have described above. This will include variations in respect of how to present the random draw on the ticket, which may be done by printing the draw on the underside of the ticket.

### Example 4.5—Advantages

This Example 4 provides a number of advantages, including:

### For the Player:

It provides the excitement of an on-line gaming experience with all its visual effects.
It provides the player with an instant game, by way of a single player game, and instant results.
It avoids potential exposure to online risks. For example it avoids potential risks associated with giving third parties over the internet access to banking information, such as credit card details.
It gives the player direct access to personal assistance and explanations, available via the POS lottery retailer outlet.

### For State Lottery Operators:

It uses and relies upon each operator's existing POS retailer network and logistics capabilities.
It maintains and enhances the important relationships that State Lottery Operators have with their POS retail outlets.
The transactions by which a player purchases a Link2Win™ Single Play entry and cashes any winnings are in all material respects the same as the current methods used by State Lottery Operators in respect of their existing LOTTO type transactions.
It should retain some players that might otherwise have migrated to other gaming operators in search of more visually exciting games to play, or in search of instant games.
Importantly, it ensures a greater control over preventing underage gambling, as the POS lottery retailers can use existing identification and verification methods to better guard against tickets being sold/offered to underage players when compared to normal online gaming

### Example 4.7—Link2Win™ Free App No bearing on Game Results

It will be appreciated by a person skilled in the art that the animations and information enabled by the free download app are not essential to the relevant Link2Win™ game play and have no affect on the game's results. Its only purpose is to provide a useful means to display the results of a draw in an exciting and convenient way.

### Example 4.8—Variation Using ‘Other’ Lottery Games

It will further be appreciated by a person skilled in the relevant art that the use of certain aspects of this invention can be used by State Lottery Operators to provide a useful means to animate other lottery games in the same or similar way as described in this example, in which the results are to be animated, displayed or played out on a mobile, tablet or personal computer device, but where the other lottery games are offered for play by State Lottery Operators using their existing POS retail infrastructure and without players undertaking any online payment transaction to enter the other lottery games, or in the collection of their winnings.

Examples of other lottery games that would or could be suitable, include:
Virtual racing games e.g. virtual horse racing; virtual dog racing; virtual car racing.
Virtual competition or team games e.g. virtual soccer; virtual tennis; virtual NFL.
Casino type games.
Slot machine type games.
LOTTO and Keno games.
Scratch Card Games.

### Example 5.0—Link2Win™ for State Lotteries—Instant Link2Win™ Scratch Card Game

### Example 5.1—Background

Example 3 focuses on a Link2Win™ game that is sold over a set period of time by a State Lottery Operator via its POS retail network to numerous players in what we refer to as a pooled game. Example 4 describes a single play of the game.

This Example 5 sets out another example of an instant Link2Win™ game sold/offered by a State Lottery Operator via its POS retail network to players, but this time using scratch cards.

We refer to this as the Link2Win™ Scratch Card Game.

### Example 5.2—Key Elements of the Link2Win™ Scratch Card Game

In this Example 5, the key elements are:
5. The single player and the State Lottery Operator must not make any transaction online (i.e. purchase remotely over the internet).
6. The single player can only enter into the Link2Win™ game by purchasing/obtaining a Scratch Card from a POS lottery retailer.
7. The only valid ‘evidence’ of entry is the original Scratch Card that is issued or given by the POS lottery retailer to the player at the time of purchase.
8. Winning Scratch Cards are presented by players to a POS lottery retailer, who process the Scratch Cards in the same way as they process a traditional scratch card—e.g. confirm the Scratch Card is valid and is a winning card; pay-out small prizes or give small recognitions directly, refer big prize/recognition winners to the relevant State Lottery for processing by them.
9. Any Scratch Card can be presented to any relevant POS lottery retailer in order to confirm whether it is a winning or loosing Scratch Card.

### Example 5.3—Further Explanation of the Methods

By way of further explanation:
A player buys/obtains a Link2Win™ Scratch Card at a POS lottery retailer outlet, in exactly the same way or similar way as if the player was purchasing/obtaining a typical scratch card from the POS lottery retailer.
The Scratch Card contains on its face a visual representation of a 5×5 matrix, with the Scratch Card showing the random placement of 25 numbers in the 25 cells.
The Link2Win™ Scratch Card has two hidden features printed on it, which are revealed by a player scratching those features clear. These hidden features are:
   3. A random draw of 25 numbers, this being a unique and individual random draw for the Link2Win™ Scratch Card.
   4. A machine readable code such as a Quick Response (QR) Code.
The Random Draw: The random draw of 25 numbers is hidden and can be revealed by scratching it clean. This allows a player to review the order of the random draw and/or to follow the order of draw and based on that order, to manually search for links on the Link2Win™ Scratch Card—if the player wishes to undertake this manual method to locate links and to identify winnings.
The machine readable code such as a QR Code: This machine readable code is also hidden and can only be revealed by the player scratching it clean. This QR Code contains:
   the positional placement on the 5×5 matrix of the 25 numbers on the Link2Win™ Scratch Card, being those 25 numbers that are displayed on the 5×5 matrix, all of which is displayed on the face of the Scratch Card.
   The Scratch Card's unique ID.
   The Scratch Card's unique random draw of 25 numbers, and it is the order of this unique draw that will provide the outcome of the Link2Win™ Scratch Card game.
The Link2Win™ Scratch Card may also have a separate bar code that is used by the POS retailer, scanning it to: (a) at the time of sale/offer, verify to the State Lottery Operator that the Scratch Card has been sold/offered and the entry fee received and/or (b) when presented by the player following its scratching, whether or not it is a winning Scratch Card, including the amount of any winnings
An example of the machine readable code in the form of a QR code is shown in FIG. 16.
In this Example 5, a free Link2Win™ mobile app is provided for all platforms—mobile, tablet or personal computer devices. For those players who wish to play the Instant Link2Win™ Scratch Card Games and who also wish to experience and see the animated draw, they would download the free app onto their relevant device as a one-time download event.
Once the machine readable code such as a QR Code that is contained on the Scratch Card has been scratched and is revealed, players would then use the Link2Win™ app to scan the machine readable code. This loads the Link2Win™ Scratch Card onto their mobile, tablet or personal computer device.
It also loads at the same time the random draw of all 25 numbers that is to be used to play-out the results of the game.
The App would then animate the draw on the player's personal computer device, and it would identify links on the Link2Win™ Scratch Card and identify prizes. Note: This play-out on the player's personal computer device is not a confirmation of winnings or entry. It is the Scratch Card that was originally purchased that is the ONLY valid confirmation.
The player takes his or her original Scratch Card to a relevant POS lottery retailer to confirm whether or not it is a winning Scratch Card, and as relevant, to be paid/recognized his or her winnings

### Example 5.4—Comparison of a Typical Transaction: State Lottery Scratch Card Vs Link2Win™ Scratch Card

Table 20 below sets out a comparison between:
a State Lottery Operator selling/offering a typical State Lottery Scratch Card through a POS Lottery retailer and then paying winners; and
that same operator selling a typical Link2Win™ Scratch Card through the same POS Lottery retailer and then paying winners.

TABLE 20
Comparison Table of ‘Operational Mechanics’

| | Typical State Lottery | Link2Win ™ |
|---|---|---|
| Event | Scratch Card | Scratch Card |
| Purchase of | At POS retailer | At POS retailer |
| Scratch Card | | |
| Valid Scratch | Original scratch card | Original scratch card |
| Cards | | |
| Closure of | n/a - Instant Game | n/a - Instant Game |
| Entries | | |
| Draw or | Contained on the card. | Contained on the card. |
| Outcome | Revealed by Scratching | Revealed by Scratching |
| Identifying | Achieved by: | Achieved by: |
| Winnings | Player initially | Player can initially |
| | identifies manually | identify manually, or |
| | POS retailer scanning | Player can use free |
| | scratch card to confirm | Link2Win ™ app to allow |
| | winnings, or | personal computer to |
| | POS retailer visually | assist player by locating |
| | confirming winnings on | links and identifying |
| | scratch card | winnings |
| | | POS retailer scanning |
| | | scratch card to confirm |
| | | winnings |
| Paying | By POS retailer | By POS retailer |
| Valid Winning | Big winnings paid by | Big winnings paid by |
| Scratch Cards | State Lottery Operator | State Lottery Operator |

### Example 5.5—Many Variations

As will be obvious to a person skilled in the art, there will be many ways to achieve the intended outcomes as we have described above.

### Example 5.6—Advantages

This Example 5 provides a number of advantages, including:

### For the Player:

It provides the excitement of an on-line gaming experience with all its visual effects.
It provides the player with an instant game.
It avoids potential exposure to online risks. For example it avoids potential risks associated with giving third parties over the internet access to banking information, such as credit card details.
It gives the player direct access to personal assistance and explanations, available via the POS lottery retailer outlet.

### For State Lottery Operators:

It uses and relies upon each operator's existing POS retailer network and logistics capabilities.
It maintains and enhances the important relationships that State Lottery Operators have with their POS retail outlets.
The transactions by which a player purchases/obtains a Link2Win™ entry Scratch Card and cashes any winnings are the same or similar as the current methods used by State Lottery Operators in respect of their existing transactions involving their typical scratch card sales.
It should retain some players that might otherwise have migrated to other gaming operators in search of more visually exciting games to play.
Importantly, it ensures a greater control over preventing underage gambling, as the POS lottery retailers can use existing identification and verification methods to better guard against Scratch Cards being sold/offered to underage players when compared to normal online gaming

### Example 5.7—Link2Win™ Free App No Bearing on Game Results

It will be appreciated by a person skilled in the art that the animations and information enabled by the free download app are not essential to the relevant Link2Win™ game play and have no affect on the game's results. Its only purpose is to provide a useful means to display the results of a draw in an exciting and convenient way.

### Example 5.8—Variation Using ‘Other’ Lottery Games

It will further be appreciated by a person skilled in the relevant art that the use of certain aspects of this invention can be used by State Lottery Operators to provide a useful means to animate other lottery games in the same or similar way as described in this example, in which the results are to be animated, displayed or played out on a mobile, tablet or personal computer device, but where the other lottery games are offered for play by State Lottery Operators using their existing POS retail infrastructure and without players undertaking any online payment transaction to enter the other lottery games, or in the collection of their winnings.

Examples of other lottery games that would or could be suitable, include:
Virtual racing games e.g. virtual horse racing; virtual dog racing; virtual car racing.
Virtual competition or team games e.g. virtual soccer; virtual tennis; virtual NFL.
Casino type games.
Slot machine type games.
LOTTO and Keno games.
Scratch Card Games.

### Example 6.0—Multiple Concurrent Games

### Example 6.1—3 Card Game

In this example we use three (3) matrix cards, and in this example the 3 matrix cards are each of a 5×5 matrix.
Card 1 to contain numbers 1-25
Card 2 to contain numbers 26-50
Card 3 to contain numbers 51-75

This example of the game can comprise of a single play of the game, or a multi play pooled game.

### Example 6.2—One Draw

Each play of the game involves the 3 cards described above. One random draw of 75 numbers is used to determine the outcome of the game, with each number drawn going to the relevant card that has the drawn number. Any number drawn that is in the 1-25 range goes to Card 1, any number drawn that is in the range of 26-50 goes to Card 2, and any number drawn that is in the range of 51-75 goes to Card 3.

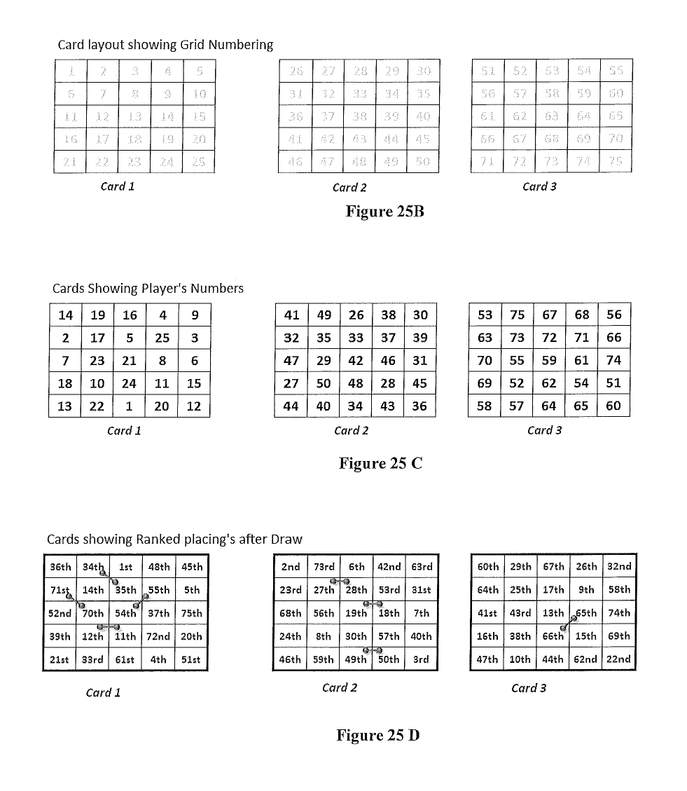

FIG. 25A shows the draw of the 75 numbers for a play of the game.

FIG. 25B shows the coordinates in each of the three (3) 5×5 matrix cards. Note: Card 1 is the same as that shown in FIG. 23.

FIG. 25C shows the actual drawn numbers allocated to each card: Card 1 contains numbers 1-25; Card 2 contains numbers 26-50; Card 3 contains numbers 51-75.

FIG. 25 D shows the ordinal ranking of each of the drawn numbers on each of the cards, and the results of the game: Card 1 has 4×2 Links; Card 2 has 3×2 Links; Card 3 has 1×2 Links.

### Example 6.3—The Odds

The odds for each of the 3 Link2Win™ Cards can be the same as a single play of a single 5×5 Card as set out in: Example 1, Tables 10-11; and Example 2, Tables 16-17, if the drawn numbers for each card are given an ordinal ranking of 1^{st} to 25^{th} as relevant to the card and the linking processes are based on those assigned ordinal rankings. In effect, it would be the same as a player purchasing 3 individual cards in the games exampled in Examples 1 and 2.

When played as a group of 3 cards that are governed by a random draw of 75 numbers with the drawn numbers each given an ordinal ranking of 1^{st} to 75^{th} and placed accordingly on the relevant card, with the linking processes based on those assigned ordinal rankings, then the odds will alter. The size of the alteration will depend on the rules set.

### Example 7.0—Token Design Concepts

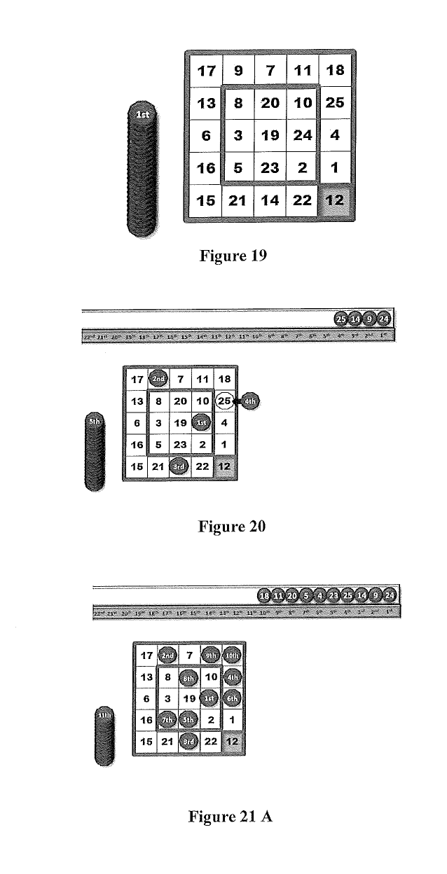

FIGS. 19-22 show a preferred form of design of the 25 virtual tokens for use in the Link2Win™ game of the present invention.

In a preferred form, the virtual Tokens 1 to 25 could be used that are dual colour, double sided and of same label. In this example the Tokens 1 to 25 are labelled on both sides with the same placing text. For example Token 1, would be labelled “1^{st}” on both sides—One side Red and the other Black.

Ideally the virtual Tokens would be shown on the screen of the computing device of the player(s) stacked in placing order prior to game start-see FIG. 19.

As the numbers are drawn and announced or presented the player(s) would place the corresponding Token (using drag and drop or similar feature) that represents the placing of the drawn ball the player would locate that number on the virtual imagery of the matrix card and cover it. For example the first drawn number would be covered with the “1st” Token. The second called number would be covered with the “2nd” Token and so on until all Tokens were used—see FIG. 20.

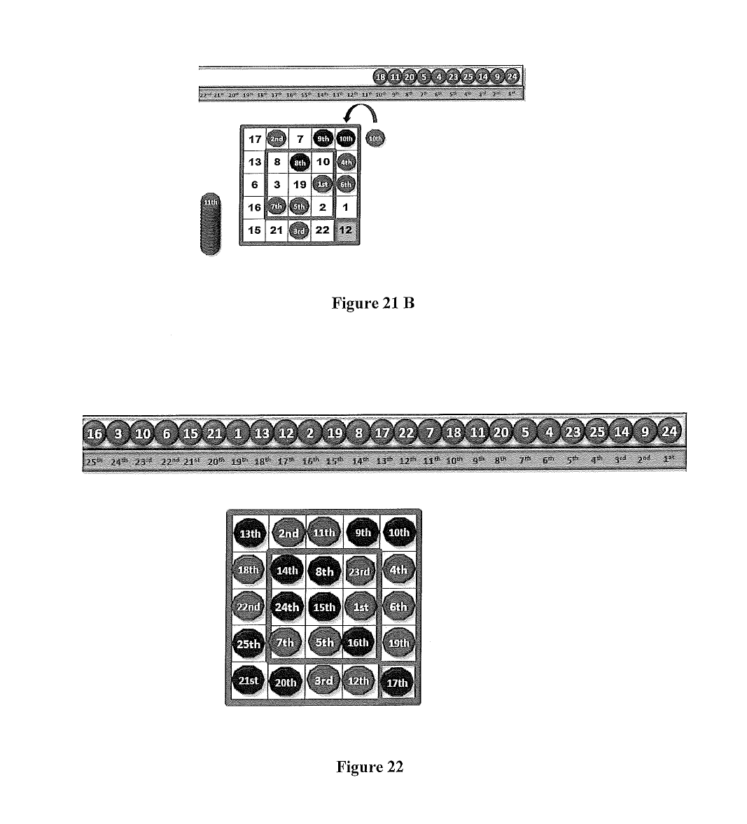

The Tokens would initially be placed with the same coloured sided showing (e.g. all Red). As prize lines such as 2 in a Row, 3 in a Row are realised by the player they could simply flip the relevant Tokens over at any time (for example by clicking on it or by tapping on it if the user's interface is a touch screen) to the alternate coloured side—see FIGS. 21(a) and 21(b). The same Placing text would be prevalent but the links would now stand out due to the different colours.

When the draw is complete all links are easily identified. In the case of 2 links meeting (such as a 3 line and a 2 line being connected (appearing as 4 in a row) the player will need to apply the rules for determining prizes. In the example just described there may be no 4 in a row link or a prize.

It is expected that when prizes are claimed the rules would automatically declare the prizes that comply with the rules.

### Example 8.0—Player Interaction—Rejecting Drawn Numbers

### Example 8.1—Background

The Link2Win™ games as described in Examples 1-7 are all random games of chance that play out till the end.

But some or all of these games could have a player interaction that would introduce an element of excitement and participation into the game. It would also reduce the odds of some of the outcomes.

### Example 8.2—Rejecting a Drawn Number/s—Joker/s

An example of such a game is one where the player may reject one or more drawn numbers, with any rejected drawn number converting into a “Joker” symbol—the Joker symbol can then be used as any number required to complete a 3 Link or 5 Link sequence.

### Example 8.3—An Overview

The allowance for the player to reject a drawn number, and for that rejected number to convert into a Joker symbol, provides the player with participation, and strategy decisions that enhance the player's experience of the game.

In this Example 8:
There are a maximum of 3 rejections from a 25 number draw (relating to a 25 cell matrix).
Each rejection turns into a “Joker” symbol that is placed on the matrix cell to which it belongs.
If for example the 3^{rd} drawn number from the random draw is to be rejected by a player—and becomes a Joker symbol, then in this example the next drawn number is to be classed as the 3^{rd} drawn number.
Joker symbols can only be used to complete a 3 Link or a 5 Link (but not a 2 Link).
Only one (1) Joker symbol can be used to complete a 3 Link.
Up to two (2) Joker symbols can be used to complete a 5 Link.
No SuperLink: If a number is drawn for the SuperLink cell (see FIG. 23, coordinate 25) and it is rejected and converts to a Joker symbol, then the card cannot qualify for any SuperLink prizes as a player will always be able to convert a drawn number for this cell into a Joker.

### Example 8.4—Explaining by Way of an Example

An example of this can be explained with reference to FIG. 23.

The table in FIG. 23 shows the coordinates, which we have assigned to each cell on the 5×5 Matrix.

Assume (for ease of understanding) that:
coordinate 1 has the 1^{st} drawn number
coordinate 2 has the 2^{nd} drawn number
that the 3^{rd} drawn number is drawn for coordinate 4, which in this example, breaks the linking sequence for a possible 5 Link. This number is rejected by the player and becomes a Joker on the coordinate 4 cell.
A new 3^{rd} drawn number is drawn and it is drawn to be placed on the coordinate 3 cell. By this time the player's card has the opportunity to complete a 5 Link on the top 5 coordinates of the Link2Win™ card.

The above example as described in Example 8.4 can be varied to achieve similar or varying outcomes. For example:
More or less Jokers may be allowed into play;
Rejected numbers may be recycled into the draw, or into the end of the draw in order of rejection;
Rejected numbers can be limited, but they may be limited to more or less than 3 rejections per play.
Optionally, players could be given the option to preselect a set number of Joker positions, although this is not believed to be as desirable.
The next drawn number after a Joker may remain as its correct order of draw (e.g. if the 3^{rd} drawn number is converted to a Joker, then the next drawn number is still recorded as the 4^{th} drawn number). Jokers are used to complete Link sequences in accordance with the relevant game rules.

### Example 9.0—Player Interaction—Relocating or Shuffling Numbers

### Example 9.1—Allowing Players to Relocate or Shuffle Numbers on the Card

This is another example of allowing player interaction.

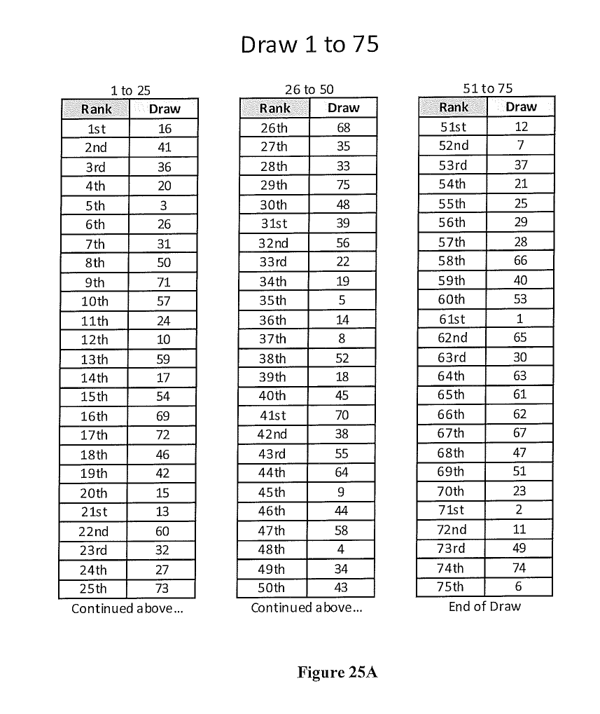

FIG. 24 shows a partial view of a 5×5 Link2Win™ Card. In this example of the game, a player is allowed to relocate or shuffle one or more numbers on a Link2Win™ Card in the hope of gaining an advantage.
All numbers remain in play as per the draw.
Players can only move or shuffle numbers on the Link2Win™ Card that have not been drawn in the associated random draw.
Players could be limited to moving or shuffling numbers as between adjacent cells or rows.

As this example involves moving or shuffling undrawn numbers, there is no change in the games odds, or prizes. The benefit is that it gives a choice of placement to those players that wish to have the opportunity to do so.

### Example 10.0—Player Interaction—Competition Involving a Pool of Players

In this example of the game, a competition amongst a pool of players is held. Similar to a poker competition, the objective of the game is to become the sole winner, achieved either by way of a single play of the game by the pool of players, with one winner emerging, or by the survival of a series of plays involving eliminations, where one winner emerges at the end.

The key elements of this exampled competition game are:
A pool of players are each given the same 5×5 Link2Win™ Card.
One random draw of 25 numbers is undertaken.
Each player can make individual choices to reject drawn numbers as they occur, and turn those drawn numbers into Jokers in the same way as set out in Example 8.
Each player will be able to reject drawn numbers up to a set maximum number of rejections, say up to 10, or as otherwise set by the rules of the relevant competition game.
The Jokers can be used to create Links in the same way as set out in Example 8, or as otherwise stipulated by the rules of the relevant competition game.
The winner is the player with the best card, as determined by the rules set out in Examples 1.4-1.8, or as otherwise set by other rules of the relevant competition game.

### Example 11.0—Player Interaction—Competition Involving a Player Competing Against a Computer

In this example of the game, a competition involving a player competing against a computer is held. Similar to computer chess, the objective of the game is to beat the computer.

The key elements of this exampled competition game are:
The player and the computer are each given the same 5×5 Link2Win™ Card.
One random draw of 25 numbers is undertaken.
Each of the player and the computer can make individual choices to reject drawn numbers as they occur, and turn those drawn numbers into Jokers in the same way as set out in Example 8. The player will not know the computers choice at the time the player makes his/her choice. The computer would ignore the player's choice in its decision making processes.
Each of the player and the computer will be able to reject drawn numbers up to a set maximum number of rejections, say up to 10 for each of them, or as otherwise set by the rules of the relevant competition game, including that the computer may be set with a lower or higher amount of rejections as the player may wish to determine, depending on the skill level of the player.
The Jokers can be used to create Links in the same way as set out in Example 8, or as otherwise stipulated by the rules of the relevant competition game.
The winner is the player or the computer with the best card, as determined by the rules set out in Examples 1.4-1.8, or as otherwise set by other rules of the relevant competition game.

### Example 12.0-5×5 Matrix Game—Variations for 2 Link Prize Profile

In this Example 12 we set out three variations to the 2 Link prizes of a standard game that can be adopted or adapted for used in some or all of the above exampled games, in particular those games exampled in Example 1.18, Table 10, and Example 2.4, Table 16.

The following three variations further demonstrate the flexibility of the prize pay-out structure of this invention.

### Example 12.1—Three Variations

Table 21 below sets out three examples of how the 2 Link prize profile in a standard play of a game (based on an exampled £5 entry fee as used throughout) can be altered to suit the requirements of a Gaming Operator and/or its players.

TABLE 21
Standard Game (excluding SUPERLink)

| Number of | | | |
|---|---|---|---|
| 2 Links | Prize Variation 1 | Prize Variation 2 | Prize Variation 3 |
| 18+ | £1,000,000.00 | £1,000,000.00 | £1,000,000.00 |
| 17 | £50,000.00 | £50,000.00 | £50,000.00 |
| 16 | £10,000.00 | £10,000.00 | £10,000.00 |
| 15 | £1,000.00 | £1,000.00 | £1,000.00 |
| 14 | £100.00 | £100.00 | £100.00 |
| 13 | £50.00 | £50.00 | £50.00 |
| 12 | £25.00 | £25.00 | £25.00 |
| 11 | £10.00 | £10.00 | £10.00 |
| 10 | £5.00 | £7.50 | £7.50 |
| 9 | £3.00 | £0.00 | £0.00 |
| 8 | £2.00 | £5.00 | £5.00 |
| 7 | £1.75 | £0.00 | £0.00 |
| 6 | £1.50 | £5.00 | £4.00 |
| 5 | £1.25 | £0.00 | £0.00 |
| 4 | £1.00 | £5.00 | £3.00 |
| 3 | £0.75 | £0.00 | £0.00 |
| 2 | £0.50 | £5.00 | £2.00 |
| 1 | £0.25 | £0.00 | £0.00 |
| 0 | £0.00 | £15.00 | £15.00 |

### Example 12.2—Many Variations

In addition, a person skilled in the art will appreciate that there are many variations that can be made and that when making adjustments to one set of prizes (in this Example 12, we do this to the 2 Link prizes), other adjustments may need to be made to the other 3 and/or 5 Link prizes in order to maintain target pay out rates and the target percentage of the total gaming revenues to be retained by the Gaming Operator/Link2Win™.

### Example 13.0-5×5 Matrix Game—“2 Links” Only with “Killer” Cells

In this Example 13 we set out a variation where the rules of a game played on a 5×5 card only recognise the 2 Link category, and not the 3, or 5 Link categories as recognised in the games set out in Examples 1 and 2. This example also introduces a method to reduce winners based on the operation of an in game feature, which we refer to as “Killer” cells.

### Example 13.1—4 “Killer” Cells

In this example we use:
Links comprising 2 symbols/numbers, overlapping (as opposed to discrete);
4 “Killer” cells on the Game Play Area (a 5×5 card);
Prizes up to 19+ Links

In this example, a Killer cell is operative if the last drawn number from the associated random draw of the 25 numbers lands on one of the Killer cells contained on the card. As the results of this exampled game are based on a random draw and are random, it makes no difference where on the 5×5 card the 4 Killer cells are positioned.

In the event that the last drawn number lands on a Killer cell, some or all of the prizes that a player would otherwise have won, are lost. At 4 Killer cells, the operative effect is to only eliminate prizes from, on average, about 1 in 6 of all games. This is calculated as to 4 divided by 25.

This feature of “Killer” cells adjusts odds and outcomes of the relevant game and it adds to player engagement and suspense.

### Example 13.2—Odds and Prizes

Tables 22 and 23 below sets out the Odds, Prize award levels (up to 19+ Links) and the prizes for each award level for a Standard game and a SUPERLINK game.

In this example, A SUPERLINK Game is not affected by any operation of a Killer cell and all prizes associated with a SUPERLINK game are won. The 4 Killer cells are located on cells other than the SUPERLINK cell.

TABLE 22
Standard Game

| | | Example Prizes |
|---|---|---|
| No. of | Odds: | Standard Game |
| 2 Links | 1 in . . . | 4 Killer Cells |
| 19+ | 258,875,739.6 | £2,500,000 |
| 18 | 20,554,381.0 | £500,000 |
| 17 | 1,990,445.9 | £50,000 |
| 16 | 241,886.4 | £5,000 |
| 15 | 36,057.3 | £3,000 |
| 14 | 6,517.0 | £2,000 |
| 13 | 1,418.5 | £50 |
| 12 | 370.0 | £25 |
| 11 | 115.4 | £20 |
| 10 | 43.1 | £13 |
| 9 | 23.1 | £10 |
| 8 | 12.5 | £8 |
| 7 | 8.2 | £7 |
| 6 | 6.6 | £5 |
| 5 | 5.5 | — |
| 4 | 7.1 | — |
| 3 | 12.3 | — |
| 2 | 30.0 | — |
| 1 | 117.0 | — |
| 0 | 968.6 | — |

TABLE 23
SUPERLINK Game

| | | Example Prizes |
|---|---|---|
| No. of | Odds: | SUPERLINK Game |
| 2 Links | 1 in . . . | 4 KillerCells |
| 19+ | 4,166,666,666.7 | £5,000,000 |
| 18 | 331,439,393.9 | £1,000,000 |
| 17 | 33,320,639.8 | £100,000 |
| 16 | 4,236,672.6 | £10,000 |
| 15 | 655,308.0 | £6,000 |
| 14 | 122,394.6 | £4,000 |
| 13 | 27,534.9 | £100 |
| 12 | 7,408.4 | £50 |
| 11 | 2,383.8 | £40 |
| 10 | 915.7 | £26 |
| 9 | 421.7 | £20 |
| 8 | 233.9 | £16 |
| 7 | 157.6 | £14 |
| 6 | 130.6 | £10 |
| 5 | 135.3 | £7 |
| 4 | 180.0 | £7 |
| 3 | 319.5 | £7 |
| 2 | 805.2 | £7 |
| 1 | 3235.9 | £7 |
| 0 | 27,628.0 | £7 |

### Example 13.3—The Killer Cell Effect

Tables 24 below contains a summary of the 4 Killer cell effect.
The reference to “Engagement %” in the table below is the percentage of players that are on a winning prize award before being reduced by the effect of the 4 Killer Cells (about a 1 in 6 reduction):

TABLE 24
4 Killer Cells Effect

| | Prize Steps | Engage- | Engage- | | |
|---|---|---|---|---|---|
| | affected by | ment | ment | Minimum | Minimum |
| Example | Killer Cells | % | Odds | Win as % | Win Odds |
| 1 | 3 | 55% | I in 1.82 | 48.25% | 1 in 2.07 |
| | (6-8 Links) | | | | |
| 2 | 4 | 55% | I in 1.82 | 47.39% | 1 in 2.11 |
| | (6-9 Links) | | | | |

### Example 13.4—Advantages of Killer Cells

One of the advantages for a gaming operator using the “Killer” cells method as exampled, is that more player engagement can be achieved both in respect of a player being closer to being on a prize award level and actually being on a prize award. Another advantage is that the final percentage of actual winners in a game can be fine tuned by a gaming operator by increasing or decreasing the number of “Killer” cells to meet its desired results.

### Example 13.5—Many Variations

This example uses 4 Killer cells. But there could be more or less used.

The effect of “Killer” cells can be obtained in other ways. For example, the 5×5 card could contain no Killer cells and instead, the same effect can be achieved by use of the 25 random draw numbers, randomly giving 4 of those numbers a Killer colour. If the last drawn number is one that is a Killer colour, then the same outcomes can be achieved.

A person skilled in the art will appreciate that there are many variations that can be made.

### Example 14.0-5×5 Matrix Game—Variations for Additional Side Bets

In this Example 14 we set out an example of a further variation to a standard game that can be adopted or adapted for use in some or all of the above exampled games, in particular those games exampled in Example 1.18, Table 10, and Example 2.4, Table 16.

### Example 14.1—Additional Side Bets

In this example, a player would enter into a Link2Win game by purchasing a Card in one of the games set out in Examples 1 and 2, and the player would have the option to purchase at a cost of £1 for each extra bet purchased, one or more side bets in the same game.

Table 25 below sets out exampled side bets.

TABLE 25
Standard Game (excluding SUPERLink) - Side Bets on 2 Links

| | | Offered Odds: | |
|---|---|---|---|
| | | A £1 side bet | |
| | Actual Odds: | offered against | Prizes |
| Each Event - | Each Event: | Each Event, - | Each |
| Number of | 1 in (Source: | one £1 bet | Event/Outcome |
| 2 Links | Table 16) | per event | Each £1 bet |
| 18+ | 22,531,098.9 | 7,500,000 to 1 | £7,500,000 |
| 17 | 2,299,651.3 | 750,000 to 1 | £750,000 |
| 16 | 275,111.2 | 100,000 to 1 | £100,000 |
| 15 | 40,538.4 | 30,000 to 1 | £30,000 |
| 14 | 7,233.7 | 5,000 to 1 | £5,000 |
| 13 | 1,555.0 | 1,000 to 1 | £1,000 |
| 12 | 400.8 | 300 to 1 | £300 |
| 11 | 123.5 | 80 to 1 | £80 |
| 10 | 45.5 | 30 to 1 | £30 |
| 9 | 20.1 | 15 to 1 | £15 |
| 8 | 10.7 | 7 to 1 | £7 |
| 7 | 6.9 | 5 to 1 | £5 |
| 6 | 5.5 | 4 to 1 | £4 |
| 5 | 5.4 | 4 to 1 | £4 |
| 4 | 7.0 | 5 to 1 | £5 |
| 3 | 11.8 | 8 to 1 | £8 |
| 2 | 28.6 | 20 to 1 | £20 |
| 1 | 109.9 | 75 to 1 | £75 |
| 0 | 898.4 | 600 to 1 | £600 |

### Example 14.2—Many Variations for Side Bets

The above exampled 2 Link side bets are offered at odds that are set at circa. two-thirds of the actual odds, except for the very high odds where it is assumed for the purpose of this example that the side bets with the very high odds (16-18+2 Links) are offered as an insured prize offering. Further, the above exampled 2 Link side bet prizes can be increased or decreased in order to achieve certain target pay out rates (return to player (“RTP”)) as may be determined from time to time by a Gaming Operator.

A person skilled in the art will appreciate that there are many variations that can be made to any side bets and that the above side bets are set out by way of example only. For example side bets can be offered for 3 and/or 5 Links and/or SuperLink outcomes in respect of any of them.

### Example 15.0-5×5 Matrix Game—No Random Draw to Obtain Ordinal Rankings

This example relates to one variation of the game.

The number layout in the Game Play Area(s) or Link2Win™ card may be similar to that shown in the matrix of FIG. 14. This time there is no requirement to have a random draw of 25 symbols in order to obtain the ordinal rankings. Rather the numbers are randomly populated in a blank matrix. In other words, the numbers from 1 to 25 are placed and displayed in the cells of the matrix in a random order, i.e. an order that is not predictable. These randomly populated numbers provide their own sequence or ranking as they are made up of the numbers from 1 to 25; hence it is easy to identify adjacent sequential numbers using the same or similar process used in identifying the adjacent ordinal rankings.

In this case there would be 10×2 links on the matrix shown in FIG. 14 comprising the adjacent numbers (8 and 9), (7 and 8), (10 and 11), (19 and 20), (23 and 24), (24 and 25), (5 and 6), (1 and 2), (15 and 16) and (23 and 22)

The symbols populated in the matrix need not necessarily be numbers but could be any other symbols of a recognizable sequence, for example, alphabets.

### Achievement Scoring

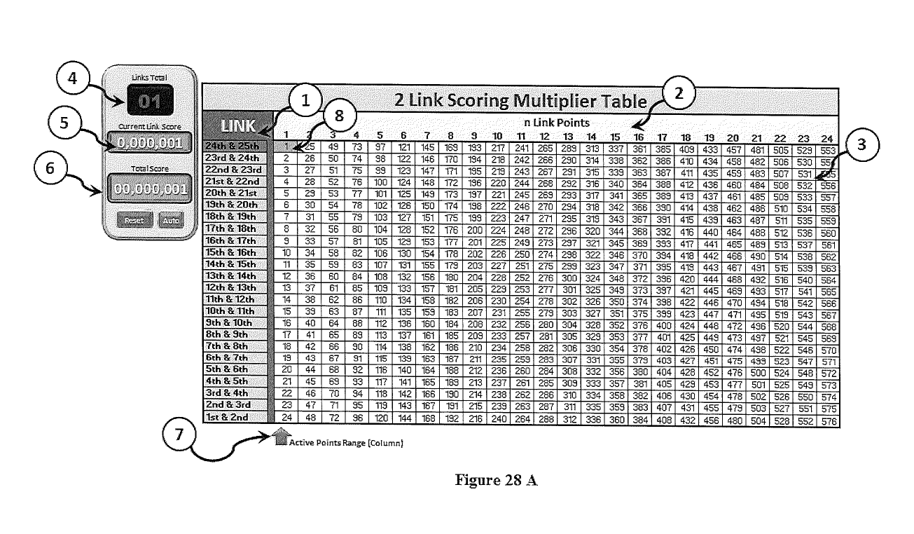

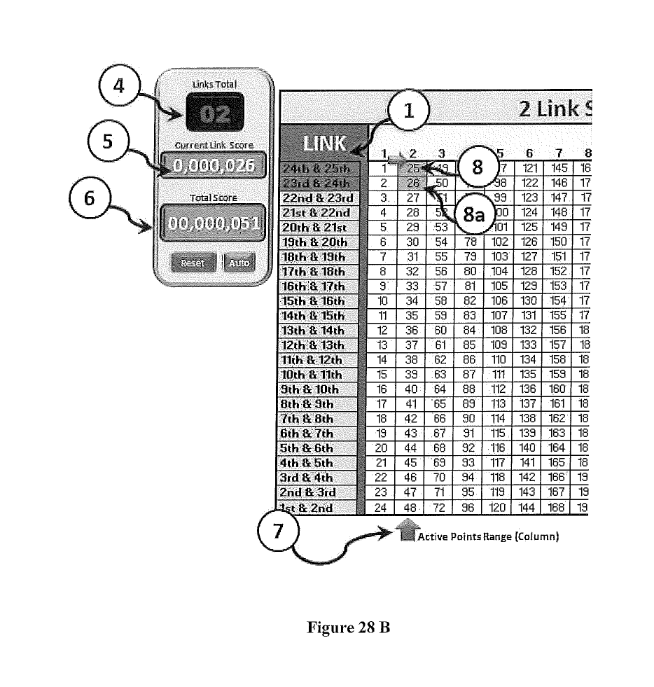

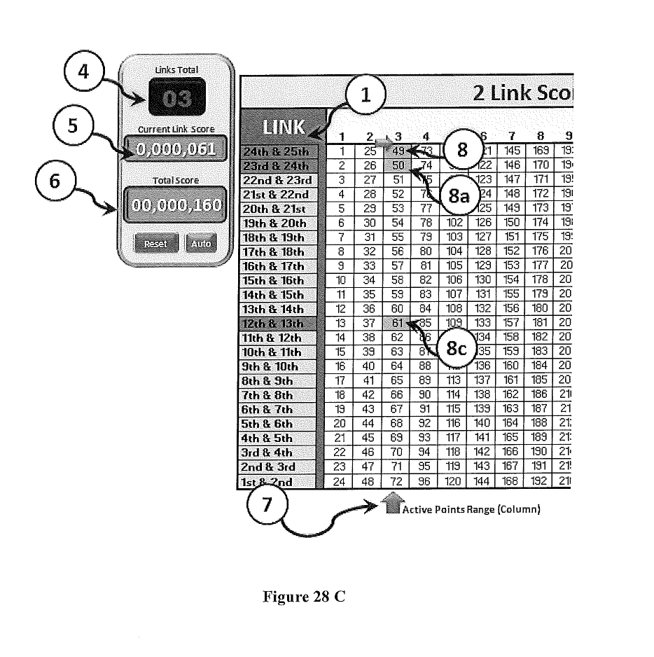

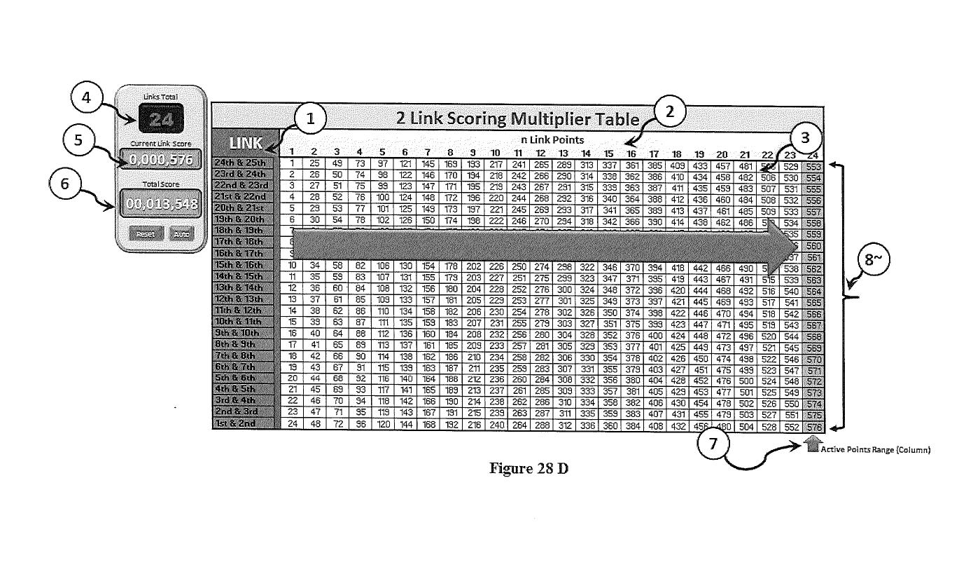

FIGS. 28A through to 28D each show a simulator where points are awarded for achieving 2-Link connections while playing the game. The same process other than the point values shown in table [3] applies for acquiring larger links e.g. 3 & 5 links but are not shown here. Due to fewer permentations of larger 3 & 5 links there will be fewer columns and rows in the respective tables.

The reference numerals used on those figures denote the following:
1. Description of the Link (in this example all links are 2 placings)
2. Points achieved based on the number of links acquired during the game.
3. Overall table of achievable points.
4. Indicates the number of Links acquired as the game progresses.
5. The Points value of the current link as played.
6. The total accumulated points from all links acquired.
7. Indicates which column is being used to calculate the points.
8. Active Points being totaled as displayed by [6]

FIG. 28A shows that a link comprising 25^{th} & 24^{th} Placed numbers has been achieved and is highlighted in the LINK column [1]. As this is the First link obtained (as indicated in display [4], the points in column 1 [7] are used.

[5] shows that the value for this Link is currently 1 point. [6] indicates that the total points from all Links thus far is 1 point.

FIG. 28B shows that a 2^{nd} Link has be acquired as indicated in the Link Counter display [4].

The New Link is comprised of 23^{rd} & 24^{th} placed numbers as highlighted in the LINK column [1].

Because this is the second Link acquired the Active Point Range [7] now shifts to the 2nd column. This new link has a Point value [8a] of 26. The previous Link (24^{th} & 25^{th}) [8] gets upgraded from 1 point to 25 Points.

### The Total Score [6] is now 25+26=51 Points.

FIG. 28C show the result of a 3^{rd} Link (12^{th} & 13^{th}) being acquired. As a result the Points [8] are calculated on column 3

The previous Link Points [8] & [8a] are upgraded to values in the 3^{rd} column and added to the new Link's 61 Points[8c] thus making the total score 160 Points [6].

The process as shown in the previous Figures' 28A to 28C continues until the last link is obtained.

FIG. 28D shows the case where every possible 2-Link connection is achieved thus all points [8˜] are summarized in the Last Column.

### Very Different To Bingo

A skilled person will realize that the Link2Win™ game of the present invention is very distinct from existing bingo games. Some of the differences between existing bingo games and the exampled Link2Win™ games of the present invention are that, in the exampled Link2Win™ games:
The matrix card player plays all the n numbers, in this case n is 25.
Every card achieves a “Blackout” as all n numbers are drawn and each player has positioned all n numbers on the Link2Win™ card.
Players/Participants number choices are converted to the ordinal number, recording each numbers ranking that arises from the separate but associated random draw of the n numbers.
Players/Participants must link their numbers to other numbers on their card based on rules (in this case the next drawn number) to match patterns (in this case straight lines, either vertical diagonal or horizontal).
In a pooled game, the game enables all winning cards of a prize to be ranked against each other so that the game produces with substantial certainty one single overall winner, or a set number of ranked winners (for example such as 1^{St} ranked to 10^{th} ranked) derived from the ranking system.
Numerous prize-winning events can occur, including from having no matches or links.
As exampled in Example 13, numerous side bet opportunities can occur as a consequence of the various outcomes generated within each play of the game.

It will be clear that a large number of variations exist and the above descriptions are by way of example only.

### Variations

The above examples describe linking numbers (2, 3 or 5 numbers) in a straight line, in order or in reverse order on a matrix card, as determined by or in reference to a random draw of the n numbers. However, it is possible to use any patterns other than straight lines. For example, a diamond shape pattern, which could be 8 in a row to form the diamond shape, could be used and the prize could be allocated accordingly. Similarly, other patterns of any other shape and sizes are possible such as but not limited to triangular, Z-shaped, L-Shaped, U-shaped, hexagonal etc. Random patterns could be used, as long as the linking criteria set out in the rules of the relevant game were met.

Similarly, the symbols or numbers that the player plays need not be 25 and can be more or less than 25. For example a Link2Win™ game consisting of 36 n numbers and a 6×6 Link2Win™ card (containing 36 cells) could be established using the features of this invention, but incorporating more prize winning opportunities (e.g. linking 2, 3, 4, 5 and/or 6 numbers linked in order, or in reverse order) and bigger top prizes, which are created as a consequence of the greater odds that result from the 6×6 expanded Link2Win™ game.

The size of the Game Play Area in the form of a Link2Win™ card can be smaller or bigger than a 5×5 matrix consisting of 25 cells or grids. Also, the matrix need not be a cell matrix. It may be a matrix of a regular or other such recognisable shape, such as a rectangular matrix of any n×y dimension, for example, a 6×3, or a 10×7 rectangular matrix. Alternatively, it may be a matrix consisting of an odd or irregular shape.

The matrix may consist of one single matrix line. The single line could be straight and therefore not joined at each end, such as 25×1 lines, or a 50×1 line or even greater. Alternatively, the single line can be of some other shape, and may be joined at each end, such as a single line comprising the outside line of a circle, or cell etc.

The Game Play Area(s) to be used need not be limited to a Link2Win™ card. The Game Play Area can be any two-dimensional or multi-dimensional area that can be used when placing three or more symbols at the Game Play Area, with the symbols being placed at the area in a regular or irregular spatial arrangement, so that some symbols are bordered by or are close to other symbols and in accordance with the rules of the relevant game one or more relationships between any two or more of the symbols at the Game Play Area, can occur.

The Game Play Area to be used may include any visual representation of a matrix comprised of any grouping (including any multi dimensional grouping) of “cells”, “circle”, “rectangle” hexagon”, or “diamond” shape or object on a Card, including but not limited to a grouping comprised of z×z shapes or objects (e.g. 5×5; 6×6), or z×y cells (e.g. 4×5; 4×6), or any ordered or disordered configuration of shapes or objects.

Any size, shape and/or colour of the tokens may be used.

In some of the examples described above, SUPERLINK is played by any/all players that correctly get the 25^{th} drawn number. The use of the 25^{th} drawn number as the SUPERLINK number can be changed to any other drawn number. Also, more than one number can be used as the SUPERLINK number. For example, the 24^{th} and 25^{th} drawn numbers can be used as the SUPERLINK numbers. Any player getting one of those numbers could qualify for SUPERLINK. Also, it is possible to have two, three or even more combinations to be used as the SUPERLINK numbers where players need to correctly get just one of the numbers (or alternatively they might need to get more than one of the numbers). A person skilled in the art will appreciate that with just 1 number as the SUPERLINK number in Examples 1 and 2 of the 5×5 matrix game, or any other example that is relevant, the odds of being a SUPERLINK player is 1 in 25. In certain situations it may be desirable to increase the number of players that get this benefit, so having 2 numbers as SUPERLINK numbers instead of just one, with a SUPERLINK play applying to any Link2Win™ card that has correctly chosen one of those numbers, gets the odds down to 1 in 12.5.

Although, the examples described above show the use of numbers on the card, the game can be played using any other form of symbols or icons or in some cases even physical objects.

Obtaining links of the numbers or symbols on a Game Play Area or matrix/matrices need not always be based on the consecutive ranking or placement order/value of the numbers/symbols as determined in the associated random draw and can instead be based on some other rule. For example, obtaining links can be based on every odd drawn number (ranking or placement order/value) e.g., 1^{st}, 3^{rd}, 5^{th} and so on and/or every even drawn number (ranking or placement order/value) e.g., 2^{nd}, 4^{th}, 6^{th} and so on.

Further, the exampled games are based on linking numbers on a 5×5 card by reference to the drawn numbers in a random draw with the immediately prior drawn number, to create a link. But variations of the game can be configured where the pattern to be matched on the card comprise drawn numbers matched in any order. For example, a 5 link could in this variation comprise linking any 5 numbers on the card in a straight continuous line. An example of this is the following drawn numbers (identified by any order of draw from a range of 5 consecutive drawn numbers). The drawn numbers might be, in order of draw: 7^{th}, 8^{th}, 9^{th}, 10^{th} and 11^{th}. The corresponding 5 Link on the matrix card could in this variation be: 9^{th}, 7^{th}, 10^{th}, 8^{th}, 11^{th}.

Alternatively, and as a further example, links could be formed using consecutively drawn numbers from the random draw by linking two or more numbers on the Game Play Area/matrix/matrices based on a game rule that allows a link when there are one or more non complying numbers located in between the relevant numbers that are to be linked.

Variations to what constitutes a Link can also be made. For example, a game could comprise Links of only 2 symbols. For example, 4 consecutively drawn symbols that are linked together on a Game Play Area/matrix/matrices can form: 3×2 Links (overlapping links using common symbols); or 2×2 Links (when the game rules set only allow discrete links).

And there are many variations involving players having interaction, in addition to the four examples set out in Examples 8 to 11.

As one example, the player(s) can play games involving multiple cards, and can be awarded points or first place position based on matching patterns, such as matching in a 5×5 card, the 9 cells that form an “X” shaped pattern. This can occur with or without other points or prizes being awarded following the full draw of 25 numbers.

Various hardware configurations to implement the game/s are possible. For instance, the Link2Win™ game could be implemented using a client-server model in which a server entity is used to process the game data and then transmit the output to one or more client machines. The client-server model could also be implemented using one or more game terminals, such as terminals using touch screens. The client-server could also be implemented in a casino environment where the game terminals are multi-function, operating the game as part of or similar to a slot-machine based game. Alternatively, the Link2Win™ game could be implemented using a stand-alone computer, in which a stand-alone application would do the game processing of the card data and display the output in graphical form to the user.

It will of course be realised that while the foregoing has been given by way of illustrative example of this invention, all such and other modifications and variations thereto as would be apparent to persons skilled in the art are deemed to fall within the broad scope and ambit of this invention as is hereinbefore described.

### Kit of Parts

It will also be understood that where a product, method or process as herein described or claimed and that is sold incomplete, as individual components, or as a “Kit of Parts”, that such exploitation will fall within the ambit of the invention.

These and other features and characteristics of the present invention, as well as the method of operation and functions of the related elements of structures and the combination of parts and economics of manufacture, will become more apparent upon consideration of the following description with reference to the accompanying drawings, all of which form part of this specification, wherein like reference numerals designate corresponding parts in the various figures.

For purposes of the description hereinafter, the terms “upper”, “lower”, “right”, “left”, “vertical”, “horizontal”, “top”, “bottom”, “lateral”, “longitudinal” and derivatives thereof shall relate to the invention as it is oriented in the drawing figures. However it is to be understood that the invention may assume various alternative variations, including multi-layered games and 3-D games, except where expressly specified to the contrary. It is also to be understood that the specific devices illustrated in the attached drawings, and described in the following specification are simply exemplary embodiments of the invention, hence specific dimensions and other physical characteristics related to the embodiments disclosed herein are not to be considered as limiting.

### Advantages

Some of the advantages of the present invention are as follows:

Great Flexibility: The system of the present invention allows playing a game that has a great flexibility and can be configured to suit the market into which it is to be offered. And it can have numerous visual front ends, all supported and running on the same underlying gaming system. For example, the new lottery system has applications of use in the LOTTO and Lottery sectors (including Keno), the Casino sector, the Slot sector, as well as in the Bingo sector of the gaming market. Further, the present invention allows a gaming event to operate with prizes, without prizes, or to operate using a totalizer or pari-mutuel system (where the prize pool depends upon the number of entries and is not a fixed amount) or to operate using a pari-mutuel system in combination with one or more ‘additional fixed prizes’, or to operate games as a single entry game played ‘on demand’ by one player and played as an instant play.

Quicker Games: The system of the present invention allows playing a game that is quicker games when compared to a typical bingo game.

Reduced n Numbers without reduction to the Odds: The system of the present invention allows playing a game that has reduced n numbers without adverse reduction in game odds when compared to a typical bingo game.

Instant and Maintained Game Excitement: Various applications of the game played by the system of the present invention can provide the ‘won’ feeling, right from the start, then suspense as the ‘won’ prize decreases, then suspense as the won prize is lost, and then anticipation as winnings start to get closer, and excitement as winnings reappear, with the anticipation of further winnings. For cards that lose, there is the ‘almost’ or ‘nearly’ won feeling. Other applications can provide for a virtually instant start of winnings, followed by a continual increase to those winnings creating game excitement.

Numerous Prize Points: The system of the present invention allows playing a game that has a large number of prize winning levels—36-45 in total in the first two exampled games, but there could be more.

Multiple Winnings: The system of the present invention allows playing a game that offers multiple prizes that can be won, up to 3 separate prizes in the exampled games set out in Examples 1 and 2-3 separate prize-winning categories for Links of 2, 3, and/or 5—and a player can win in all 3 categories.

Side Bet Opportunities: The system of the present invention allows playing the games that offer the opportunity to offer additional side bets, creating further betting opportunities from within a single game.

Big Lotto Style Prizes can always be on offer: The system allows playing the games that can have odds that rise through the prize winning levels (36-45 in the first two exampled games) to surpass the odds in large big prize lottery games, such as the odds in EuroMillions (top prize is odds of 1 in 108 million) and American PowerBall (top prize is odds of 1 in 175 million). The games can have large insured ‘Lotto’ style prizes—always on offer.

Integrity of the Winning Results: The system allows playing the games where the winning card numbers/links are easily determined by a participant and the gaming operator and the determination of a winning card is based on the tried and proven method of a random draw of numbers after entry to the relevant game is closed. This is a process that can be of the highest integrity with the random number generator subject to checking by the licensing bodies.

Advantages of involvement of Independent Auditing Party: Further, The system allows playing the games, where the game results can be subject to an independent audit process, which can be done immediately after each game or even years later. We believe this ability to carry out independent audits will significantly reduce the chance of fraud affecting the winning result. The independent auditing party can simultaneously and independently receive raw gaming data and, following the closure of the relevant game, check and verify the integrity of the winning results as determined by the gaming operator using duplicate gaming software. This ability to involve an independent auditing party is of significant advantage and it enhances the integrity of the results of games using our invention.

All Required Cards can be Ranked: The system allows playing the games where each card containing one or more links can be ranked, against each other card.

Guarantees a Winner: A further advantage of the invention is that the system allows playing a game involving a pool of participants, the gaming system can undertake eliminations and at relevant stages, separate cards that are tied in order to separate out a single first placed or ranked card. It does this by utilising the rankings of the 5, and/or 3 and/or 2 Links as has been set out in Examples 1.5-1.8. Each of the card's performances can be ranked against each other, resulting in the invention being able to always determine a first ranked card. The system of LOTTO cannot guarantee a first division winner, whether that be a single first division winner or two or more winners that share the first prize. This invention provides a transparent method to do so, and in a game involving a pool of players it can do so irrespective of the order of the number choices set out on each card and irrespective of the order of the random draw.

Structured to be significantly certain that a single first ranked Card will always occur: In contrast to LOTTO type games, the system of the present invention allows playing the games where a pool of entries occurs can, when required, always guarantee a first ranked card for any first place prize on offer and that it will be virtually certain that it will always be a sole first ranked card. The only circumstances where the gaming system of this invention cannot determine a single first ranked winner is where: (a) the winning card has the same matching Link results and the same rankings of ALL those Links by reference to Examples 1.5-1.8 as one or more other cards; and/or (b) ALL the cards in the game, and without exception, have no Links at all. Both events are extremely unlikely and are sufficiently remote that a single first ranked card can be said to be virtually certain. Nevertheless, if there are tied first ranked cards remaining after all the ranking and elimination procedures as set out in Examples 1.5-1.8 have been completed, then the remaining tied cards share the relevant prize.

Can used in Periodic Draws: A further advantage is that the system of the present invention allows playing the games that can be used in periodic draws, such as a yearly draw, where the computer software stores all the cards since the prior periodic draw and processes a free to entry game for a pari-mutuel prize funded by a portion of all entries made during the relevant period.

Incorporates a Super Prize Function: A further advantage is that the system of the present invention allows playing the games that can incorporate a super prize function, similar in functionality to a Power Ball play in a Lotto game, where prizes can be significantly increased. This has been referred to as the SUPERLINK number located on the bottom right hand cell of the 5×5 card. An example of the increase in prizes occurs when considering Table 17 (SUPERLINK prizes) against Table 16 (standard prizes).

Can be used in a Virtual Environment: A further advantage of the invention, is that system of the present invention allows a game that can be adapted from a pure numbers game, into a virtual game where the gaming experience and the delivery of results is through virtual or animated means that can be made to be more visually exciting than a pure numbers game.

Allows for Player Interaction: As set out in Examples 8 to 11, a further advantage of the invention is that the system of the present invention allows playing a game that can allow players to interact with the game during the game draw in ways that deliver and enhance player satisfaction, and/or improve a player's winning chances.

Allows for Competitions: A further advantage of the invention is that the system of the present invention allows playing a game that can be used in a competition format, where a pool of players compete against each other and where one winner is to emerge, or it allows a single player to challenge him or herself against a computer, similar to a chess computer, thereby providing an interactive and challenging gaming event.

Gaming System can be used in Numerous Other Gaming Sectors: A further advantage of the invention is that the system of the present invention allows playing a game that can be used in many different gaming sectors or categories, such as use in the LOTTO and Lottery sectors (including Keno), as well as the Casino, Slot, and Bingo sectors of the gaming market.

Important advantages for State Lottery Operators: As set out in Examples 3-5, further advantages are that the invention the system of the present invention allows playing a game that can be used by State Lottery Operators in various applications of the invention (including by way of Link2Win™ Scratch Card applications) all using a State Lottery Operator's existing POS lottery retailer networks, with no need for online entry purchasing transactions, while at the same time still providing for players to experience the convenience and excitement of a computer animated and visually engaging play-out of the results of a game utilising the invention on a player's personal computer device (e.g. on mobile, tablet, PC). And these advantages and relevant aspects of the invention can extend to other lottery games (including other scratch cards) of a State Lottery Operator.

Advantages for use in a Regional or Worldwide Lottery: The system of the present invention allows playing a game that has as one of its advantages the ability to be used in a regional or worldwide lottery game. The game will have some significant advantages or appeal when used in a regional or worldwide lottery compared with the standard ‘LOTTO’ type games, many of which have remained unchanged for years. These advantages or appeal will include:

Unique and Exciting: The system of the present invention allows playing the games that are unique, different and easy to play with game and draw excitement. The games can be full of suspense;

Transparent: The system of the present invention allows playing the games where results and game processes are transparent and able to be independently audited;

Player Engagement: The system of the present invention allows playing the games that can deliver, transparently, the ‘won’ feeling, or the ‘nearly won’ feeling, right from the start;

Can attract players: It is generally accepted that new, exciting and easily understood games attract and retain players, which is of interest to all gaming operators. The system of the present invention allows playing the games that meets all these points;

Wide odds range: The system of the present invention allows playing the games of that can give rise to a wide range of odds, both in respect of the ability to win any prize and in respect of the ability to create significant Lotto style prizes, which occur as a consequence of the creation of the sizable odds that are created as a consequence of the invention set out in the exampled games. For example, prize points with odds of 1 in 22; 40; 75; 363; and 418 million arise in the exampled 5×5 game—see Example 1.19, Table 12;

Numerous prize points: The system of the present invention allows playing a matrix game of that allows for many prize points (36-45 in the first two exampled games); including for a unique prize for a complete failure to secure any 2 Link match on a card;

A complimentary game: The system of the present invention allows playing the games that can be positioned by lottery organizations as complimentary games to their existing Lotto type businesses;

Online and mobile applications: The system of the present invention allows playing the games that are ideal for online game applications (including mobile) which is where many of the world's gaming and lottery organizations have a keen focus, but the games of this invention are equally capable of being used in a retail environment (scratch cards) or through standard Lotto type POS lottery retailers—where a televised or broadcast draw occurs, or where the results are played on a player's mobile, tablet or personal computer device; and

Flexible market positioning: The system of the present invention allows playing the games that can be positioned with different price and prize points and different play frequencies. For example, the 5×5 card game can be position as an instant play or daily game, and the 6×6 game could be positioned as a higher priced weekly game.

### INDUSTRIAL APPLICABILITY

As described above, the preferred embodiments of the invention allows a game that can be operated with prizes, without prizes, or to operate using a totalizer or pari-mutuel system (where the prize pool depends upon the number of entries and is not a fixed amount) or to operate using a pari-mutuel system in combination with one or more ‘additional fixed prizes’, or to operate using fixed prize amounts. In respect of a game that is played by a pool of players, the gaming event closes at a defined time or upon the reaching of defined parameters such as the reaching of a predetermined number of ticket sales or prize pool.

The preferred embodiments of the invention allow quicker games. The present invention allows a reduced range of n numbers without reduction to game odds.

The preferred embodiment of the invention guarantees a winning result and that it will be substantially certain that there will be a single card (player) as the sole winner.

The preferred embodiments of the invention provide the advantages listed above.

1. A system for mapping and converting one or more matrices used in a game that is played on the one or more matrices, the system comprising:
a display means;
a memory storing at least particular rules, the rules being related to one or more matrices, each consisting of multiple cells, the rules at least specifying valid links between the cells of the one or more matrices; and
one or more modules stored in the memory and configured for execution by one or more processors, the one or more modules including instructions:
to initialize one or more matrices consisting of multiple cells, by identifying at least some of the cells of the one or more matrices using a number of unique identifiers, the number of unique identifiers being equal to a number of cells of the one or more matrices that are to be identified;
to cause each of the uniquely identified cells of the one or more matrices to display a symbol identified by the respective identifier of that cell, on the display means;
to read the rules stored in the memory and to store in the memory the scoring factors associated with at least particular cells of the one or more matrices identified by particular rules;
to create an ordinal ranking of at least those cells of the one or more matrices that display the symbols;
to cause at least some of the cells of the one or more matrices displaying the symbols to display their ordinal ranking, on the display means;
to calculate a series of sequences identified by particular rules in relation to relative positions of the ordinal rankings of the cells of the one or more matrices;
to determine any valid links between the calculated series of sequences, the valid links being determined according to the rules;
to calculate a game result from the scoring factors stored in memory and associated with at least the particular cells of the one or more matrices; and
to display at least the result of the game on the display means.

2. A system as claimed in claim 1 wherein the one or more modules further includes instructions to display any valid links between the calculated series of the sequences, on the display means.

3. A system as claimed in claim 1, wherein the symbol displayed by any one cell on the display means is unique to at least the matrix containing that cell.

4. A system as claimed in claim 1, wherein the display means is an OLED or a touch screen display.

5. A system as claimed in claim 1 further comprises an input device operatively connected to the processor to input data to the processor.

6. A system as claimed in claim 5 wherein the input device is adapted to input a symbol data to the processor, the symbol displayed by the at least some of the cells of the one or more matrices on the display means being dependent on the symbol data inputted by the input device.

7. A system as claimed in claim 5 wherein the input device is a machine readable code scanner adapted to read and input symbol data from a machine readable code.

8. A system as claimed in claim 5 wherein the input device is a camera.

9. A system as claimed in claim 1, wherein the system comprises a symbol generator operatively connected to the processor, the symbol generator being adapted to generate at least some of the symbols that are displayed by the cells of the one or more matrices on the display means, the ordinal ranking of the cells being values that represent the order in which the at least some of the symbols are generated from the symbol generator.

10. A system as claimed in claim 9, wherein the input device is operatively connected to a symbol generator and to the processor, wherein the input device receives the ordinal ranking data from the symbol generator and inputs the received ordinal ranking data to the processor, the ordinal ranking displayed by at least some of the cells of the one or more matrices on the display means being dependent on the ordinal ranking data inputted by the input device.

11. A system as claimed in claim 10, wherein the symbol generator generates the symbol in a random order, pseudo-random order, or a logical order unknown to any participant(s) of the game.

12. A system as claimed in claim 1 wherein, the memory and the processors are located in a remote location in a server and the display means is operatively connected to the server.

13. An apparatus for mapping and converting one or more matrices that is used in a game that is played on the one or more matrices, the apparatus comprising:
a matrix store storing at least one matrix having a specified number of cells, a plurality of unique symbol identifiers for identifying symbols, each symbol being identified by a unique symbol identifier;
a placement allocator receiving each unique symbol identifier from the matrix store and placing each unique symbol identifier in the at least one matrix so that each symbol identifier represents each cell;
a sequence implementer adapted to receive a specified number of ordinal ranking values each of which represent an order in which a specified number of symbols are drawn, and to replace at least some of the symbol identifiers representing the respective matrix cells with one ordinal ranking value corresponding to the order in which that particular symbol is drawn, the ordinal ranking value being in a sequence between 1 and the specified number;
a rule store for storing a set of rules, the rules being dependent on the ordinal ranking values, sequence(s) of the ordinal ranking values and a location of the ordinal ranking values on the cells;
a cell location determiner adapted to determine the location of the ordinal ranking values on the cells;
a sequence determiner adapted to determine if the ordinal ranking values located at two or more cells are in sequence(s) according to the rules of the game;
a sequence detector adapted to determine if the ordinal ranking values located at two or more cells are determined to be in sequence(s) by the sequence determiner according to the rules;
a sequence sorter adapted to compare the sequence(s) detected by the sequence detector and sort the sequence(s) that are valid sequence(s) and invalid sequences according to the rules;
a sequence comparator adapted to compare at least the valid sequence(s) thereby obtaining a result providing information about at least the number and/or type of the valid sequence(s) according to the rules;
a result publisher adapted to receive at least the result from the sequence comparator and transmit at least the result externally for publication.

14. An apparatus as claimed in claim 13, wherein the apparatus further comprises a score calculator for calculating a score using any scoring factors in the rules of the game and associated with particular cells and/or valid links and wherein the result publisher is adapted to receive and transmit the calculated score from the score calculator for publication.

15. An apparatus as claimed in claim 13, wherein the apparatus further comprises an identifier generator that generates the unique symbol identifiers to be received by the placement allocator.

16. An apparatus as claimed in claim 13, wherein the apparatus further comprises a transaction module adapted to receive and/or process payments or at least store any payment details.

17. An apparatus as claimed in claim 13, wherein the apparatus further comprises an information module for storing information of the participant(s) of the game.

18. An apparatus as claimed in claim 13, wherein the apparatus is operatively connected to one or more display means adapted to receive and display any data transmitted by the result publisher.

19. (canceled)

20. The apparatus as claimed in claim 18, wherein the display means is adapted to display a symbol together with respective placement value of that symbol on each cell of the one or more matrices.

21. An apparatus for mapping and converting at least one matrix, the apparatus comprising:
a display means;
a memory storing a definition of valid links between the cells of the at least one matrix; and
one or more modules stored in the memory and configured for execution by one or more processors, the one or modules including instructions:
to initialize at least one matrix consisting of multiple cells, by identifying at least some of the cells of the at least one matrix using a number of unique identifiers, the number of unique identifiers being equal to a number of cells of the at least one matrix that are to be identified;
to cause each of the uniquely identified cells of the at least one matrix to display a symbol identified by the respective identifier of that cell, on the display means;
to read the definitions of valid links stored in the memory and to store in the memory the valid links associated with at least particular cells of the one or more matrices identified by particular definitions;
to create an ordinal ranking of at least those cells of the one or more matrices that display the symbols;
to cause at least some of the cells of the one or more matrices displaying the symbols to display their ordinal ranking, on the display means;
to calculate a series of sequences identified by particular definitions of valid links in relation to relative positions of the ordinal rankings of the cells of the one or more matrices;
to determine any valid links between the calculated series of sequences, the valid links being determined according to the rules;
to calculate a result from the scoring factors stored in memory and associated with at least the particular cells of the one or more matrices; and
to display at least the result on the display means.

22. (canceled)
